(19) United States
(12) Patent Application Publication
(10) Pub. No.: US 2016/0226308 A1
(43) Pub. Date: Aug. 4, 2016

(54) Wall Paneling Construction Smart Apparatus and System

(71) Applicants: David Valin, Ossining, NY (US); Alex Socolof, Ossining, NY (US)

(72) Inventors: David Valin, Ossining, NY (US); Alex Socolof, Ossining, NY (US)

(21) Appl. No.: 14/611,285

(22) Filed: Feb. 2, 2015

(51) Int. Cl. H02J 17/00; H02J 4/00; H04L 12/10

(52) U.S. Cl. CPC H02J 17/00; H04L 12/10; H02J 4/00

(57) ABSTRACT

The apparatus and system presented is a self contained Wall Paneling Construction Smart Apparatus that utilizes and requires a plurality of apparatus's to effectively perform the functions of transferring electricity, data and further providing a point where low energy electrical devices can plug into for charging, and use. The apparatus's presented as part of the system, are all together required to carry out the functions needed in the functioning of the presented system. The system principles carried out in the apparatus and system are for the purpose of making it easier to install directly in a safe way to alternative energy devices. The wall apparatus also provides microphones, cameras, and speakers and other components for other useful purposes with the apparatus in the system, such as identification of humans and objects, utilizing measurements and entertainment.

### CROSS REFERENCE TO RELATED APPLICATIONS

This application claims priority from and is a continuation in part of U.S. Pat. No. 8,369,997, entitled “Solar Panel Wind Turbine Communication Server Network Apparatus Method and Mechanism”, filed on 28 Apr. 2010, which is incorporated by reference in its entirety for all purposes as if fully set forth herein.

This application claims priority from and is a continuation in part of U.S. patent application Ser. No. 12/768,981, entitled “Solar Panel Wind Turbine Communication Server Network Apparatus Method and Mechanism”, filed on 28 Apr. 2010, which is incorporated by reference in its entirety for all purposes as if fully set forth herein.

This application claims priority from and is a continuation in part of U.S. patent application Ser. No. 12/860,936, entitled “A method for connecting a human key identification to objects and content or identification, tracking, delivery, advertising, and marketing”, filed on 23 Aug. 2010, which is incorporated by reference in its entirety for all purposes as if fully set forth herein.

This application claims priority from and is a continuation in part of U.S. patent application Ser. No. 12/653,749, entitled “Method and Mechanism for identifying protecting, requesting, assisting and managing information”, filed on 17 Dec. 2009, which is incorporated by reference in its entirety for all purposes as if fully set forth herein.

This application claims priority from and is a continuation in part of U.S. patent application Ser. No. 13/282,730, entitled “Method for Transformation of a Website”, filed on Jun. 29, 2011, which is incorporated by reference in its entirety for all purposes as if fully set forth herein.

This application claims priority from and is a continuation in part of U.S. patent application Ser. No. 13/171,746, entitled “Method and process for registration, creation and management of campaigns and advertisements in a network system”, filed on Jun. 29, 2011, and is a granted U.S. Pat. No. 8,818,850 which has an issue date of Aug. 26, 2014 which is incorporated by reference in its entirety for all purposes as if fully set forth herein.

This application claims priority from and is a continuation in part of U.S. patent application Ser. No. 13/357,029, entitled “Apparatus for connecting a human key identification to objects and content for identification, tracking, delivery, advertising, and marketing”, filed on 24 Jan. 2012, which is incorporated by reference in its entirety for all purposes as if fully set forth herein.

This application claims priority from and is a continuation in part of U.S. patent application Ser. No. 13/360,670, entitled “Method for connecting a human key identification to objects and content for identification, tracking, delivery, advertising, and marketing”, filed on 28 Jan. 2012, which is incorporated by reference in its entirety for all purposes as if fully set forth herein.

This application claims priority from and is a continuation in part of U.S. patent application Ser. No. 13/332,173, entitled “Method for identifying and protecting, information”, filed on 12 Dec. 2011, which is incorporated by reference in its entirety for all purposes as if fully set forth herein.

This application claims priority from and is a continuation in part of U.S. patent application Ser. No. 12/459,353, entitled “Method and mechanism for protection, sharing, storage, accessing, authentication, certification, attachment and tracking anything in an electronic network”, filed on Jun. 29, 2009, which is incorporated by reference in its entirety for all purposes as if fully set forth herein.

### BACKGROUND OF THE INVENTION

The field of this invention is related to A Wall Paneling Construction Smart Apparatus and System for houses, buildings and mobile applications. The apparatus and system functions with a self contained low energy electrical socket plug in area and energy storage, that requires a reduced amount of wiring for transfer of electricity. The energy transferal apparatus in the system utilizes light transmission for sending and receiving electricity. In the field of prefabricated homes, as well as custom built homes, various procedures and equipment have been proposed for providing ready made wall panels, but so far as is known, no one has solved the problem of providing an electrical wireless energy transfer wall panel apparatus, to reduce construction costs, and the time related to building walls in structures. The presented invention has apparatus and system provisions for utilizing temporary or mobile instant electrical connections whether such wall panels are used for prefabricated, custom homes or temporary housing.

### SUMMARY OF THE INVENTION

The present invention relates to an apparatus for rapid installation, and energy transference for any size house or similar building so that electricity and communications can be fabricated and joined together to form a low energy system providing accessible charging, communication, and measurement stations on the exterior and interior walls of the house or other building structures. The presented apparatus and system functions are carried out using a plurality of processors, mechanisms and computers for control and management.

The Wall Panel is used for the purpose of providing an energy supply for charging, and use of low voltage, DC and AC current appliances. The appliances work within the principles of the GSense Solar Hybrid energy and communication system. The purpose of the Wall Paneling Construction Smart Apparatus is to have a safe reliable connection to users in a living and work space that it provides energy and communication for. And further providing a connection between the GSense Main Hybrid Solar units, for electricity to homes and business, the GSense Mini Apparatus for the development community, and the GSense Micro Mini apparatus for establishing a low cost infrastructure micro-grid for places that have no infrastructure.

A further important aspect of the invention, is for the purpose of saving the user costs related to wiring a home, office or structure. And for the purpose of providing a connection to alternative energy systems to be able to set up an electrical and communication system economically, and rapidly in undeveloped places around the world.

### TECHNICAL FIELD OF THE INVENTION

The present invention generally relates to technology that provides the ability of electricity to be converted into light, and then at the point of transmission to be converted back into electricity. One of the principles of the invention is that the apparatus and system utilizes, and takes advantage of a plurality of energy generation apparatus and strategies in it's generation and storage of electricity. All devices that work with the apparatus and system are required to be manufactured with the principles of the presented apparatus and system in the design for best practices, performance and functionality. But mobile phones, computers, and low energy devices can be charged and run also utilizing the wall panel USB ports for access to power. With the GSense Hybrid Solar apparatus and it's ability to store electricity and data.

### DESCRIPTION

What is presented here is a stationary electrical access wall outlet panel apparatus, that uses a plurality of low level, laser devices similar to a laser pointer, that are connected to an energy storage device, such as a battery, or super capacitor. These lasers then take the electricity from the energy storage device and transmit light to a plurality of solar photo voltaic cells that act as a receiver unit, that converts the light back into electricity and stores it in a separate energy storage device.

The apparatus also has built in an electricity generator solar photo voltaic cells, with a plurality of solar concentrator apparatus's that increase the efficiency of the solar photo voltaic cells in ambient room light to add to the capacity of the presented apparatus electricity to serve the user.

A plurality of graphene super capacitor apparatus's are added to the system to stabilize the electricity flows, in taking transfers of electricity very quickly in the system. These super capacitors, charge quickly and then charge the batteries over a longer amount of time. The batteries used in the system are light weight, and a plurality of organic battery storage units that are not toxic to the environment, after use and are primarily graphene based batteries. All devices in the system where batteries are needed use these types of battery systems.

The plurality of connectors that are mounted on the surface and use area of the wall apparatus and system, are made up of traditional USB low voltage adapters for low level charging of mobile devices, tablets and the like, and delivery of data from the data storage devices provided in the apparatus. A CPU central processing unit and computer motherboard are also provided for management, Internet access and data transferal purposes, accessed on the LCD touch screen display provided in the system. Furthermore the new USB Power Delivery adapters, that can handle much higher electricity transferal are provided on the surface of the wall apparatus and system panel.

A plurality of low level electricity generator apparatus's are provided for charging when the outside solar panels that are part of the GSense Solar Hybrid units that are sending electricity to the wall apparatus presented have low energy generation (night time, and cloudy days). Also the apparatus and system has all surfaces coated layers for generating ambient electricity provided in the system. An aqueous delivery apparatus is provided for water to be delivered to the thermal generation apparatus, to increase the efficiency of the apparatus.

A plurality of cameras utilized for stereo 3D vision, are mounted to the surface of the wall panel apparatus for aggregation and processing identification of objects and people utilizing the Human identification key system. The cameras can be connected through the Internet at that specific spatial point where the Wall Panel apparatus is installed. The cameras further provide for the ability of the system to determine measurements of humans, objects and room locations of items as a security system.

A plurality of microphones are provided in the apparatus and system, for Human Key security aggregation and communications, along with a plurality of speakers that provide stereo sound for communication entertainment and the system and user to access.

A spatial point sound and light measurement controller apparatus that is made up of sensors, and vision processors is provided for measurements utilizing sound (sonar) and light (infrared), where distances are aggregated in the apparatus for further processing by the CPU controller in measuring things in the proximity of the area that the Wall Panel apparatus is installed.

A wireless controller board is supplied for wireless energy transfer, and wireless communications with other wireless devices, and communication with the GSense Solar Hybrid devices used in the area.

Another component of the apparatus and system is the plurality of electricity converted to light transmitting and receiving apparatus's. These apparatus's provide the wireless electricity transference in the wall apparatus and system. By utilizing light as a wire in the walls, ceiling, or flooring of a structure, they provide for the elimination of high voltage wires having to be added to construction costs of a dwelling. By placing a transmitter at a point to initiate electricity transference utilizing light transferal, and a receiver at the point of delivery of electricity converting the light to energy, the energy can be delivered anywhere in the building or structure effectively. Another advantage to having wireless electricity transferred in this manner is that the energy does not create EMF radiation in a field in a room. There are studies related to residual magnetism, static build-up, power charges and the fields emitted by the wiring in your walls. The presented apparatus and system greatly reduces those fields being generated.

The apparatus and system also has a plurality of graphene layered EMP protection apparatus's built into all sensitive cases surrounding controllers, data storage and any devices that can be harmed by EMP events in the system. EMP events can come at anytime from many sources, including the suns magnetic energy pulses. This EMP protection apparatus keeps data, and integrated circuits safe in the presence of EMP events.

A Human Key USB processor port for identification of authorized users, is also provided as a integral apparatus in the presented system, for attaching a Human Key identification to energy transfers such as ATM KWH banks where identification of the owner of the electricity is a necessity in getting paid for extra energy created by the user. A Human Key controller board is also included in the apparatus and invention, to speed up the processing utilized in the Human Key identification system.

A plurality of energy and battery controller boards are used in the apparatus and system to manage battery flows, and direct flows of energy to other batteries, in the system. And the system further comprises a plurality of 3D Solar panels solar concentrator apparatus's with light intensity tracking apparatus's, utilizing sensors at specific spatial points so the controllers can determine what angle the solar concentrator device should be rotated for the best efficiency of the system.

Further more a plurality of multi layered graphene solar cell apparatus's are used as the photo voltaic electricity generating devices in the system. And are used in the accessories that work within the apparatus and system presented. Organic graphene solar cells are not toxic and can be produced in an economical way, for best performance in the system.

Also presented is a mobile non stationary wall panel construction apparatus and system version, so that the Wall Panel Apparatus and system can be mounted for use in vehicles, or mobile devices or batteries used to transfer energy to the KWH bank utilizing the KWH Banking controller apparatus. A low voltage local DC energy network adapter, allows the mobile apparatus to transfer DC voltage energy with or without an inverter. The mobile apparatus also works in accomplishing measurements, at spatial point targets, and aggregation of mobile measurements of humans and objects.

By having the Wall Panel Apparatus mounted on a portable mobile battery pack delivering secure electricity to the KWH bank utilizing the KWH Banking controller apparatus, connected to the Human Key with the Human Key authorization controller board, and the Human Key measurement apparatus, for making measurements part of identifying humans, and objects, inside the battery pack the user will have a secure transaction for energy buys and sells. The battery pack also powered by the wall panel apparatus and system can be controlled by a tablet computer, or mobile device through the wireless controller board in the presented system.

Also with ⅓ of the people on earth having no infrastructure related to electricity, or palatable water, the presented apparatus and system includes where the Wall Panel Apparatus and System works integrally with a low voltage DC LED lighting apparatus that can plug into stationary or mobile non stationary wall panel construction apparatus to provide lighting. And further has an integral component attached to the USB Power delivery energy connector for light, and charging, and a low voltage DC heating apparatus that can plug into stationary or mobile non stationary wall panel construction apparatus for material and air heating applications. And further provides a low voltage DC water purifying apparatus that can plug into stationary or mobile non stationary wall panel construction apparatus, a USB Power delivery energy connector for palatable water purification applications, and charging. And further provides a low voltage DC food dehydrator apparatus that can plug into stationary or mobile non stationary wall panel construction apparatus, and a USB Power delivery energy connector for food preservation and storage applications, and charging. And still further provides an itegral component in a low voltage DC water heating and cooling apparatus that can plug into stationary or mobile non stationary wall panel construction apparatus, and a USB Power delivery energy connector for water heating and cooling applications, and charging. And still further provides a graphene laser energy creation apparatus, and a cooling fan apparatus, combined with a heat transfer apparatus, and a Peltier thermo generator apparatus, with a plurality of of electricity generating layers apparatus for the purpose of providing inexpensive energy creation, utilizing hot and cold temperatures.

This apparatus provides cooling for food preservation, cooling for comfort in hot regions, as climate change is making huge populations environments hotter. It also assists in producing low level energy during the day and the night time for people.

The mobile Wall panel apparatus and system also provides a low voltage DC water de-salinization apparatus that can plug into stationary or mobile non stationary wall panel construction apparatus, with a graphene filtration filter apparatus, and a USB Power delivery energy connector for water salt removal applications, and charging for people near sea water, or stranded near sea water.

The Apparatus and invention also works integrally and is part of the system presented a low voltage DC Mobile ATM Battery Pack apparatus that can plug into stationary or mobile non stationary wall panel construction apparatus, along with a USB Power delivery energy connector for KWH energy banking applications, and charging. Also for the AC appliances the apparatus includes a low voltage DC to AC inverter apparatus that can plug into stationary or mobile non stationary wall panel construction apparatus.

And as the Wall Panel Apparatus and System has useful cameras, microphones, speakers, and measurement sensors related to the Human Key user and object identification system built into the system, then added as an integral component is a plurality of laser measurement system apparatus for determining measurements in a free space, along with a plurality of sonic measurement sensors for remote object measurement, and a remote wire frame creation system processor for real time determining of multiple edge measurements. And further provides a spatial point identification component with an apparatus for a user to try products on, and an apparatus for collaboration for measured custom manufacturing, and further providing an apparatus to create and print measurement 3D mesh files on 3D Printers.

### DEFINITIONS

Unless stated to the contrary, for the purposes of the present disclosure, the following terms shall have the following definitions:

A module in software is a part of a program. Programs are composed of one or more independently developed modules that are not combined until the program is linked. A single module can contain one or several routines or steps.

A module in hardware, is a self-contained component.

A system is an assemblage or combination of things, machines, parts or equipment forming a complex or unitary whole. An organized, purposeful structure that consists of interrelated and interdependent elements (components, entities, factors, members, machines, parts or equipment etc.). These elements continually influence one another (directly or indirectly) to maintain their activity and the existence of the system, in order to achieve the goal of the system.

A system has structure, it contains parts (or components) that are directly or indirectly related to each other;

A system has behavior, it exhibits processes that fulfill its function or purpose; A system has interconnectivity: the parts and processes are connected by structural and/or behavioral relationships.

A system's structure and behavior may be decomposed via subsystems and sub-processes to elementary parts and process steps.

A system has behavior that, in relativity to its surroundings, may be categorized as both fast and strong

An Apparatus the technical equipment or machinery needed for a particular activity or purpose. A collection of instruments, machines, tools, parts, or other equipment used for a particular purpose. A machine having a specific function

A solar concentrator apparatus is an apparatus, that utilizes concentrated solar power (also called concentrating solar power, systems generate solar power by using mirrors or lenses to concentrate a large area of sunlight, or solar thermal energy, onto a small area. In the current presented invention apparatus and system we use mirrors for direction and redirection of light to a larger area of solar cells, in a solar panel array. Sensors are also used to calculate intensity of light directed to needed areas for optimal electricity generation.

A graphene super capacitor apparatus is an apparatus used as an integral component of the presented invention, for fast charging, availability and fast distribution distribution to organic batteries, and devices in the system. The cells that make up the current invention apparatus are comprised of mostly graphene sheets, or graphene suspended in a alginate polymer or other organic polymer.

An organic battery storage units is an apparatus used as an integral component for storage in the presented invention system, that utilizes organic materials, that can reduce recycling and toxic results in disposal, and fabrication as related to the environment. An organic battery can be thrown out anywhere and it will not affect the environment.

Aqueous is defined, of or containing water, typically as a solvent or medium.

An aqueous delivery apparatus is a device that delivers water to the thermal infrared electricity generating graphene painted layers apparatus, super capacitor, and battery utilizing sensors related to voltage fluctuations in the presented invention system.

An electricity generator apparatus is a device that generates electricity utilizing magnetic motion, existing motors, photons moving through materials such as graphene, and thermal painted layers from heat specifically or the differences in hot and cold utilizing the Peltier apparatus.

A USB Power Delivery apparatus In July 2012, the USB Promoters Group announced the finalization of the USB Power Delivery (“PD”) specification, an extension that specifies using certified “PD aware” USB cables with standard USB type A and B connectors to deliver increased power to devices with larger energy demand. Devices can request higher currents and supply voltages from compliant hosts—up to 2 A at 5 V (for a power consumption of up to 10 W), and optionally up to 3 A or 5 A at either 12 V (36 W or 60 W) or 20 V (60 W or 100 W). In all cases, both host-to-device and device-to-host configurations are supported.

The intent is to permit uniformly charging laptops, tablets, USB-powered disks and similarly higher power consumer electronics, as a natural extension of existing European and Chinese mobile telephone charging standards. This may also affect the way electric power used for small devices is transmitted and used in both residential and public buildings.

The Power Delivery specification defines six fixed power profiles for the power sources. PD-aware devices implement a flexible power management scheme by interfacing with the power source trough a bidirectional data channel and requesting a certain level of electrical power, variable up to 5 A and 20 V depending on supported profile. The power configuration protocol uses a 24 MHz BFSK-coded transmission channel on the V_{BUS} line.

The USB Power Delivery revision 2.0 specification has been released as part of the USB 3.1 suite. It covers the Type-C cable and connector with four power/ground pairs and a separate configuration channel, which now hosts a DC coupled low-frequency BMC-coded data channel that reduces the possibilities for RF interference. Power Delivery protocols have been updated to facilitate Type-C features such as cable ID function, Alternate Mode negotiation, increased V_{BUS} currents, and V_{CONN}-powered accessories.

USB Power Delivery offers the following features:

Increased power levels from existing USB standards up to 100 W.

Power direction is no longer fixed. This enables the product with the power (Host or Peripheral) to provide the power.

Optimize power management across multiple peripherals by allowing each device to take only the power it requires, and to get more power when required for a given application.

Intelligent and flexible system level management of power via optional hub communication with the PC.

Allows low power cases such as headsets to negotiate for only the power they require.

The Seebeck effect is the conversion of temperature differences directly into electricity and is named after the Baltic German physicist Thomas Johann Seebeck. Seebeck, in 1821, discovered that a compass needle would be deflected by a closed loop formed by two different metals joined in two places, with a temperature difference between the junctions. This was because the metals responded to the temperature difference in different ways, creating a current loop and a magnetic field. Seebeck did not recognize there was an electric current involved, so he called the phenomenon the thermomagnetic effect. Danish physicist Hans Christian Ørsted rectified the mistake and coined the term “thermoelectricity”.

The Peltier effect is the presence of heating or cooling at an electrified junction of two different conductors and is named after French physicist Jean Charles Athanase Peltier, who discovered it in 1834. The Peltier effect can be considered as the back-action counterpart to the Seebeck effect (analogous to the back-emf in magnetic induction): if a simple thermoelectric circuit is closed then the Seebeck effect will drive a current, which in turn (via the Peltier effect) will always transfer heat from the hot to the cold junction. In the presented invention the Peltier effect is used to generate electricity by taking the thermal cold and heat and directing it to the Peltier apparatus for additional electricity generation.

A component a constituent part; element; ingredient. A part of a mechanical or electrical system. One of the parts of something (such as a system or mixture): an important piece of something

A wall paneling construction apparatus and system a flat or curved component, typically rectangular, that forms or is set into the surface of a door, wall, floor or ceiling, used in construction of buildings. Building Construction is the process of preparing for and forming buildings and building systems, and Apparatus which is a complex structure within an organization or system.

An electrical access wall outlet panel is an installable panel with USB and other plugged in electrical sockets, that is used for the purpose of supplying electricity, transferring electricity, receiving electricity and charging batteries in the invention.

A low energy multiple color lasers A laser is a device that emits light through a process of optical amplification based on the stimulated emission of electromagnetic radiation. The term “laser” originated as an acronym for “light amplification by stimulated emission of radiation”. A laser differs from other sources of light because it emits light coherently. Spatial coherence allows a laser to be focused to a tight spot, enabling applications like laser cutting and lithography. Spatial coherence also allows a laser beam to stay narrow over long distances (collimation), enabling applications such as laser pointers. Lasers can also have high temporal coherence which allows them to have a very narrow spectrum, i.e., they only emit a single color of light. Temporal coherence can be used to produce pulses of light—as short as a femtosecond. In this patent we are refering to Low level laser diodes that come in many colors, Red (635 nm), green (520 nm) violet, orange and blue (445 nm). And also infrared (IR) diode laser modules of up to 5 mW. Lasers in the invention are used for spatial point measurements, low level energy transfer, and communications transmittance to spatial point target receivers.

Lasers have many important applications. They are used in common consumer devices such as optical disk drives, laser printers, and barcode scanners. Lasers are used for both fiber-optic and free-space optical communication. They are used in military and law enforcement devices for marking targets and measuring range and speed.

An organic battery organic batteries use matter that has come from a once-living organism, is capable of decay or the product of decay, or is composed of organic compounds. Organic batteries are environmentally friendly and can be safely disposed of anywhere. The batteries used in the presented invention are organic batteries.

A spatial point sound and light measurement controller apparatus The controller apparatus presented here utilizes well know processes, to provide measurements, it has functions utilizing Three-dimensional space which is a geometric three-parameter model of the physical universe (without considering time) in which all known matter exists. These three dimensions can be labeled by a combination of three chosen from the terms length, width, height, depth, and breadth. Any three directions can be chosen, provided that they do not all lie in the same plane as spatial point targets, or coordinates to define position in space.

In mathematics, analytic geometry (also called Cartesian geometry) describes every point in three-dimensional space by means of three coordinates. Three coordinate axes are given, each perpendicular to the other two at the origin, the point at which they cross. They are usually labeled x, y, and z. Relative to these axes, the position of any point in three-dimensional space is given by an ordered triple of real numbers, each number giving the distance of that point from the origin measured along the given axis, which is equal to the distance of that point from the plane determined by the other two 2 axes.

Other popular methods of describing the location of a point in three-dimensional space include cylindrical coordinates and spherical coordinates, though there is an infinite number of possible methods. See Euclidean space.

We also use sound (Ultrasonic Sensor) and light (infrared) (IR) sensors that aggregate distance data for determining distances, and related them to points in space, thereby creating a spatial point coordinated target.

Ultrasonic sensors (also known as transceivers when they both send and receive, but more generally called transducers) work on a principle similar to radar or sonar, which evaluate attributes of a target by interpreting the echoes from radio or sound waves respectively. Active ultrasonic sensors generate high frequency sound waves and evaluate the echo which is received back by the sensor, measuring the time interval between sending the signal and receiving the echo to determine the distance to an object. Passive ultrasonic sensors are basically microphones that detect ultrasonic noise that is present under certain conditions.

Light (infrared) (IR) sensors—which is made of components such as a plurality of IR LED receiver (photodiode) combined with a plurality of 1 IR LED emitters. This kind of sensor takes a continuous distance reading and reports the distance as an analog voltage. analog rangers and digital detectors. Analog ranges provide information about the distance to an object in the ranger's view. Digital detectors provide a digital (high or low) indication of an object at or closer than a predefined distance.

These sensor apparatus components, use triangulation and a small linear CCD array to compute the distance of objects in the field of view. In order to triangulate, a pulse of IR light is emitted by the emitter. The light travels out into the field of view and either hits an object or just keeps on going. In the case of no object, the light is never reflected, and the reading shows no object. If the light reflects off an object, it returns to the detector and creates a triangle between the point of reflection, the emitter and the detector.

The incident angle of the reflected light varies based on the distance to the object. The receiver portion of the IR sensor includes a lens that transmits reflected light onto various portions of the enclosed linear CCD array based on the incident angle of the reflected light. The CCD array can then determine the incident angle, and thus calculate the distance to the object. There are a plurality of IR distance sensors used in this invention.

An electricity converted to light transmitting apparatus in the present invention we use low level laser apparatus like a laser pointer, so we have the electricity brought into the low level laser apparatus, and it is then converted into laser light wave form for transmission to the light converted to electricity receiving apparatus.

A light converted to electricity receiving apparatus in the present invention we use a PV Photo Voltaic apparatus like a solar panel, so we have the electricity received through light transmission and converted into electricity at the receiving end and it is sent to the use area, or a electricity storage device (battery, super capacitor).

Electronegativity, symbol χ, is a chemical property that describes the tendency of an atom or a functional group to attract electrons (or electron density) towards itself. An atom's electronegativity is affected by both its atomic number and the distance at which its valence electrons reside from the charged nucleus. The higher the associated electronegativity number, the more an element or compound attracts electrons towards it. First proposed by Linus Pauling in 1932 as a development of valence bond theory, it has been shown to correlate with a number of other chemical properties.

A thermocouple apparatus is a temperature-measuring device consisting of two dissimilar conductors that contact each other at one or more spots, where a temperature differential is experienced by the different conductors (or semiconductors). It produces a voltage when the temperature of one of the spots differs from the reference temperature at other parts of the circuit. Thermocouples are a widely used type of temperature sensor for measurement and control, and can also convert a temperature gradient into electricity.

A thermal infrared electricity generating graphene painted layers apparatus in the presented invention we use a plurality of painted, and metal conductive materials layered in a thermocouple process utilizing the differences in electronegativity to create electricity from a thermal initiated conversion to electricity apparatus. In the presence of thermal temperature, the electrons in the paint of the present invention flow in a circuit from high electronegativity to low electronegativity. the flow creates a void in the charge balance and therefore attracts the electrons to continuously flow in response to the thermal temperature. The flow of electricity increases in proportion with the increase of thermal heat applied to the painted surfaces.

An electromagnetic pulse (EMP), also sometimes called a transient electromagnetic disturbance, is a short burst of electromagnetic energy. Such a pulse may occur in the form of a radiated, electric or magnetic field or conducted electrical current depending on the source, and may be natural or man-made. EMP interference is generally disruptive or damaging to electronic equipment, and at higher energy levels a powerful EMP event such as a lightning strike can damage physical objects such as buildings and aircraft structures. The damaging effects of high-energy EMP have been used to create EMP weapons. These are typically divided into nuclear and non-nuclear devices. Such weapons, both real and fictional, are becoming known to the public by means of popular culture.

Types of natural EMP event include:

Lightning electromagnetic pulse (LEMP). The discharge is typically an initial huge current flow, at least mega-amps, followed by a train of pulses of decreasing energy.

A solar superstorm flare that has been proven can knock out all unprotected technology and electrical grid systems around the world confirmed by the warnings of experts that the U.S. is unprepared for an electromagnetic pulse, or EMP, event.

Electrostatic discharge (ESD), as a result of two charged objects coming into close proximity or even contact.

Meteoric EMP. The discharge of electromagnetic energy resulting from either the impact of a meteoroid with a spacecraft or the explosive breakup of a meteoroid passing through the Earth's atmosphere.

Types of (civil) man-made EMP event include:

Switching action of electrical circuitry, whether isolated or repetitive (as a pulse train).

Electric motors can create a train of pulses as the internal electrical contacts rotate.

Gasoline engine ignition systems can create a train of pulses as the spark plugs are energized.

Continual switching actions of digital electronic circuitry.

Power line surges. These can be up to several kilovolts, enough to damage electronic equipment that is insufficiently protected.

Types of military EMP include:

Nuclear electromagnetic pulse (NEMP), as a result of a nuclear explosion. A variant of this is the high altitude nuclear EMP (HEMP), which produces a pulse of a much larger amplitude and different characteristics due to interactions with the Earth's magnetic field.

Non-nuclear electromagnetic pulse (NNEMP) weapons.

A Faraday cage or Faraday shield is an enclosure formed by conductive material or by a mesh of such material. Such an enclosure blocks external static and non-static electric fields by channeling electricity through the mesh, providing constant voltage on all sides of the enclosure. Since the difference in voltage is the measure of electrical potential, no current flows through the space. Faraday cages are named after the English scientist Michael Faraday, who invented them in 1836.

A Faraday cage operates because an external static electrical field causes the electric charges within the cage's conducting material to be distributed such that they cancel the field's effect in the cage's interior. This phenomenon is used, for example, to protect electronic equipment from lightning strikes and electrostatic discharges.

To a large degree, though, they shield the interior from external electromagnetic radiation if the conductor is thick enough and any holes are significantly smaller than the wavelength of the radiation. The metal layers are grounded to dissipate any electric currents generated from external or internal electromagnetic fields, and thus they block a large amount of the electromagnetic interference.

A graphene layered EMP protection apparatus which is a component that makes up the case appartus for EMP Electro Magnetic Pulse protection of critical electronic parts in the presented apparatus system invention. The apparatus, is made up of a plurality of angled graphene sheets, that combined act as a Faraday Cage to disperse electro magnetic pulses to the ground, rather than damaging the covered protected electronic components. In the presented invention the graphene layered EMP protection apparatus is attached to the thermal infrared electricity generating graphene painted layers apparatus, so that all electricity generators, and electronic components are protected from EMP damages.

A Human Key USB processor port which is a processor port, so that human key authorizations can be made with a wired device. This is an additional redundancy or test authorization, as the port can be documented installed at a specific spatial point target.

A Human Key controller board is a separate controller for the purpose of speeding up human key identifications, and adding processing power to the system.

A 3D Solar panel with light intensity tracking apparatus is an apparatus that identifies at a specific spatial point how much light is hitting that point. In the solar panel apparatus of the presented invention the surface of the solar panels, uses this apparatus that has light intensity sensors to determine where and at what spatial point more concentrated light should be directed for best electricity generation efficiency.

A multi layered graphene solar panel apparatus is a solar panel created by utilizing a plurality of transparent graphene layers suspended in a brown algae polymer, with a mirror reflective base layer that converts light (photons) into electricity in the presented invention apparatus and system.

A low voltage local DC energy network adapter is an adapter (USB or USB Power Delivery) that can be connected to low voltage devices for electricity, or charging. This adapter is local as it is delivering electricity generated from solar panels and other short distance generation systems.

A spatial point measurement apparatus controller is an apparatus that performs the processing for the measurement aggregations, and determinations of spatial point targets, or reference points in the current system. It is a separate controller as real time processing power is needed by the system for human key authentications, and any measurements needed in the invention.

A mobile battery pack storage apparatus is a battery and super capacitor that is used for transporting energy to other use areas, and the KWH bank and ATM for converting electricity into currency.

A Human Key measurement apparatus is an additional redundancy aggregation apparatus for measuring the physical dimensions of a human or object at the time of registration in the system. It is for the purpose of adding not only image data, and audio data, but proportional measurement data to the tests at the time of identification of a human or object.

A rechargeable graphene battery is a battery apparatus and system that uses organic materials such as graphene for storage of electricity, that can be recharged.

An energy and communications controller board is a management system board for managing energy transfers, intensity lighting data, energy robotics in the system, and communications through VOIP, solar hybrid node to node communications, maintenance and cleaning of the Solar panels in the presented system.

A principle is a law or rule that has to be, or usually is to be followed, or can be desirably followed, or is an inevitable consequence of something, such as the laws observed in nature or the way that a system is constructed. The principles of such a system are understood by its users as the essential characteristics of the system, or reflecting system's designed purpose, and the effective operation or use of which would be impossible if any one of the principles was to be ignored. Functions in the presented invention, are a rule or fact of nature underlying the working of the system, or working within the system. Also devices that communicate and work with in the system, or artificial devices that can work within the presented apparatus and system invention must follow the principles of the invention. Some principles related to this invention are that all devices must require low energy, a USB connection, a wireless light transferal ability, a rechargeable battery in all devices, an EMP cage protection for all devices.

A low voltage DC LED lighting apparatus is a low voltage LED light apparatus that plugs into the presented wall panel socket for charging, communications and power, and has principles built in to the apparatus for device to device communication, sensing, low energy storage, and working specifically with the presented apparatus system invention.

A low voltage DC heating apparatus is a low voltage heating apparatus that plugs into the presented wall panel socket for charging, communications and power, and has principles built in to the apparatus for device to device communication, sensing, low energy storage, and working specifically with the presented apparatus system invention.

A low voltage DC water purifying apparatus is a low voltage water purifying apparatus that plugs into the presented wall panel socket for charging, communications and power, and has principles built in to the apparatus for device to device communication, sensing, low energy storage, and working specifically with the presented apparatus system invention.

A low voltage DC food dehydrator apparatus is a low voltage dehydrator apparatus that plugs into the presented wall panel socket for charging, communications and power, and has principles built in to the apparatus for device to device communication, sensing, low energy storage, and working specifically with the presented apparatus system invention.

A low voltage DC water heating and cooling apparatus is a low voltage water heating and cooling apparatus that plugs into the presented wall panel socket for charging, communications and power, and has principles built in to the apparatus for device to device communication, sensing, low energy storage, and working specifically with the presented apparatus system invention.

A low voltage DC water de-salinization apparatus is a low voltage water de-salinization apparatus that plugs into the presented wall panel socket for charging, communications and power, and has principles built in to the apparatus for device to device communication, sensing, low energy storage, and working specifically with the presented apparatus system invention.

A low voltage DC Mobile ATM Battery Pack apparatus is a battery pack that stores and transfers electricity to other users, and ATM KWH energy banks for conversion into currency or use. The Battery Pack has principles built in to the apparatus for device to device communication, sensing, energy storage, and working specifically with the presented apparatus system invention.

A power inverter, or inverter, is an electronic device or circuitry that changes direct current (DC) to alternating current (AC). The input voltage, output voltage and frequency, and overall power handling depend on the design of the specific device or circuitry. The inverter does not produce any power; the power is provided by the DC source.

A power inverter can be entirely electronic or may be a combination of mechanical effects (such as a rotary apparatus) and electronic circuitry. Static inverters do not use moving parts in the conversion process.

A low voltage DC to AC Inverter Apparatus is an inverter that converts electricity from DC to AC and delivers electricity to devices, other users, and ATM KWH energy banks. The Inverter Apparatus has principles built in to the apparatus for device to device communication, sensing, energy storage, and working specifically with the presented apparatus system invention.

A graphene laser cold energy creation apparatus is an apparatus that utilizes a plurality of transparent graphene layers, rotated at specific angles, and then applies a plurality of low level lasers for the purpose of creating a cold energy cooling affect as a component in the invention.

A cooling fan apparatus is a mechanical fan which is a machine used to create flow within a fluid, typically a gas such as air. The fan consists of a rotating arrangement of vanes or blades which act on the fluid. The rotating assembly of blades and hub is known as an impeller, a rotor, or a runner. Usually, it is contained within some form of housing or case. The cooling agents customarily employed are air and a liquid, either alone or in combination. In some cases, direct contact with ambient air (free convection) may be sufficient; in other cases, it may be necessary to employ forced-air convection, created either by a fan or by the natural motion of the hot body. Liquid is typically moved through a continuous loop in the cooling system by a pump. In the current invention a mechanical fan is used to blow air over the graphene laser cold energy creation apparatus, which cools the air further than the ambient room temperature. And the cooling fan apparatus directs the needed cooling to refrigeration unit, hot parts, and Peltier thermo generator apparatus for creating additional electricity in the system invention presented.

A heat transfer apparatus is an apparatus that takes any heat created in the system invention and utilizes a mechanical fan to cool and direct the heat to the Peltier thermo generator apparatus for creating additional electricity in the system invention presented.

A Peltier thermo generator apparatus is a heat and cooling sensitive electricity generation apparatus in the presented invention that works with a plurality of layers of painted material and metal to generate electricity with ambient local heat. The peltier apparatus has included, p and n semiconductor material between 2 plates, one cold and one hot utilized to take the difference in temperatures of each plate, to generate electricity. Also the graphene laser cold energy creation apparatus, heat transfer apparatus and the cooling fan apparatus have directed pathways to the Peltier thermo generator apparatus for consistent electricity generation. This layered apparatus is applied to case components of the presented invention, and is one of the principles and is a main component in any development related to all components and devices that communicate and work with the presented apparatus and system invention.

A laser measurement system apparatus is a system for utilizing light sensor processes to determine spatial point measurements.

A sonic measurement sensors is a system for utilizing sound & sonar sensor processes to determine spatial point measurements.

A remote wire frame creation system processor is a high performance processor that calculates a wire frame of spatial point measurements, and stores the data for use in the system.

A spatial point identification component is a component and processor performed measurement system that works by aggregating measurement information and storing the information during registration by a user in the human key system. Measurement at specific spatial point targets of the human face are aggregated and stored for later reference along with audio, video and image data in identification of a human or object in the presented system invention. Spatial Point Identification is the 19th redundancy test of authentication in the presented system.

A human key data access manager component is an apparatus utilizing a set of processes performed on a system on chip processor that manages any users entry into the presented system that has been registered and is authorized by the human key system, in the presented invention.

A human key administrative access manager component is an apparatus utilizing a set of processes performed on a system on chip processor that manages any administrative users entry into the presented system that has been registered and is authorized by the human key system, in the presented invention.

A mobile, hand held manager component is an apparatus or system on chip, that plugs into mobile phone, tablet or other computer to manage the presented system.

An infrared and color bands laser light receiver and transmitter is a low level laser light transmitter and photo voltaic receiver apparatus for the transference of electricity without wires in the presented system as a main component.

An infrared or visible light laser diode distance evaluator component is a spatial point traget measuring apparatus utilizing light sensors and processor for converting data and storing data, related to managing measurements in the presented system.

A data storage component is a hard drive, or solid state hard drive that has the ability to use low energy, and adheres to the principles of the presented apparatus and system invention.

A human key security and identification component is a password system that identifies a user in 19 tests, related to measurements, facial recognition, speaker recognition, and sensing information aggregated at the time of registration in the system.

A request anything transmitter and receiver component is an apparatus system on chip for performing requests to users in a network, for services, product information, decisions, and suggestions in the current invention presented.

A sensor apparatus for the measurement of distances is the use of sensors to create spatial point coordinates, for the purpose of measuring humans and objects, for identification, manufacturing, services, and measurement uses in the system presented.

A digital semantic agent apparatus is an apparatus used in the presented invention system for user defined activities performed by the machine instead of by human intervention. A robot is an example of a digital semantic agent apparatus. The digital semantic agent apparatus can be programmed to run acting independently to some degree semi-autonomous, and in some respects in the system to act in an autonomous performance of instructions programmed into the apparatus in the invention.

A robot is a mechanical or virtual artificial agent, usually an electro-mechanical machine that is guided by a computer program or electronic circuitry. Robots can be autonomous or semi-autonomous.

An autonomous robot is a robot that performs behaviors or tasks with a high degree of autonomy, which is particularly desirable in fields such as space exploration, cleaning floors, mowing lawns, waste water treatment and delivering goods and services.

A mini sonic distance measurement component is a sound sensor component for measuring distances of objects in the presented system invention.

An Avatar an icon or figure representing a particular person in computer games, Internet forums, etc.

An Avatar Digital Semantic Agent is an Avatar combined with the Digital Semantic Agent connected to the authentication, and identification security measures, and security tests of the human key system and apparatus in the presented system invention.

A Virtual World and Real World registry of objects measurements apparatus is the utilization and combination of all the presented principles, an apparatus presented in this system invention for applications in the Virtual World and Real World. Real World registry in this apparatus is aggregated and stored utilizing real world objects in real time, utilizing multiple senses aggregation such as images, measurements and audio utilizing a plurality of sensors, aggregated and attached to files aggregated by the human key apparatus and system, combined with CODEFA for object identification. The Virtual World aggregation is of human key attached files that have already been stored in a folder and database.

Create a wire-frame of spatial point targets from the object being measured is the process performed by a computer processor, that is an autonomous and semi-autonomous process in the system invention, that can be performed in registration, or in authentication aspects of the system presented invention. A wireframe is a skeletal three-dimensional model in which only lines and vertices are utilized and represented, taken from spatial point measurements of shapes, objects and humans edge features.

Virtual means not real, The opposite of virtual is real, absolute, or physical.

A virtual world is a computer-based simulated environment. The term has become largely synonymous with interactive 3D virtual environments, where the users take the form of avatars visible to others. These avatars can be textual, two or three-dimensional graphical representations, or live video avatars with auditory and touch sensations. In general, virtual worlds allow for multiple users.

The user accesses a computer-simulated world which presents perceptual stimuli to the user, who in turn can manipulate elements of the modeled world and thus experience a degree of telepresence. Such modeled worlds and their rules may draw from the reality or fantasy worlds. Example rules are gravity, topography, locomotion, real-time actions, and communication. Communication between users can range from text, graphical icons, visual gesture, sound, and rarely, forms using touch, voice command, and balance senses.

A 3D Scanner apparatus utilizes a plurality of USB cameras and low level laser line pointer components in the presented system invention.

MakerScanner Open Source 3D Scanning.

The basic way the MakerScanner works is by:

projecting a line onto an object

recording the line's position relative to any flat reference

computing the 3d geometry based on those numbers

Parts

PS3 Eye USB Camera

Laser line pointer

2 AA battery holder

2 AA batteries

MeshLab is an open source, portable, and extensible system for the processing and editing of unstructured 3D triangular meshes.

The system is aimed to help the processing of the typical not-so-small unstructured models arising in 3D scanning, providing a set of tools for editing, cleaning, healing, inspecting, rendering and converting this kind of meshes.
The system is heavily based on the VCG library developed at the Visual Computing Lab of ISTI-CNR, for all the core mesh processing tasks and it is available for Windows, MacOSX, and Linux. The MeshLab system started in late 2005 as a part of the FGT course of the Computer Science department of University of Pisa and most of the code (˜15 k lines) of the first versions was written by a handful of willing students.
This project is actively supported by the 3D-CoForm project.
Blender 2.73a

### Developer(s) Blender Foundation

Initial release 1995
Stable release 2.73a/Jan. 20, 2015; 5 days ago

### Written in C, C++ and Python

Operating system Microsoft Windows, Mac OS X, GNU/Linux, FreeBSD

### Size 51.4 MB

Type 3D computer graphics software
License GNU General Public License v2 or later[2]
Website blender.org

Blender is a professional free and open-source 3D computer graphics software product used for creating animated films, visual effects, art, 3D printed models, interactive 3D applications and video games. Blender's features include 3D modeling, UV unwrapping, texturing, raster graphics editing, rigging and skinning, fluid and smoke simulation, particle simulation, soft body simulation, sculpting, animating, match moving, camera tracking, rendering, video editing and compositing. Alongside the modeling features it also has an integrated game engine.

The Blender Foundation and online developer community are proud to present Blender 2.73

Several Cycles Rendering updates, improvements and new features, support for GeForce 9xx GPUs.

New fullscreen mode, improved Pie Menus, 3D View can now display the world background.

Knife-tool now allows freehand smart cuts, and more improvements were made in selection tools, Bevel Modifier and Shapekeys.

Unwrapping UVs was improved, strength is now enabled for Grab and Snake Hook brushes, better visual feedback mode for painting with masks.

Sequencer now can show a backdrop, strips can be snapped to others along with other improvements.

Freestyle NPR Rendering has a new SVG exporter add-on, along with other improvements.

Grease Pencil had a major update, it is now possible to edit and animate strokes! New draw styles, and imporvements in user interface.

Collada Importer was updated, improving the compatibility with other software's bone concepts.

Add-ons: FBX improved importing/exporting armatures, some Python API changes could need some Add-ons to be updated!

As usual several other minor updates and improvements, and lot of bugfixing also in this release.

Virtual measurements in the virtual and real world are accomplished by the apparatus and system invention presented utilizing Makerscanner, Meshlab and Blender open source processes in system on chip processor in the invention.

Measurement is a method for determining quantity, capacity, or dimension. All systems of measurement use units whose amounts have been arbitrarily set and agreed upon by a group of people. Several systems of measurement are in common use, notably the United States Customary System and the metric system. The metric system has been officially adopted as the international standard for use in science, providing scientists all over the world with an efficient way of comparing the results of experiments conducted at different times and in different places.

A virtual measurements is a measurement made in a virtual world. In the real world we can measure specific spatial points of humans and objects with sensors such as light and sound sensors, with processes processed on integrated circuits in a computer. In a virtual world all objects are created as images, video, and text files, so measurement is performed as a step of processes to determine quantity, capacity and dimension. In the presented invention we use a plurality of both Virtual and Real World apparatus for measurements.

An object registry an object is something material that may be perceived by the senses, or a thing that you can see and touch and that is not alive. A registry is a place for registering, a book for official records, or the place where such records are kept. So in the presented system invention the object registry apparatus functions with sensors, storage and human key attachment to a process of steps to aggregate object information, and store images, measurements, and other sensing data, in folders, and databases for reference at a later date.

A search engine of measurements is the apparatus for searching folders, databases for measurement data related to object registry subjects and data, and human key registry subjects and data.

An Avatar sensing system is utilized in the current invention for utilizing the avatar digital semantic agent, combined with a connection to sensing apparatus in the presented invention. User can have their Avatar perform sensing tasks, remotely only by a human who is authorized, with the human key to access the Avatar sensing system.

Digital Semantic Agents multiple autonomous or semi-autonomous robots, or machine performing functions of the human apparatus, in the presented system invention.

A Real People live humans, that are not a machine or apparatus.

A GEO targeting system a system used in the presented apparatus invention combined with spatial point targeting. Geo targeting in geomarketing and internet marketing is the method of determining the geolocation of a website visitor and delivering different content to that visitor based on his or her location, such as country, region/state, city, metro code/zip code, organization, IP address, ISP or other criteria. A common usage of geo targeting is found in online advertising, as well as internet tele-vision with sites such as iPlayer and Hulu, which restrict content to users geolocated in specific coun-ties; this approach serves as a means of implementing digital rights management.

A spatial point targeted sensors is an apparatus that places special sensors at specific spatial points. The process can be performed by digital semantic agents, remotely with mobile devices and in the virtual world with x y and z coordinates in the presented system and invention.

A Human Cloud is utilization of cloud computing through multiple nodes in the presented apparatus system invention, where data is stored across a distributed network of solar hybrid nodes, so that there is no single point of failure of loss of data in the system protected with the human key (that identifies humans) and object key (that identifies objects). Cloud computing involves deploying groups of remote servers and software networks that allow centralized data storage and online access to computer services or resources. Clouds can be classified as public, private or hybrid.

An Avatar Cloud is a utilization of cloud computing with access by Avatar's, virtual representations of humans, robots through multiple nodes in the presented apparatus system invention, where data is stored across a distributed network of solar hybrid nodes, so that there is no single point of failure of loss of data in the system protected with the human key (that identifies humans) and object key (that identifies objects).

A digital or analog measurement data aggregated where Analog data is data that is represented in a physical way. Where digital data is a set of individual symbols, analog data is stored in physical media, whether that's the surface grooves on a vinyl record, the magnetic tape of a VCR cassette, or other non-digital media. Much of the world's natural phenomena can be translated into digital text, image, video, sound, etc. For example, physical movements of objects can be modeled in a spatial simulation, and real-time audio and video can be captured using a range of systems and devices. Analog data may also be known as organic data or real-world data. CODEFA object registration is done with digital and analog data when combined with the Human Key for aggregation and processing in the presented system invention.

An advertisement creator module is defined as a software module that is engaged by a user through a computer or other equivalent electronic device to upload media such as images and video to create advertisements which follow a predetermined process or protocol.

A QR code module is an abbreviation for Quick response code. A QR code module is a specific matrix barcode (or two-dimensional code) that is readable by dedicated QR barcode readers and camera telephones. The code consists of black modules arranged in a square pattern on a white background. The information encoded may be text, URL, or other data. QR codes are automatically created by the QR code module when a user registers, and also are created when a user creates or uploads an advertisement to the system, and are also created when a user creates a campaign in the system, so that each user, advertisement and campaign has attached its own QR code, for use in the system. Also scan able data embedded for decoding in the QR code attached to Users, Advertisements and Campaigns can be changed for the purpose of marketing, relating information, and tracking as the user needs to change it with a QR code administration dashboard editor function. In this invention QR codes are also issued, used and linked to color bands to identify which property the color band is attached to, and what original property it came from.

A Payment module is defined as software module that is engaged by a user through a computer or other equivalent electronic device to pay bills, pay other users, move funds from one registered users bank account or virtual bank account to another users bank account or virtual bank account, or to outside bank accounts.

A software module is defined as a series of process steps stored in an electronic memory of an electronic device and executed by the processor of an electronic device such as a computer, pad, smart phone, or other equivalent device known in the prior art.

A human key, human identification key or human key module is defined as a collection of processor steps, within a computer server, and/or networked to other computer servers, that processes, facial and voice data, in a method where a person looking at the cam and talking or saying a phrase is identified, in a computer that work in real time to store and cross reference data for identification and security, as related to using an individual unique human being as a user name, password, key or any other unique identifier of that unique human being, a Human Key can be attached to and/or substituted for QR code uses throughout the invention.

The “Human Key” server is a computer/machine that uses Human Key software and modules to identify a specific individual human, by first taking and aggregating information using a camera or plurality of cameras, with audio voice recording, combined with other aggregated data to show unique human aspects for identification, then uses this same data to verify identity of the human when called for by the machine server.

When addressing the functions of this invention of “Connecting a human key to objects and content for identification” we must first provide processes for registration of humans, and registration of objects in the system. Then after the registration we can attach, connect, and show rightful identification of humans and objects. So what we are presenting here is the processes a programmer skilled in the art can use to Register, encrypt de-encrypt, use, connect, attach files, objects, and humans for rightful ownership and use in networks.

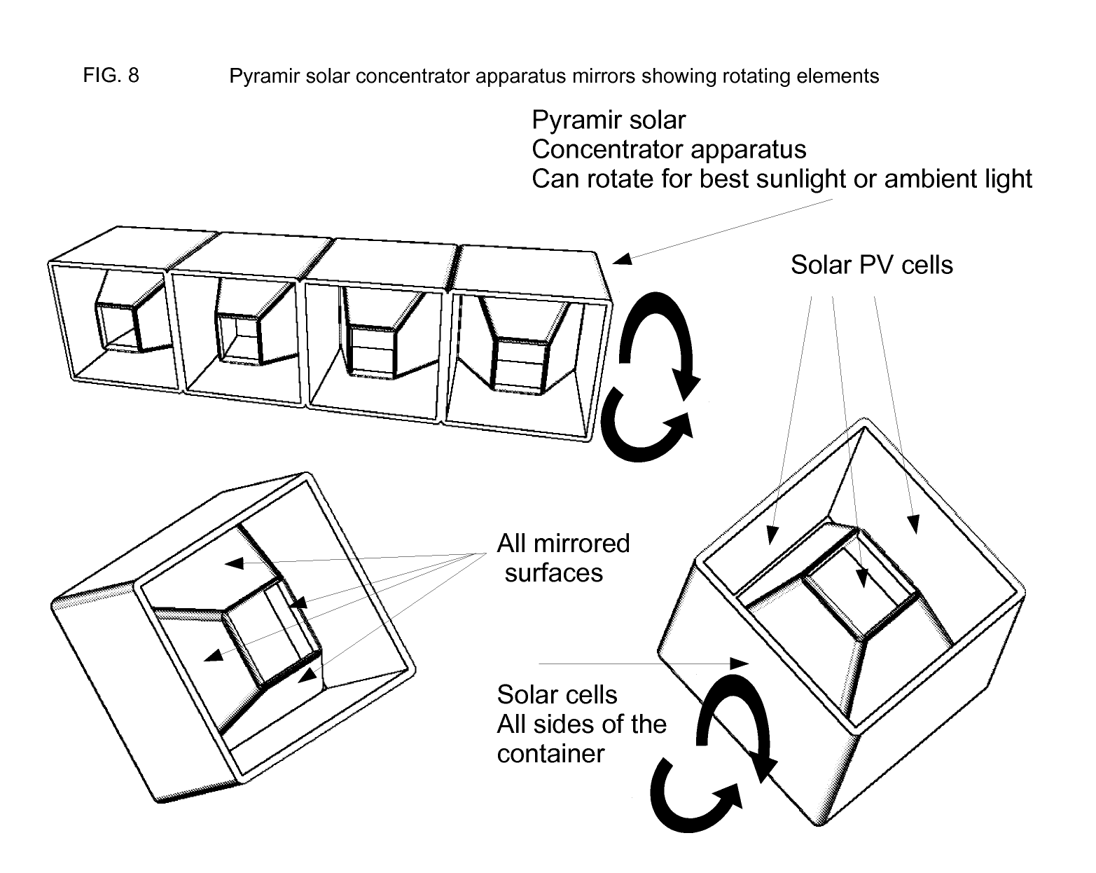

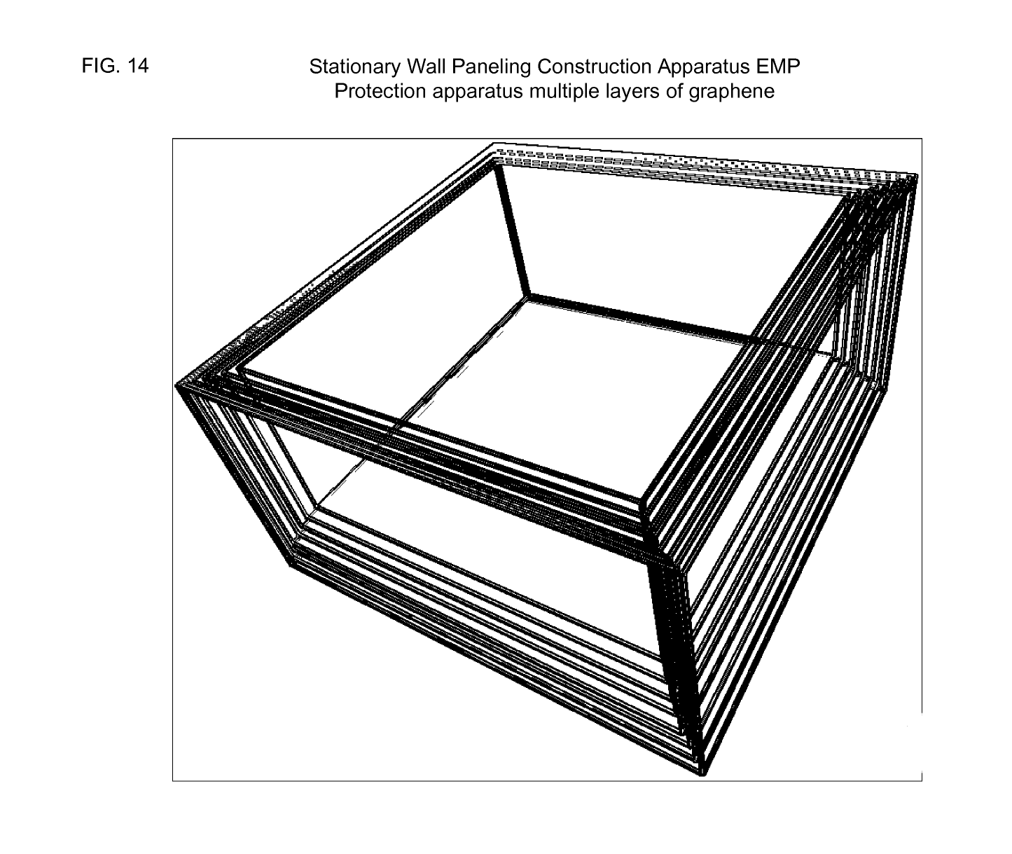

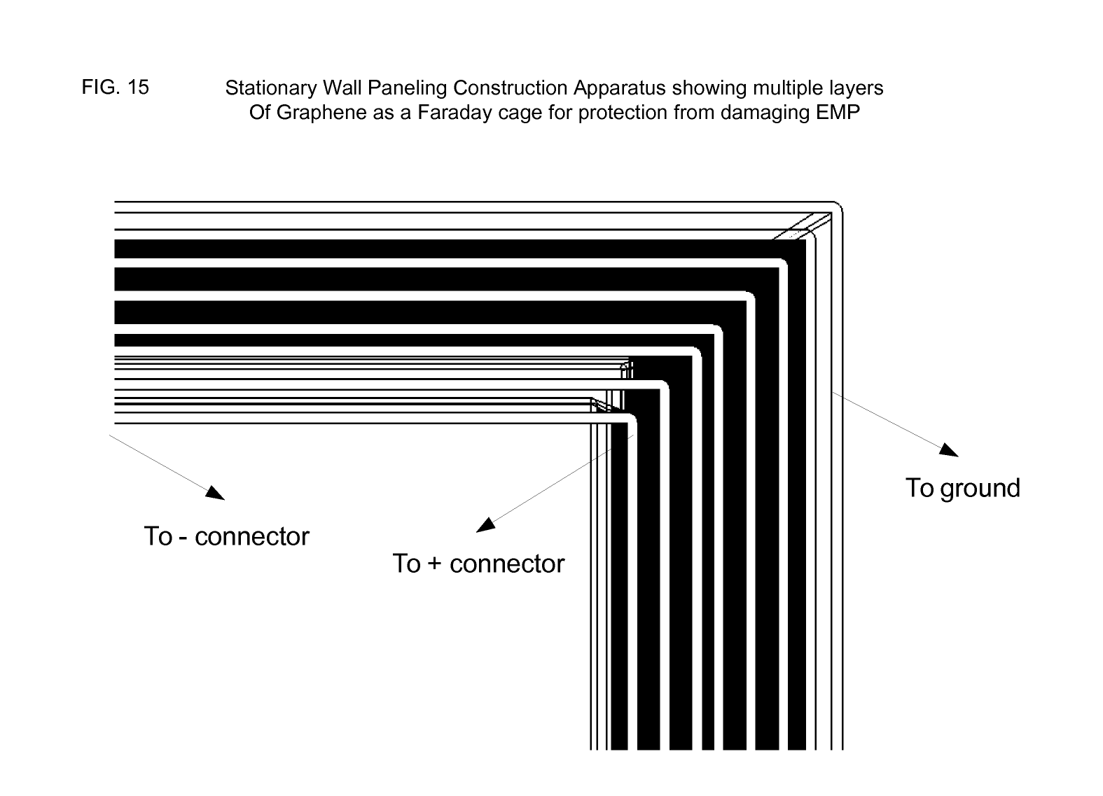

To accomplish these processes we show using a “Human Key” human registration system and a “CODEFA” object registration system. These processes are clearly shown in patent application Ser. No. 12/860,936 included here in it's entirety in FIG. 8, FIG. 9, and FIG. 15 which shows how Human Key works, and steps related to taking files and creating a unique CODEFA number to identify an object from video, or images.

By having a Human Key that identifies humans and having a CODEFA number registered for identification of objects you have the human key attached, connected and provided to an Object by way of CODEFA encryption number for identification.

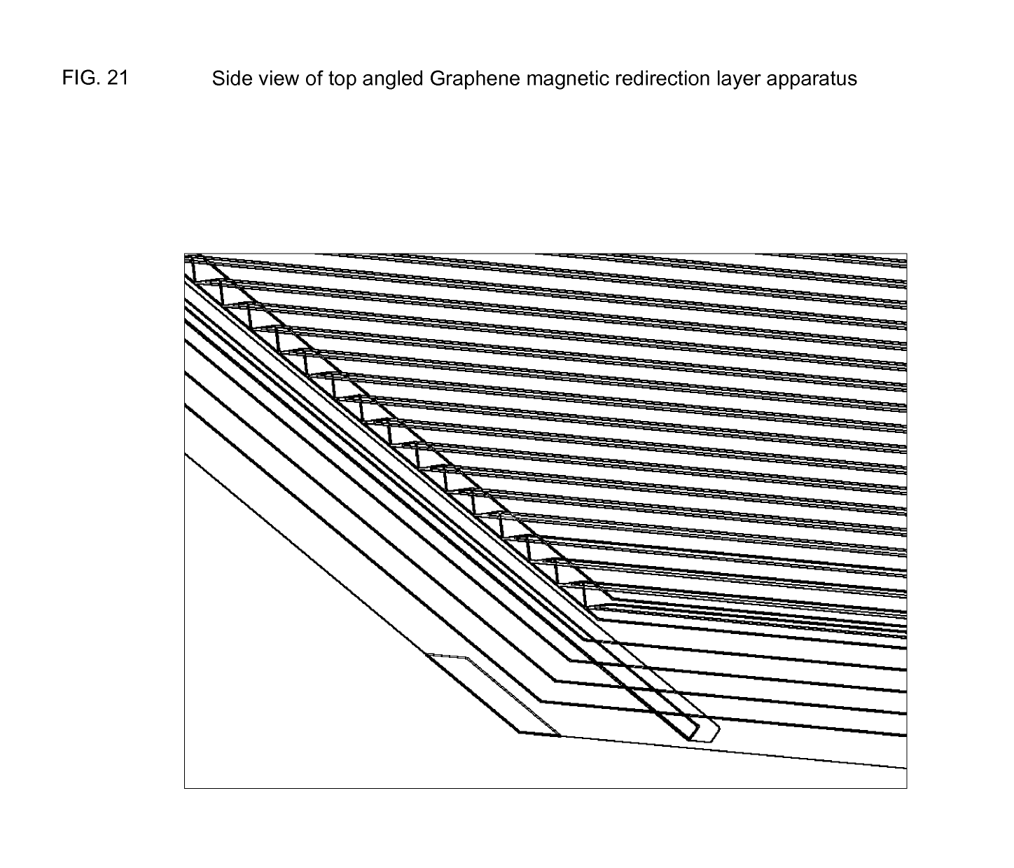

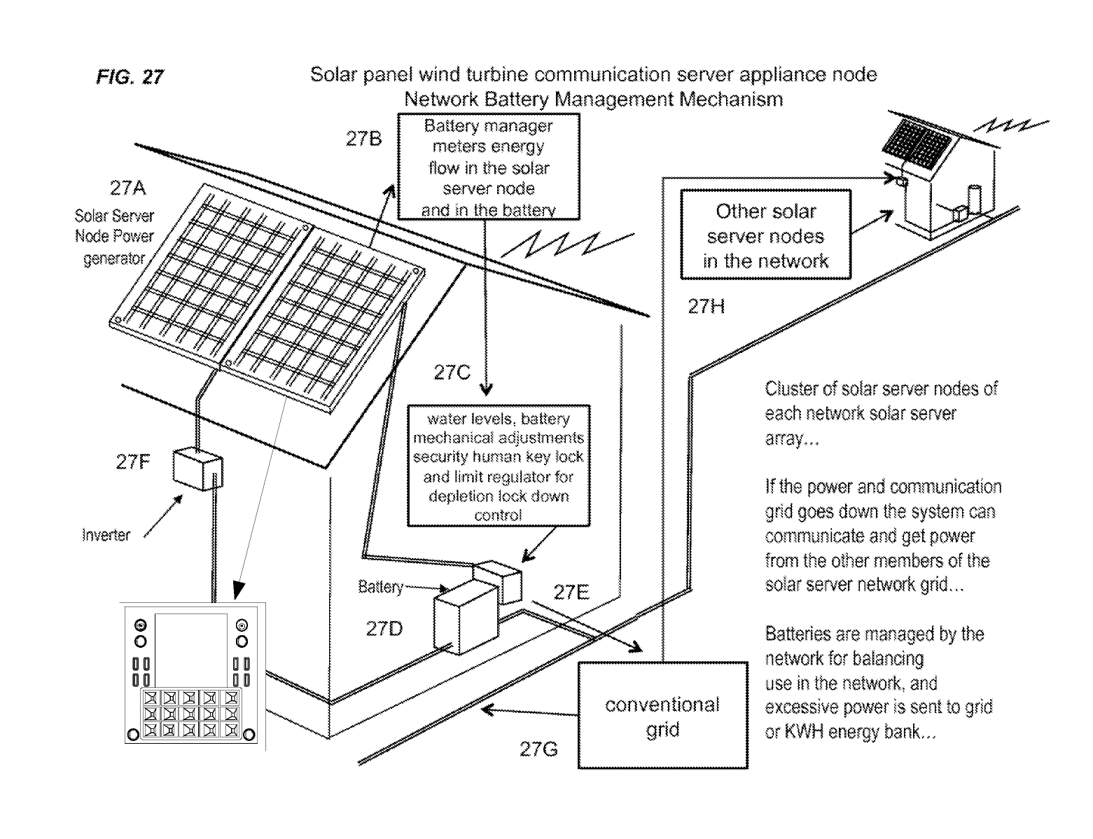

FIG. 17, 18, 20 shows human key processes. In FIG. 21 we show 17 pattern matching processes that make up the Human Key. FIG. 27 shows the initial registration with Human Key.

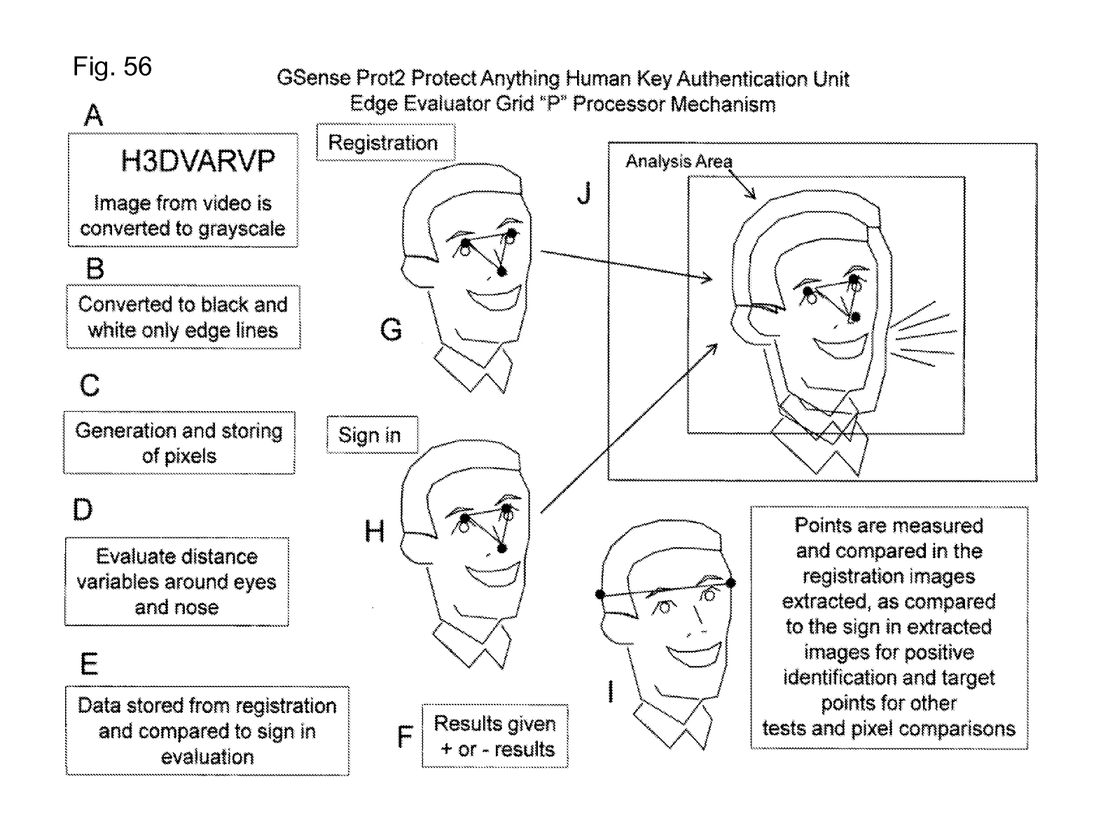

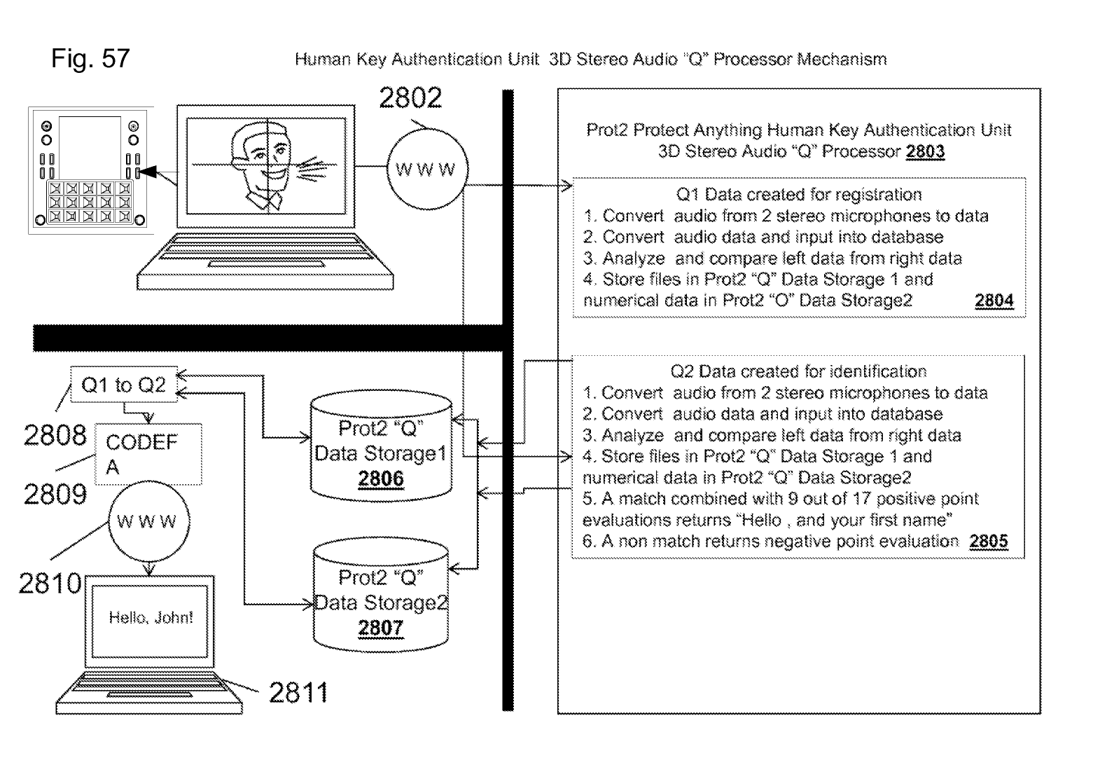

FIG. 57 through 82 show the individual processing methods used in a processor in a computer, that are used by the human key as steps to providing multiple redundant identification processes aggregated at the time of registration of a human or an object in the invention. Any programmer with average skills could take these steps and create the human key registration system. These steps are taken from application Ser. No. 12/860,936:

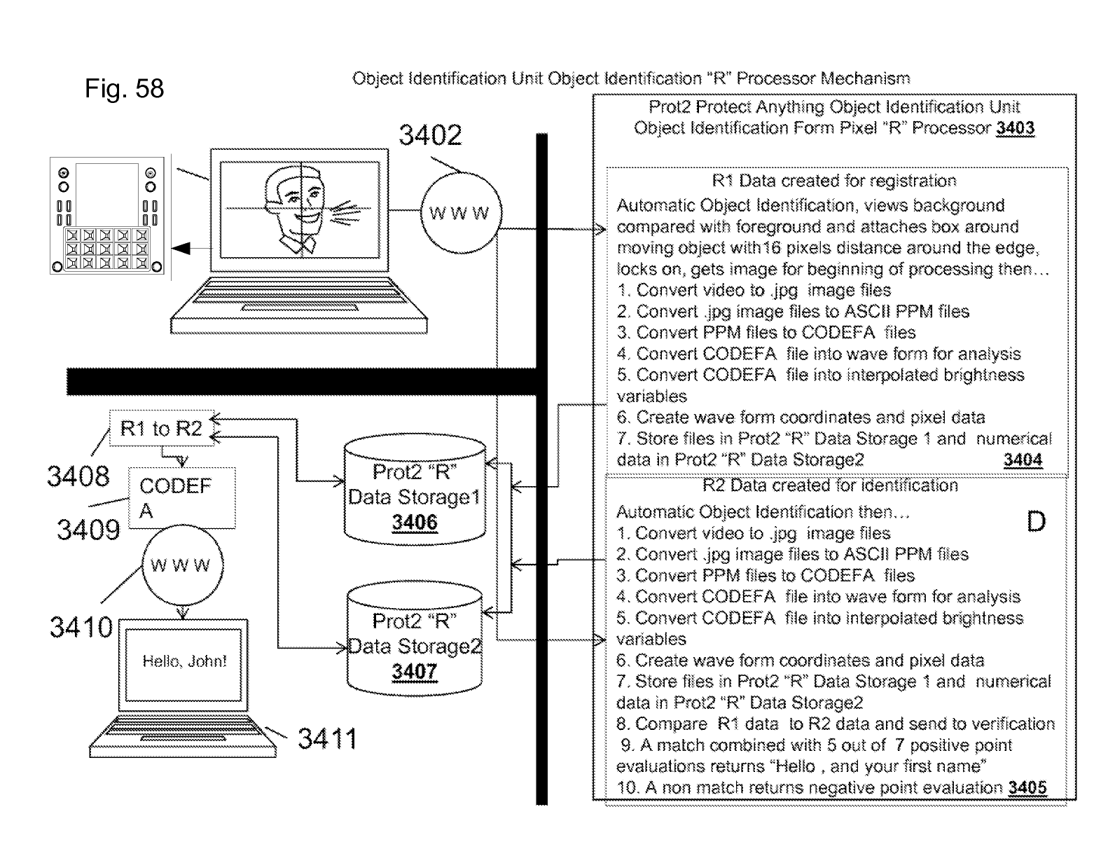

FIG. 58 “A” Processor which converts video and images to Wave Form for analysis, for as demonstrated in C registration and a separate process method for D identification. Then it shows where the CODEFA object identification registration system is added at the end of the process. CODEFA takes an objects video or image and breaks it down to a file that can not be used, or encrypts it, and assigns it a number. Then CODEFA reassembles the object identification file for use later on by de-encrypting it.

A plurality of individual registration processes, steps, for encrypting and de-encrypting and future identification are carried out at the time of registration of humans, and objects in the invention. A programmer with skill in the art would be able to create these video, audio, image, and measurement processes with the information provided in this invention.

These exactly defined steps are from figures in application Ser. No. 12/860,936:

FIG. 58 Human Key Video Wave Form process

(converts and transforms video at time of registration to wave form and saves files)

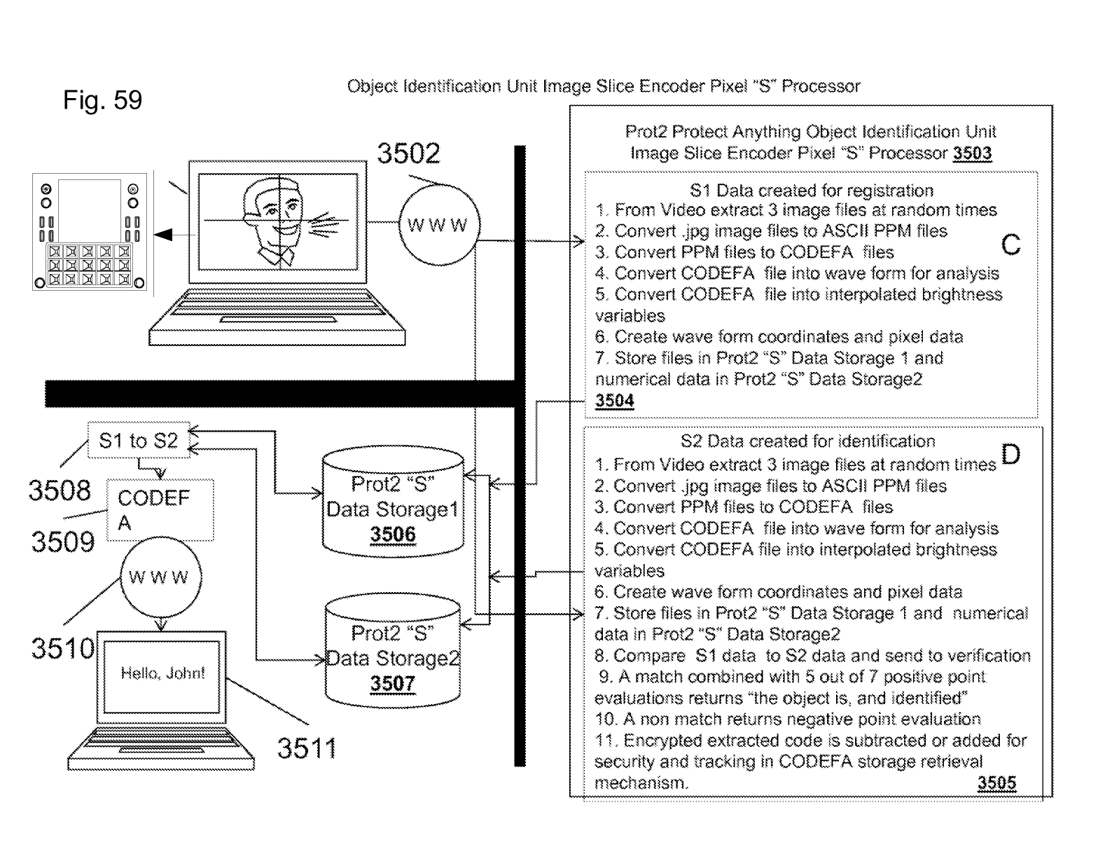

FIG. 59 Human Key Audio Wave Form process

(converts and transforms audio at time of registration to wave form and saves files)

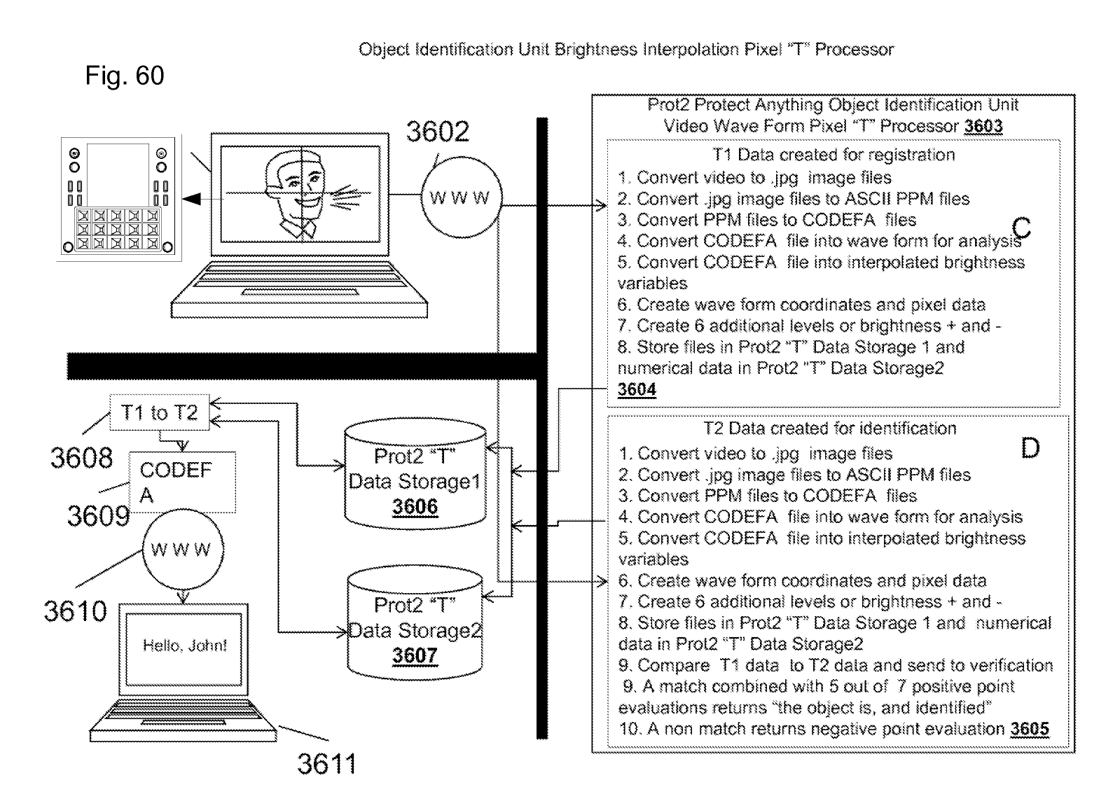

FIG. 60 Human Key Triple Image Interpolation process

(aggregates and transforms images from video and saves files)

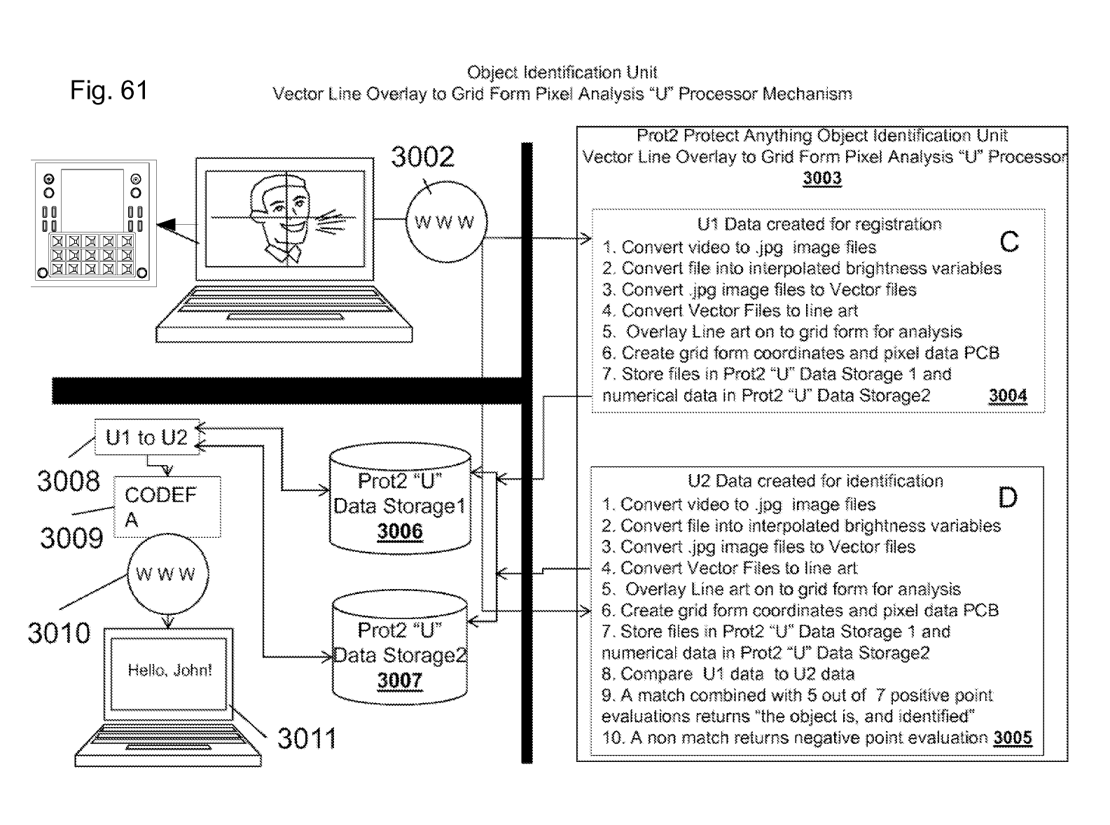

FIG. 61 Human Key Image Slice Encoder process

(aggregates and transforms images from video and saves files)

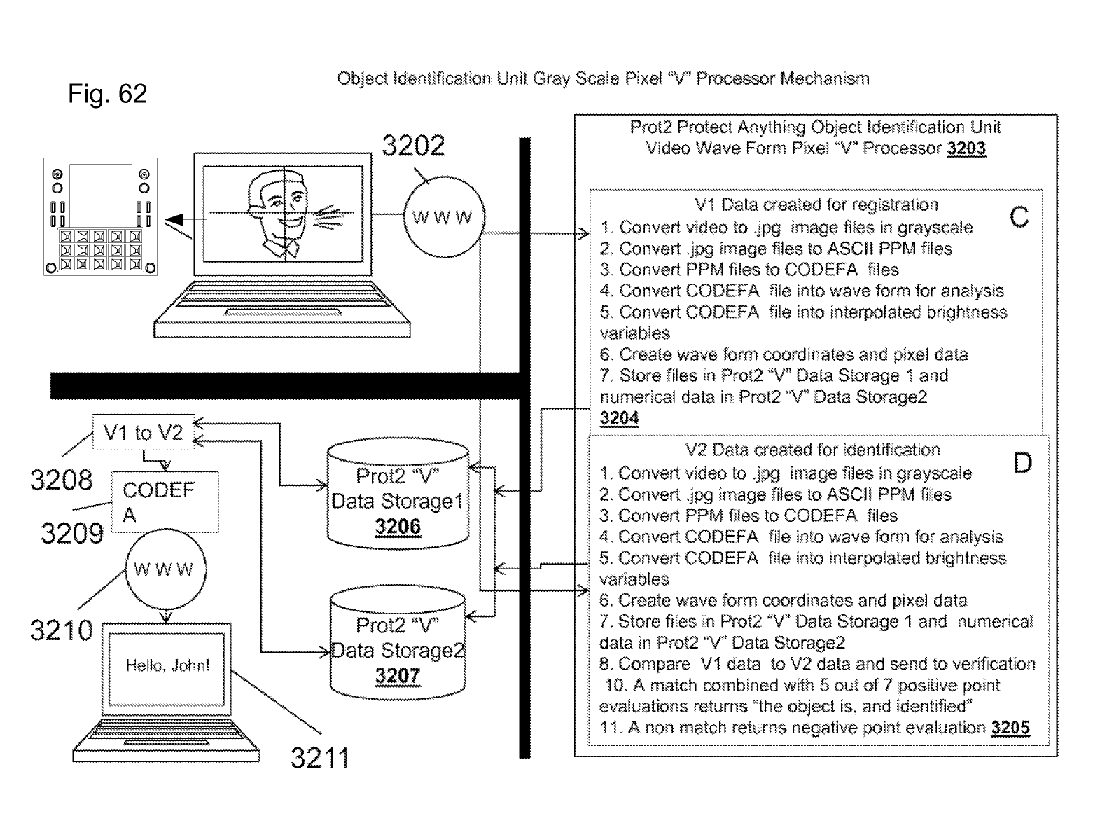

FIG. 62 Human Key Brightness Interpolation process

(aggregates and transforms set brightness files for future low light conditions in identification)

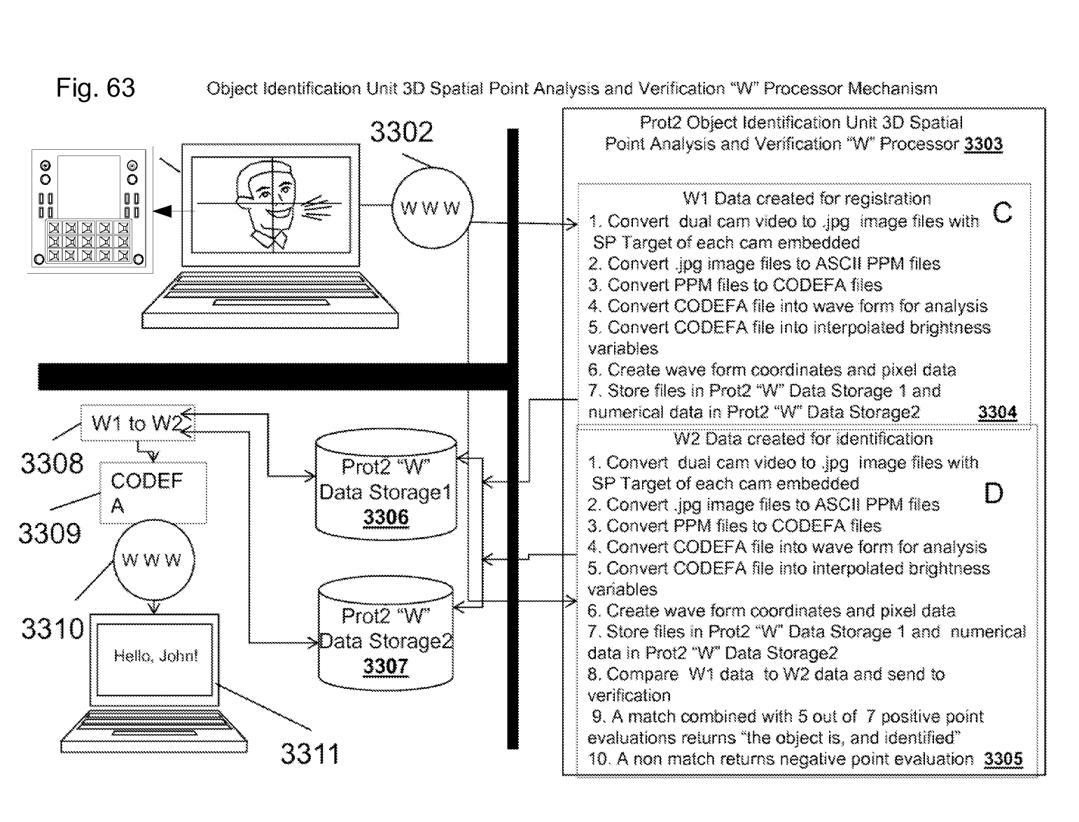

FIG. 63 Human Key Video Audio Specific Point Comparative Analysis process

(aggregates and transforms specific spatial point for video aggregation and audio aggregation)

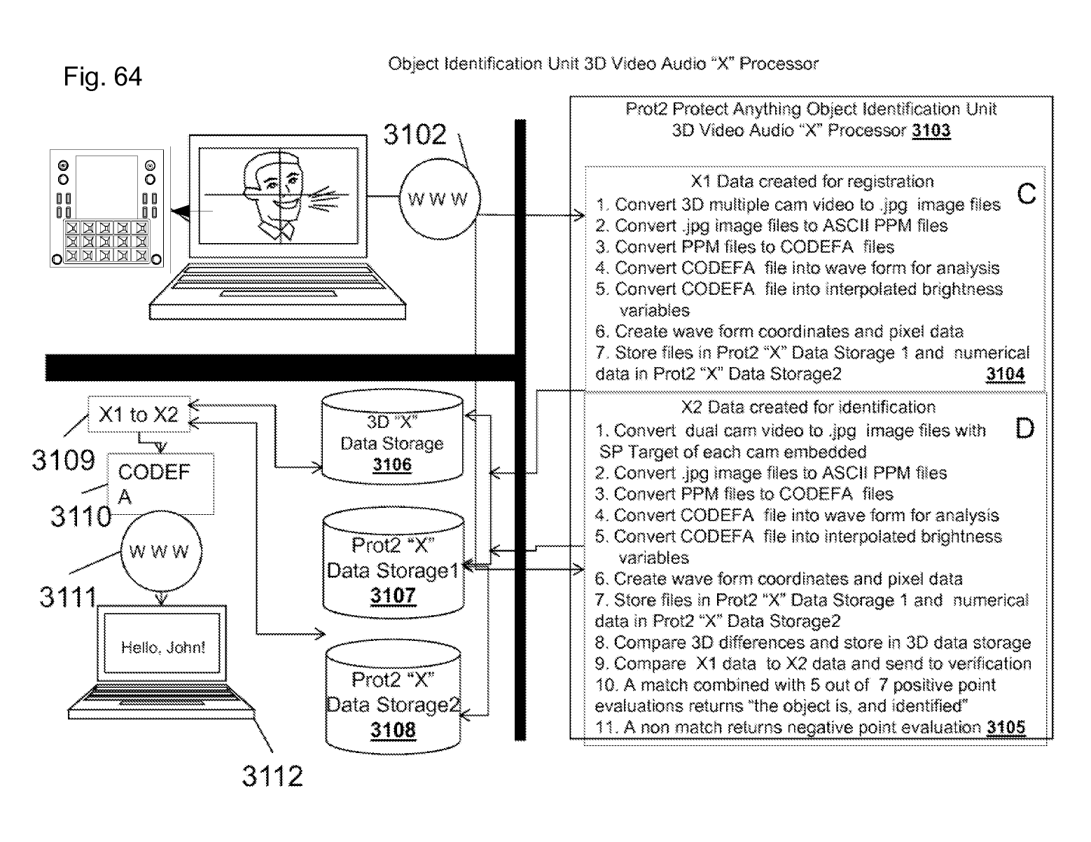

FIG. 64 Human Key Human Semantic Phrase Comparison process

(aggregates and transforms audio human phrase for comparison in identification)

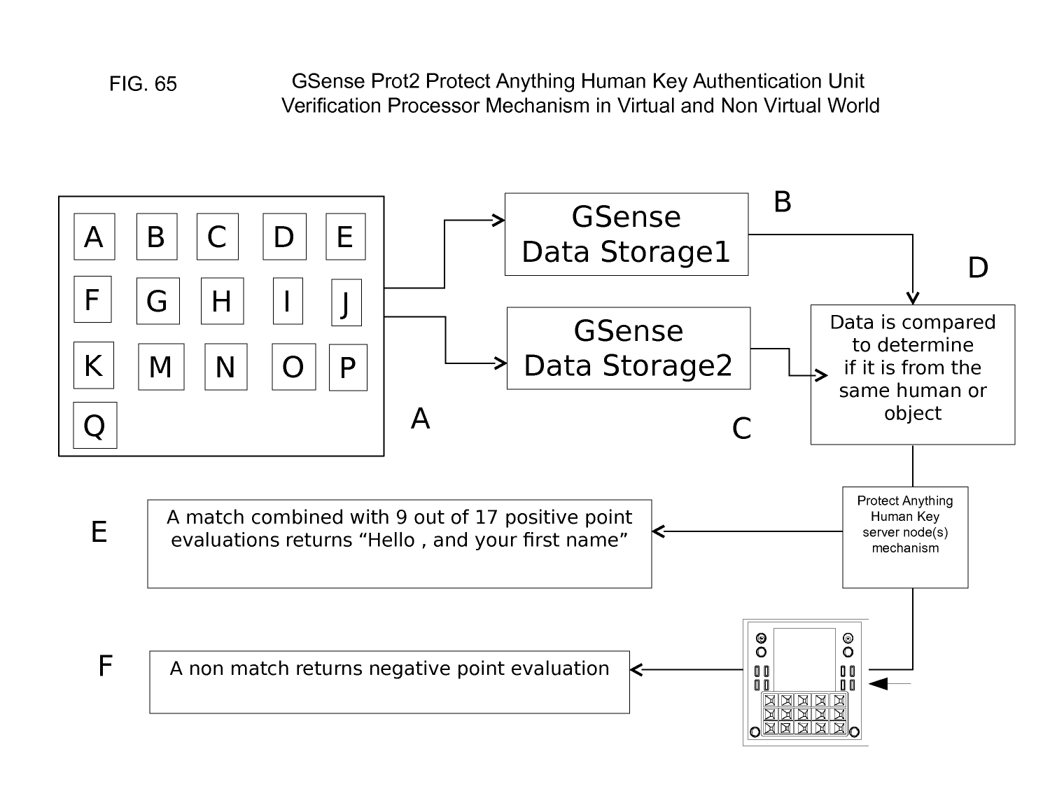

FIG. 65 Human Key Video Audio Phrase Comparative Spatial Point Analysis process

(aggregates and transforms spatial point of targeted Video audio)

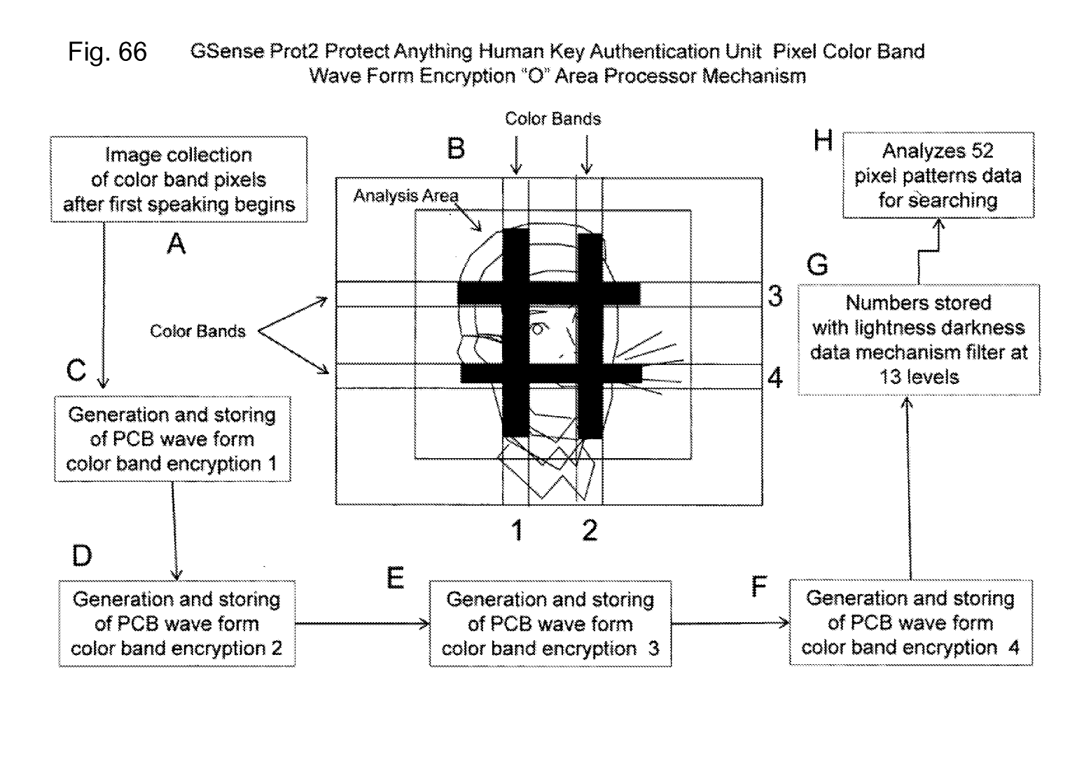

FIG. 66 Human Key 3D Spatial Point Analysis process

(aggregates and transforms with multiple cameras and multiple microphones)

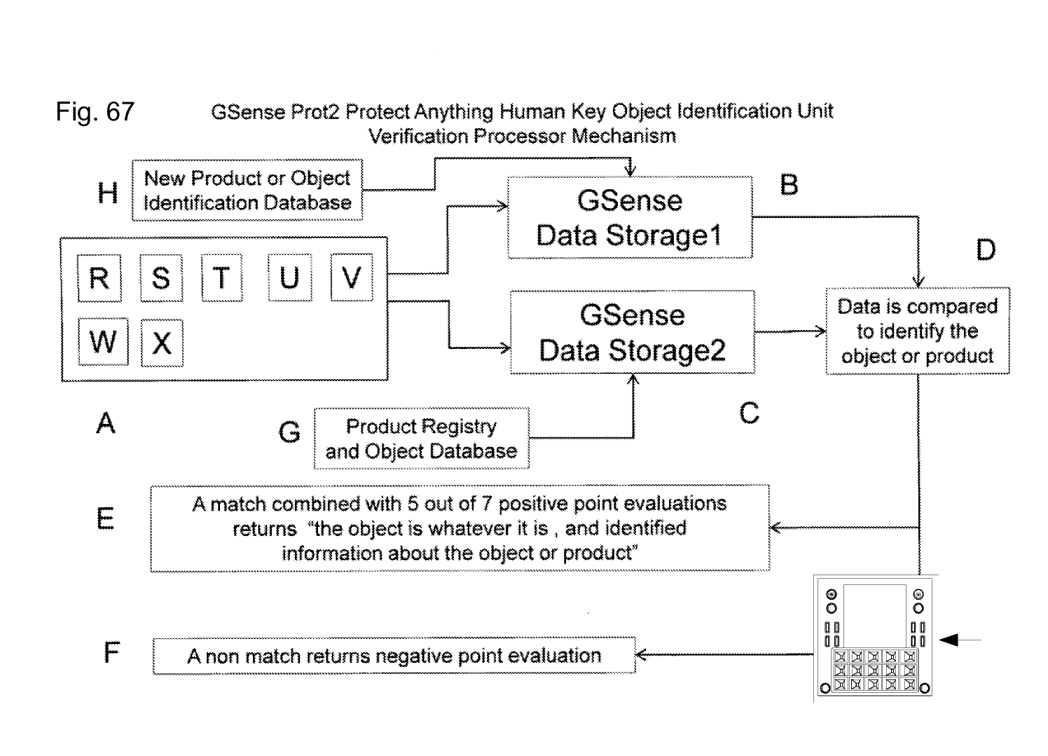

FIG. 67 Human Key Object Identification process

(aggregates and transforms whether the specimen is a human or object)

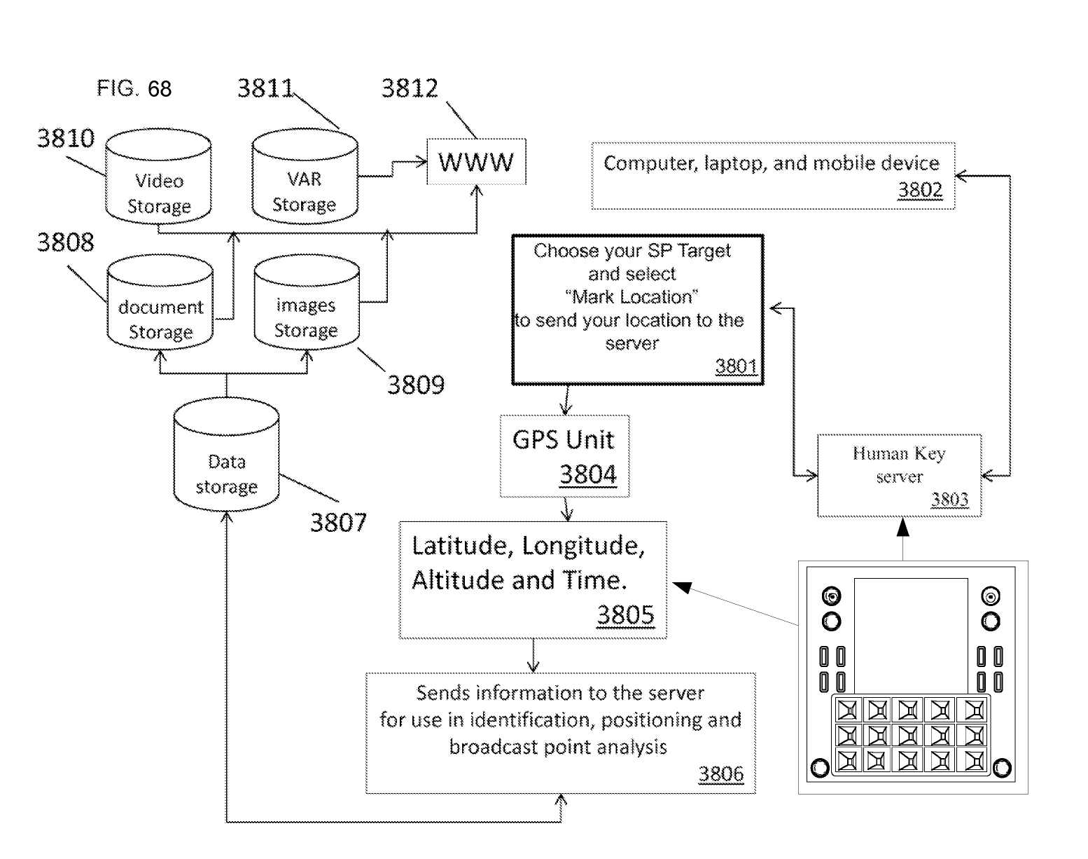

FIG. 68 Demonstrates how object identification works in the invention process

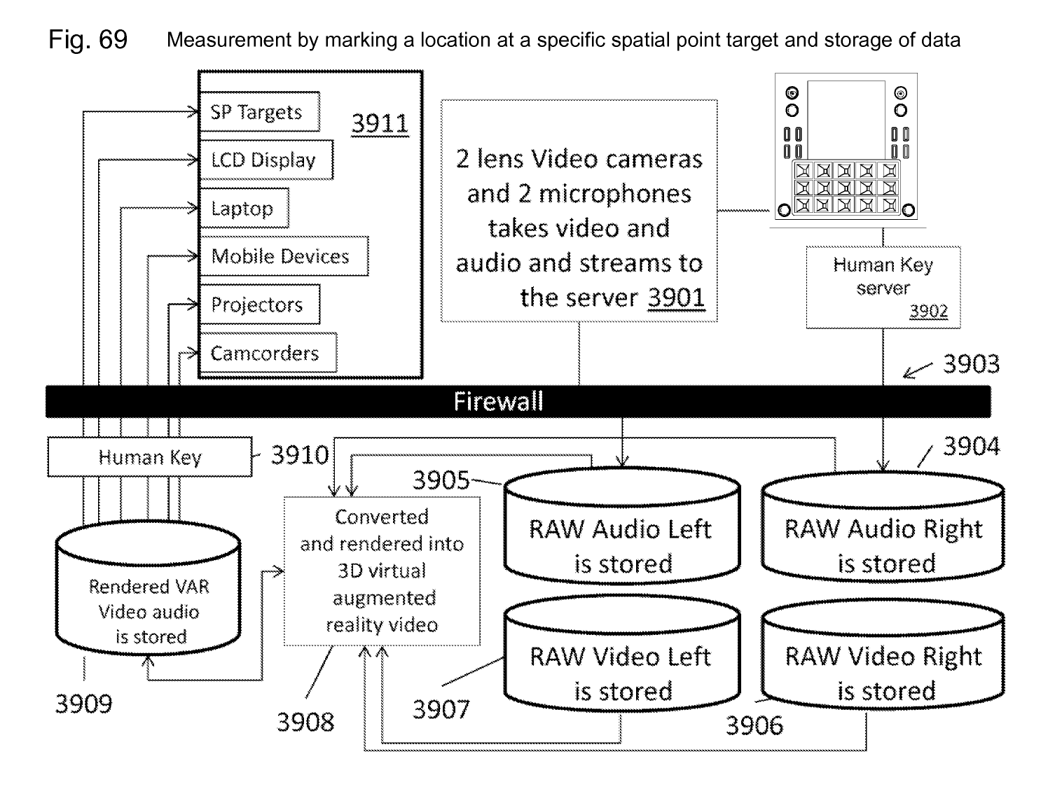

FIG. 69 Shows Human Key Audio Distant Interpolation Method process

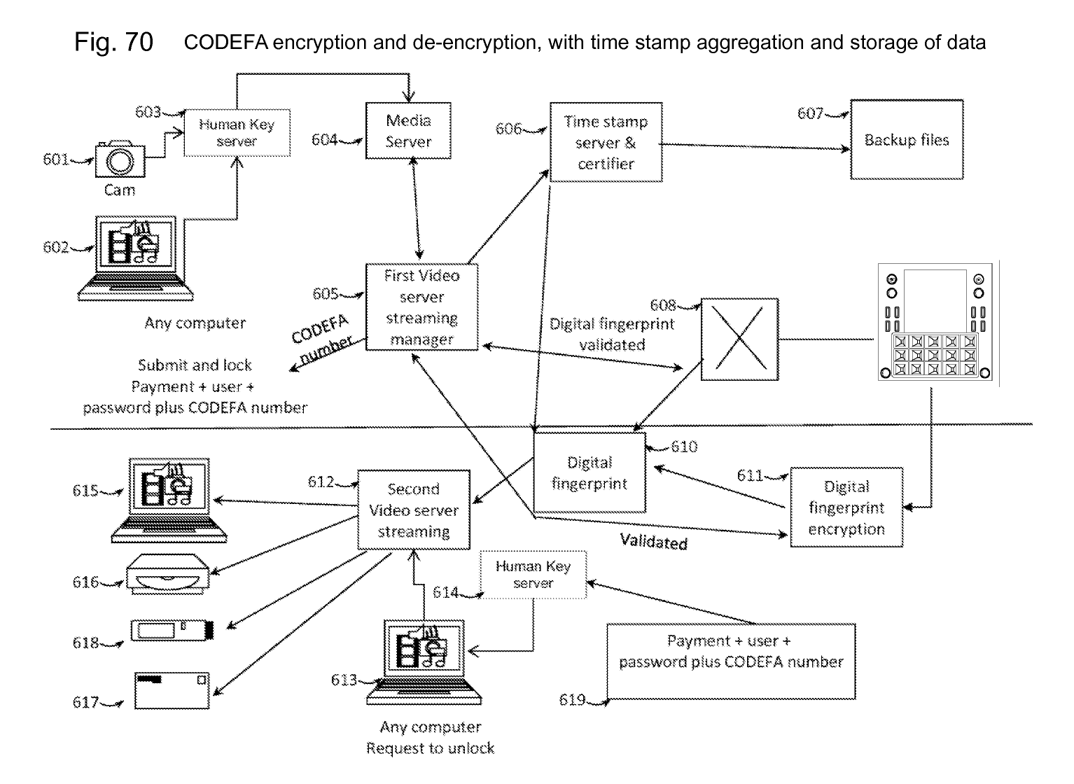

FIG. 70 Human Key 3D Video Audio process

(aggregates and transforms a plurality of cameras and microphones data)

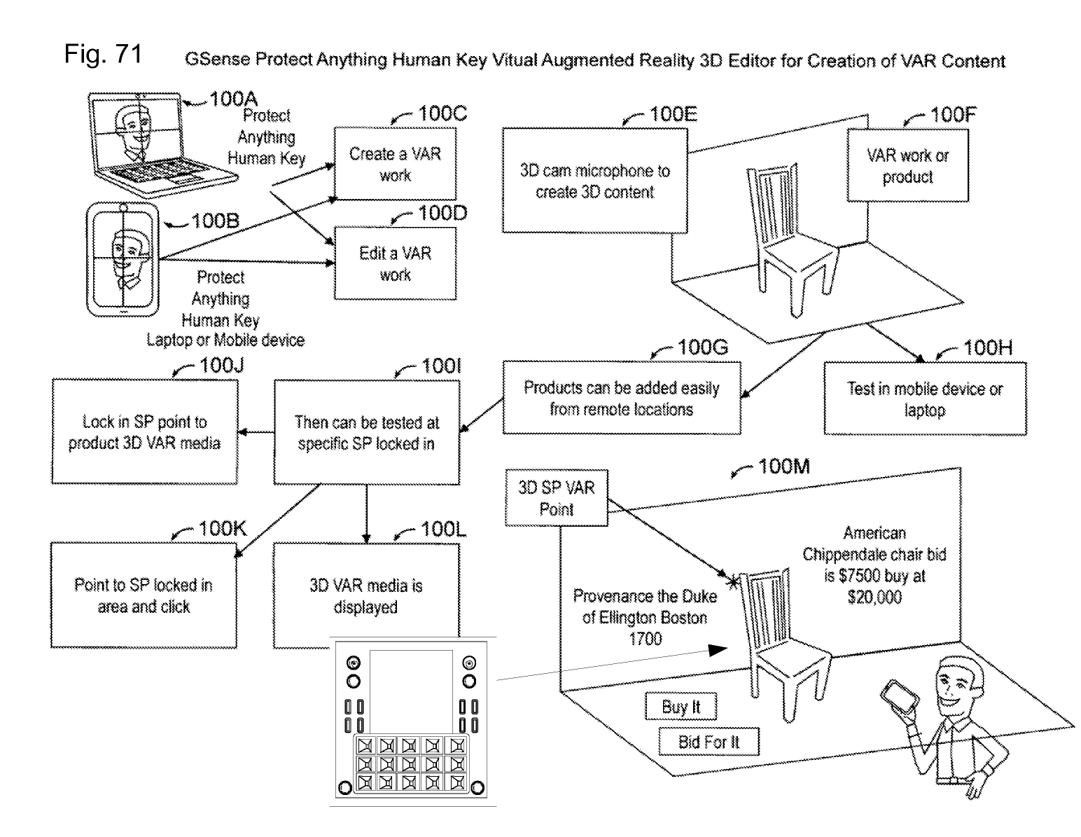

FIG. 71 Human Key Gray Scale process

(aggregates and transforms non color gray scale files for low level lighting and identification)

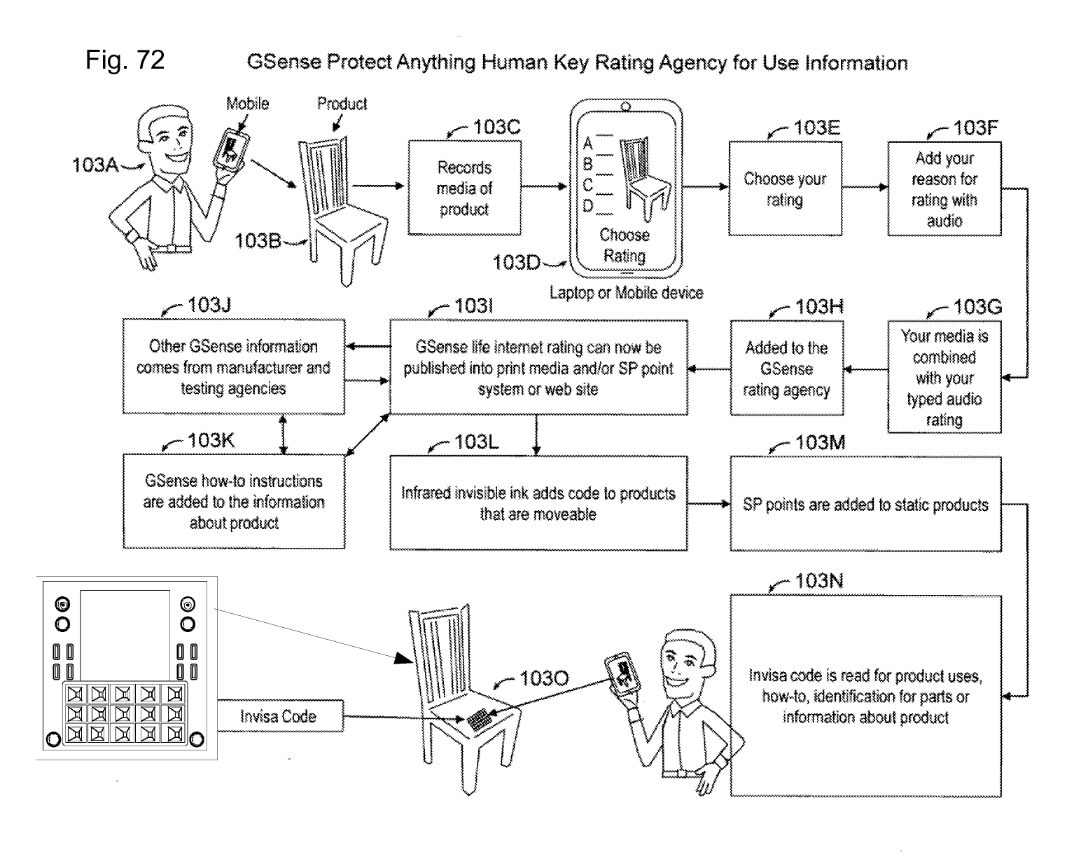

FIG. 72 Human Key Color Band Wave Form Encryption process

(aggregates and transforms edge detection, in color bands for identification)

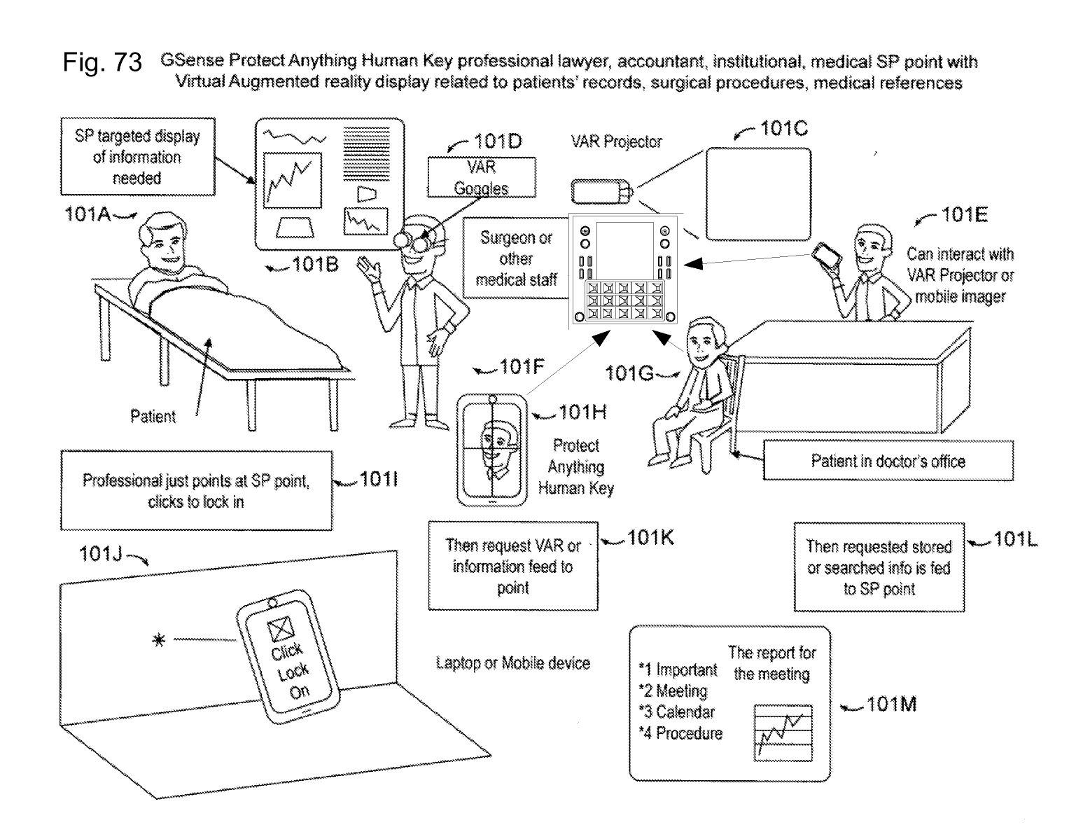

FIG. 73 Human Key 3D Stereo Audio process

(aggregates and transforms in multiple microphones)

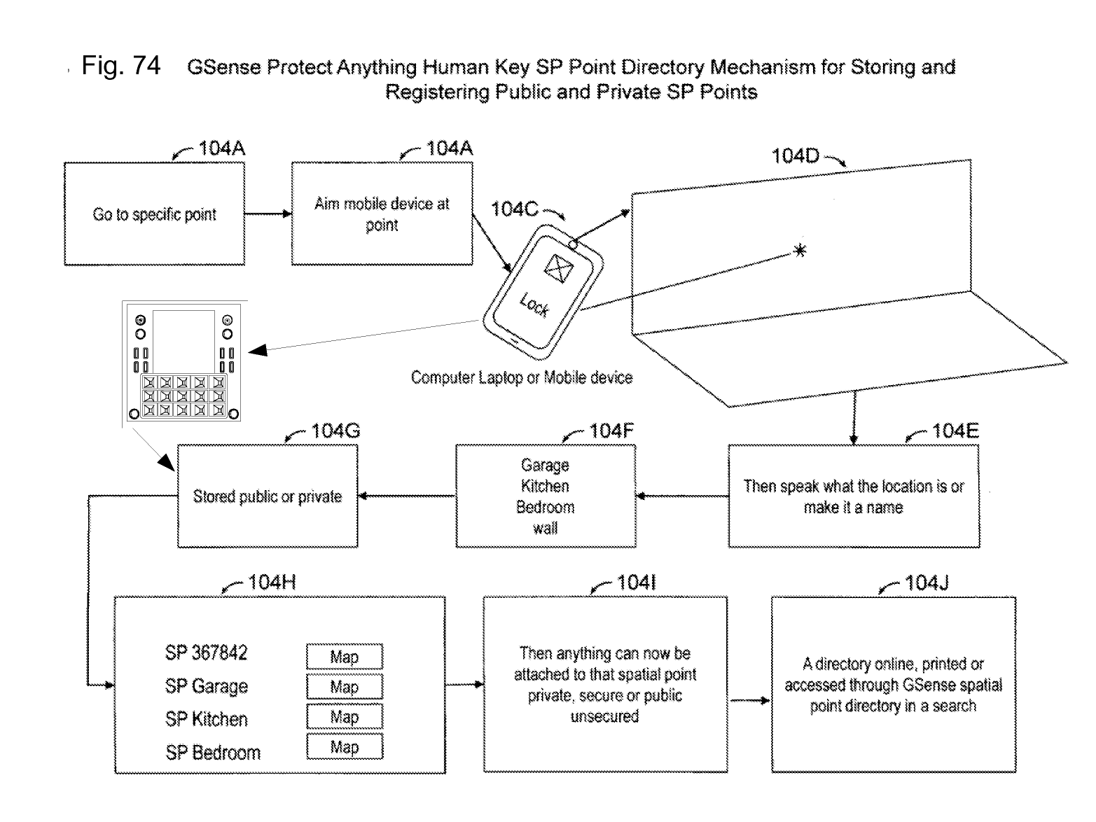

FIG. 74 Human Key Vector line Overlay to Grid Form process

(aggregates and transforms edge shapes and line data for identification)

The next method processes are for Object Aggregation and Identification at the time of registration and verification in the invention:

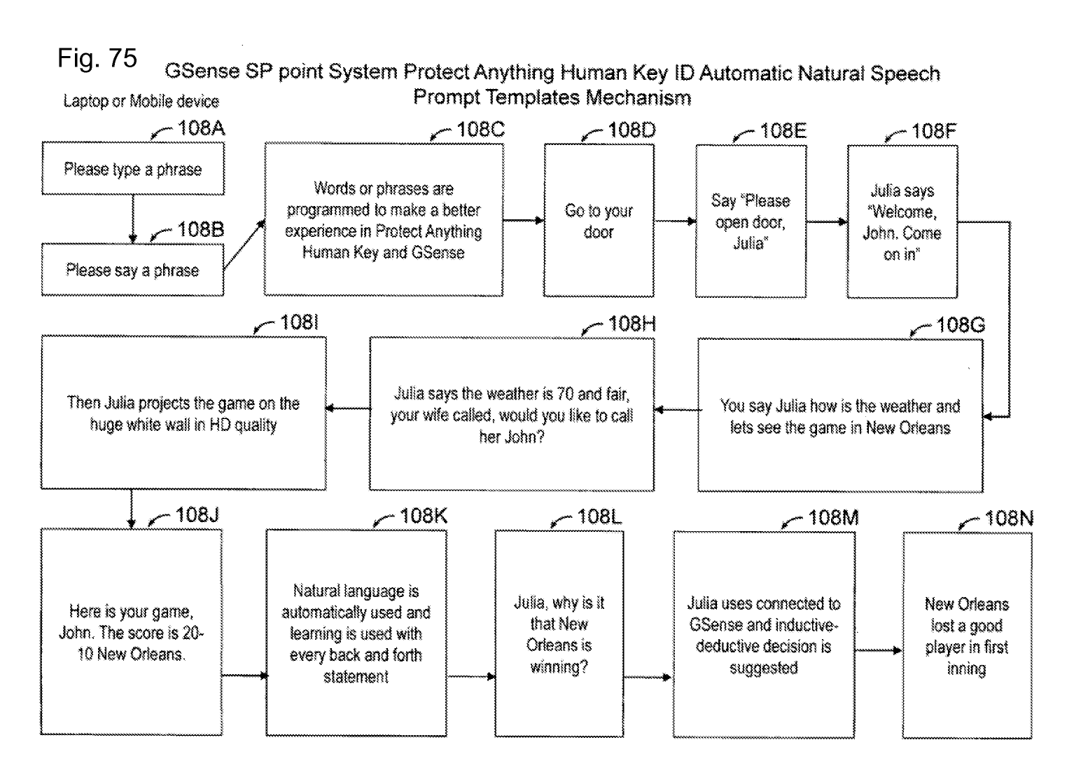

FIG. 75 Object Vector Line Overlay Grid Form process

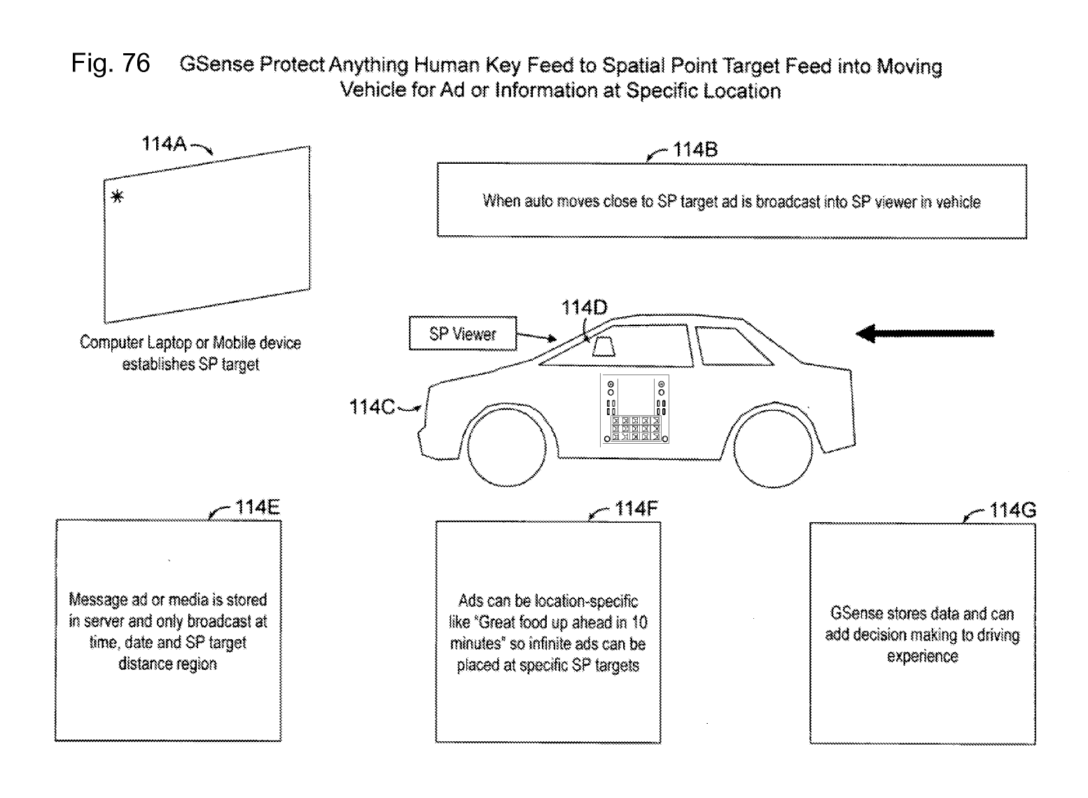

FIG. 76 Object 3D Video Audio process

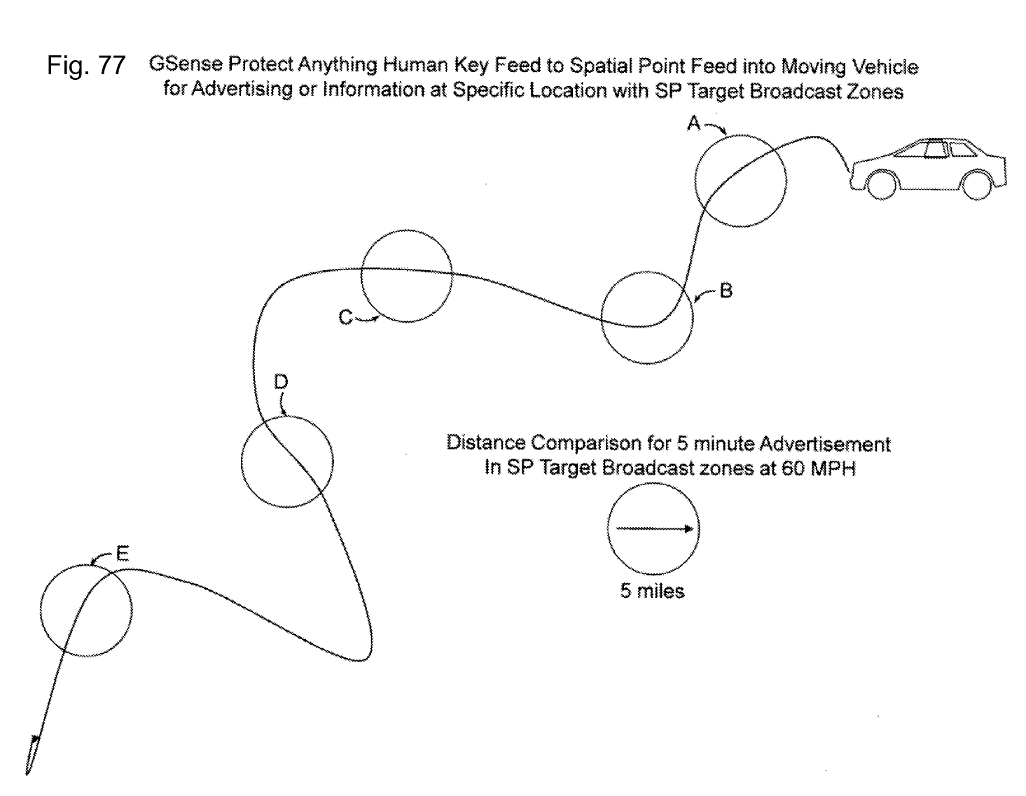

FIG. 77 Object Gray Scale process

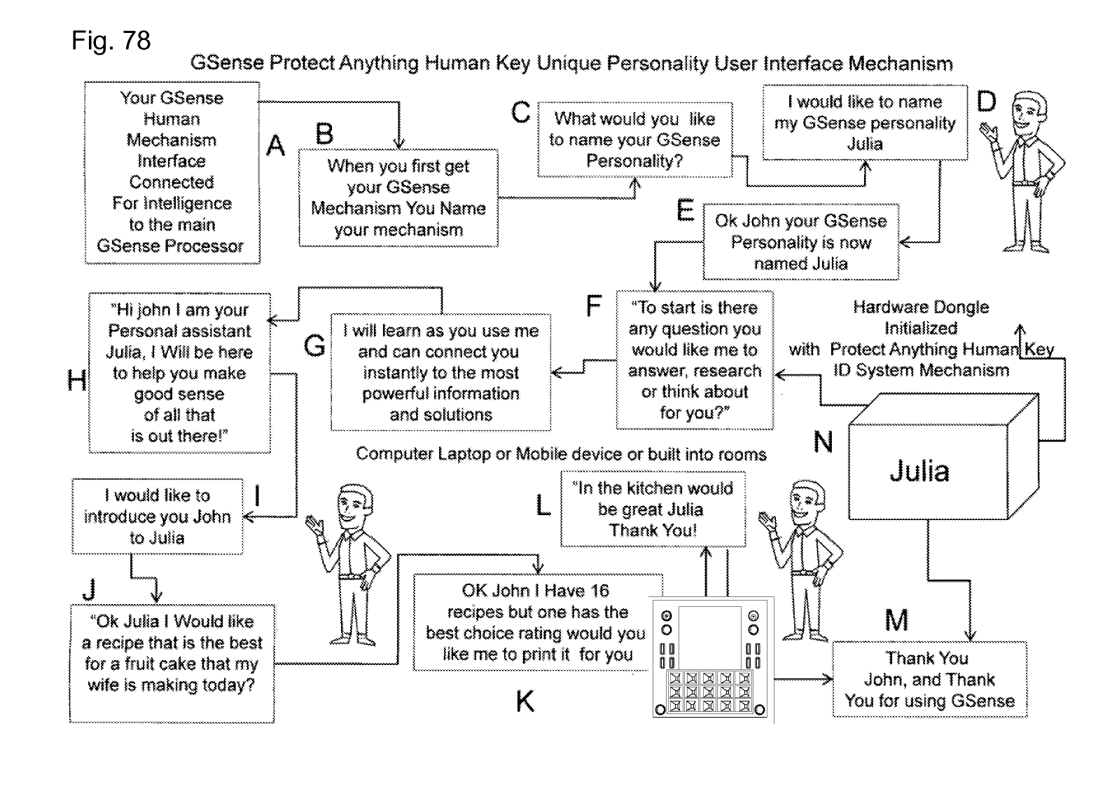

FIG. 78 Object 3D Spatial Point process

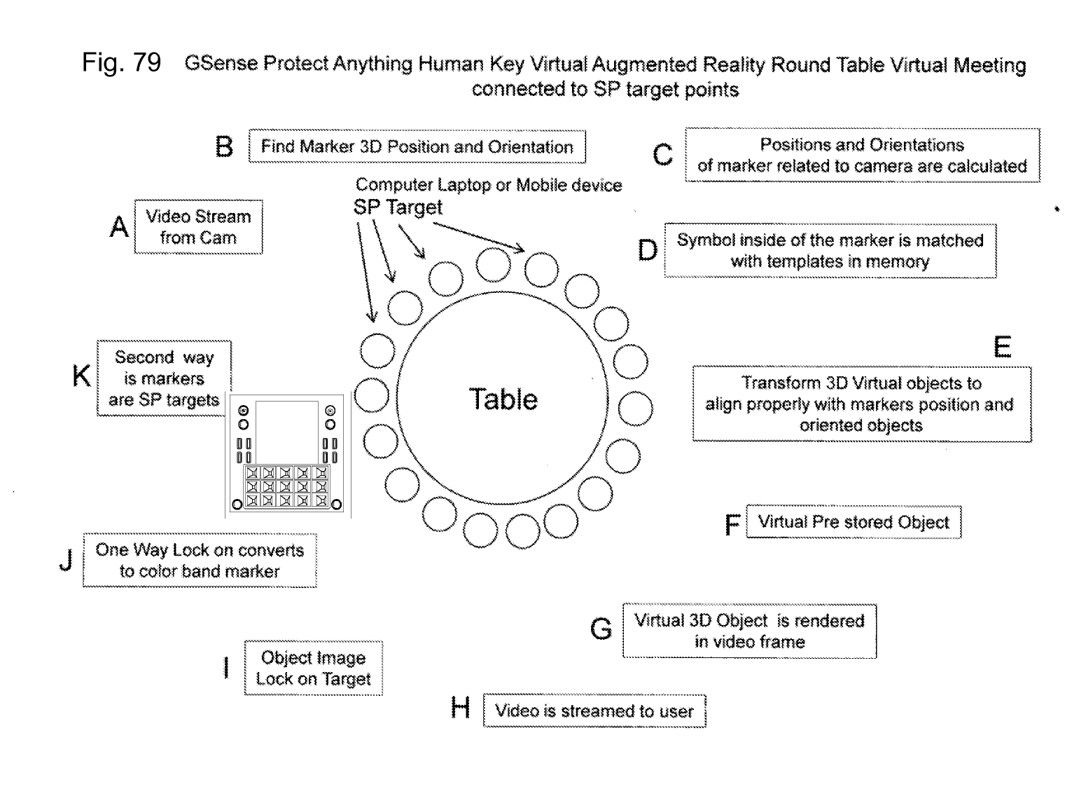

FIG. 79 Object Identification Process

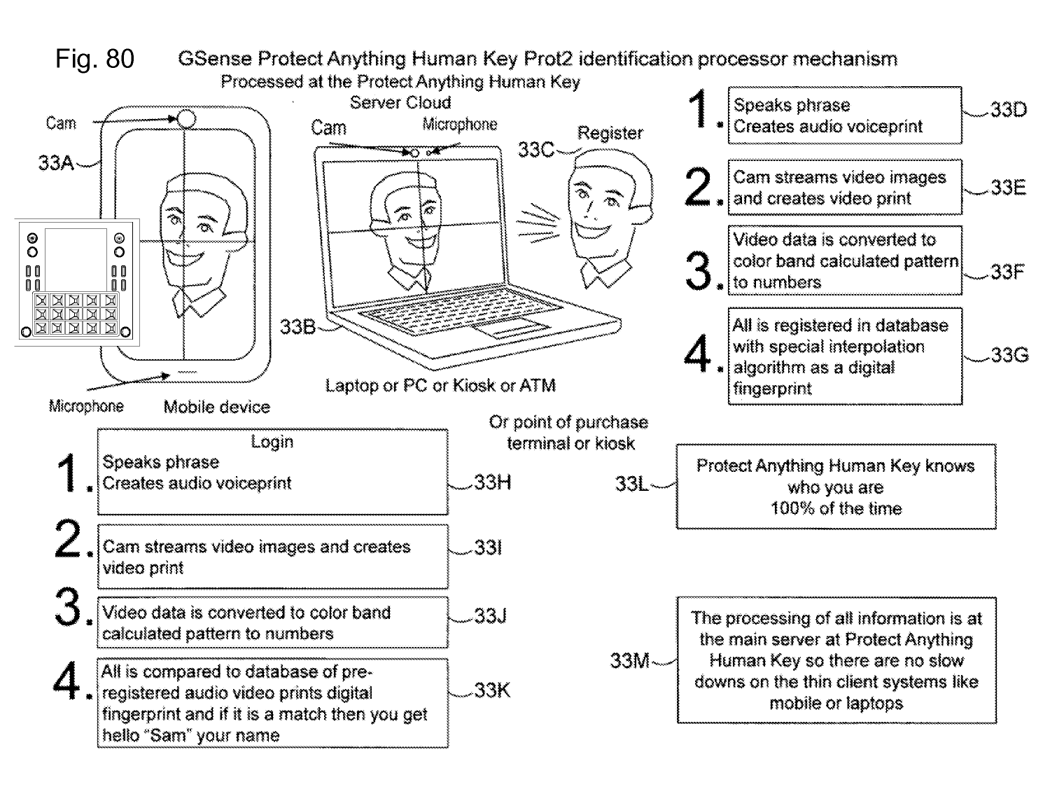

FIG. 80 Object Image Slice Encoder process

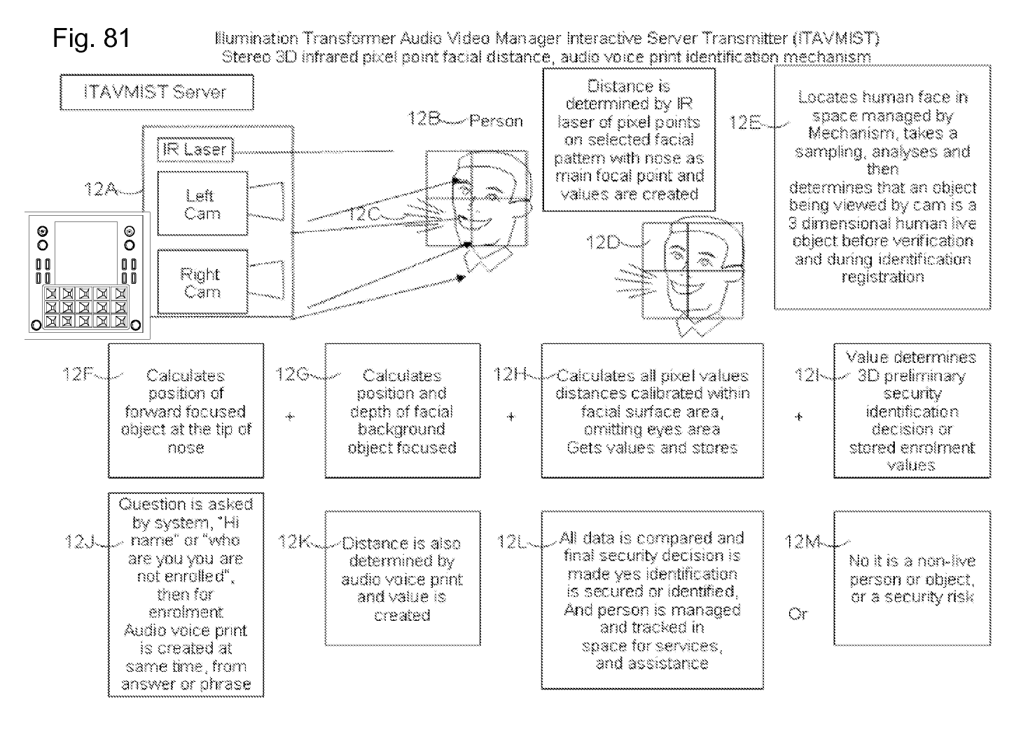

FIG. 81 Object Unit Brightness Interpolation process

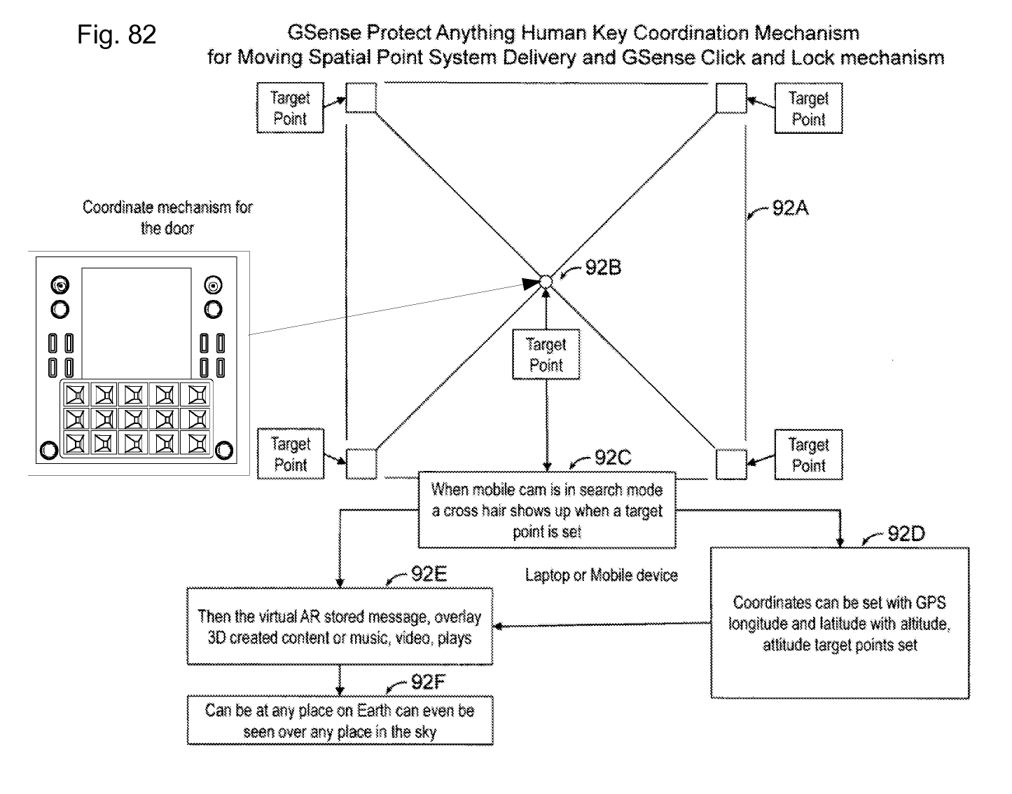

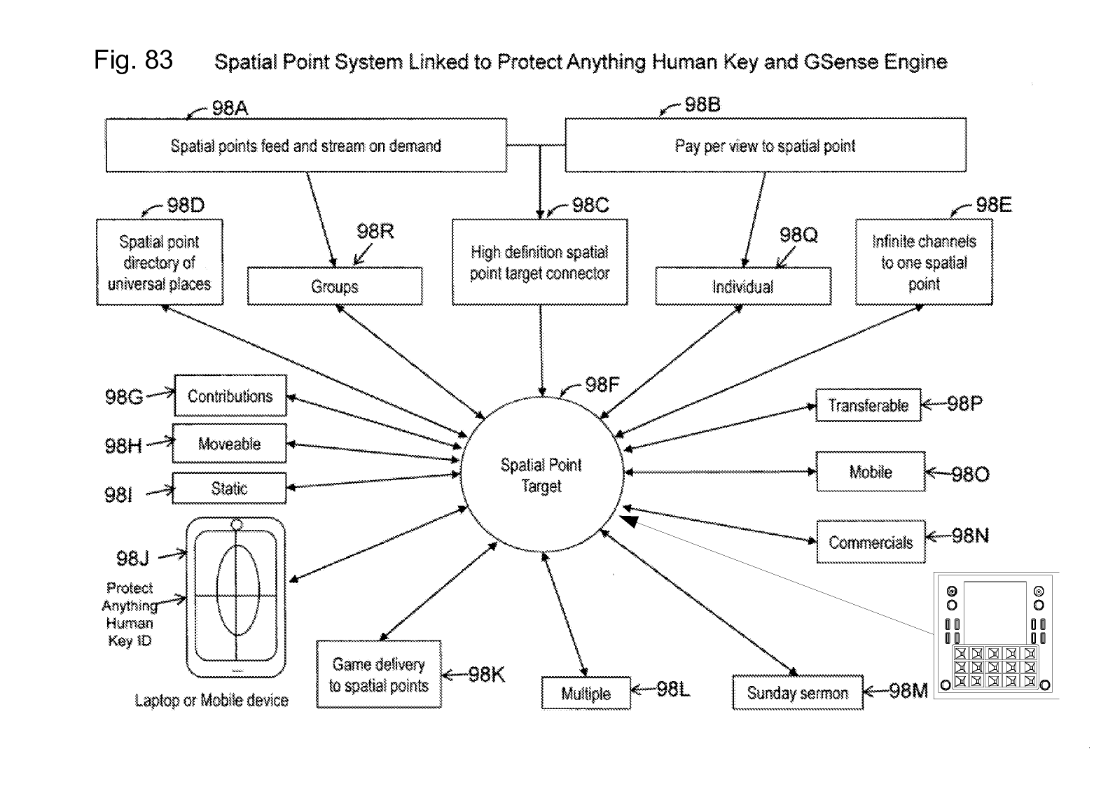

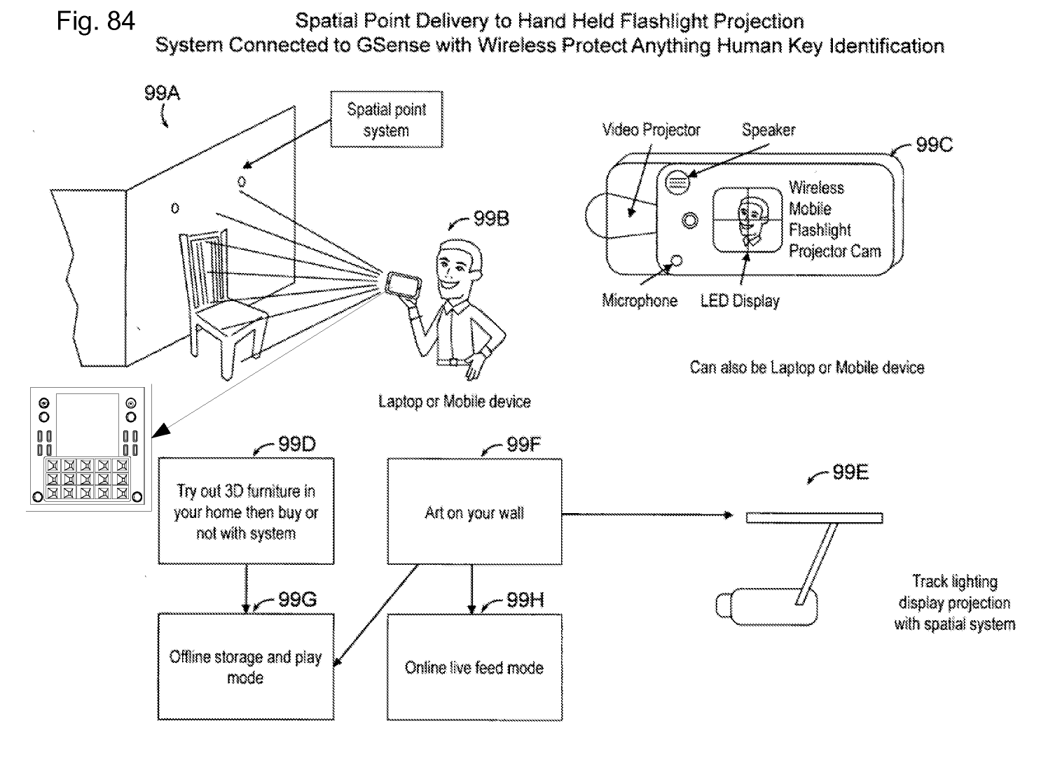

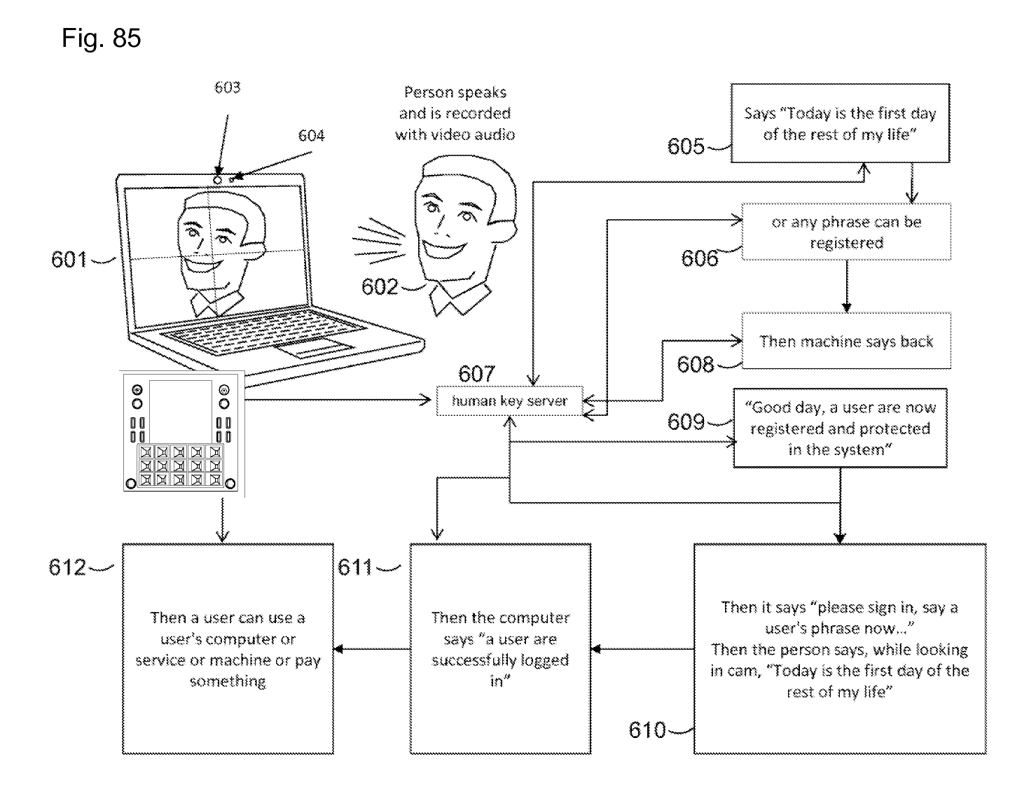

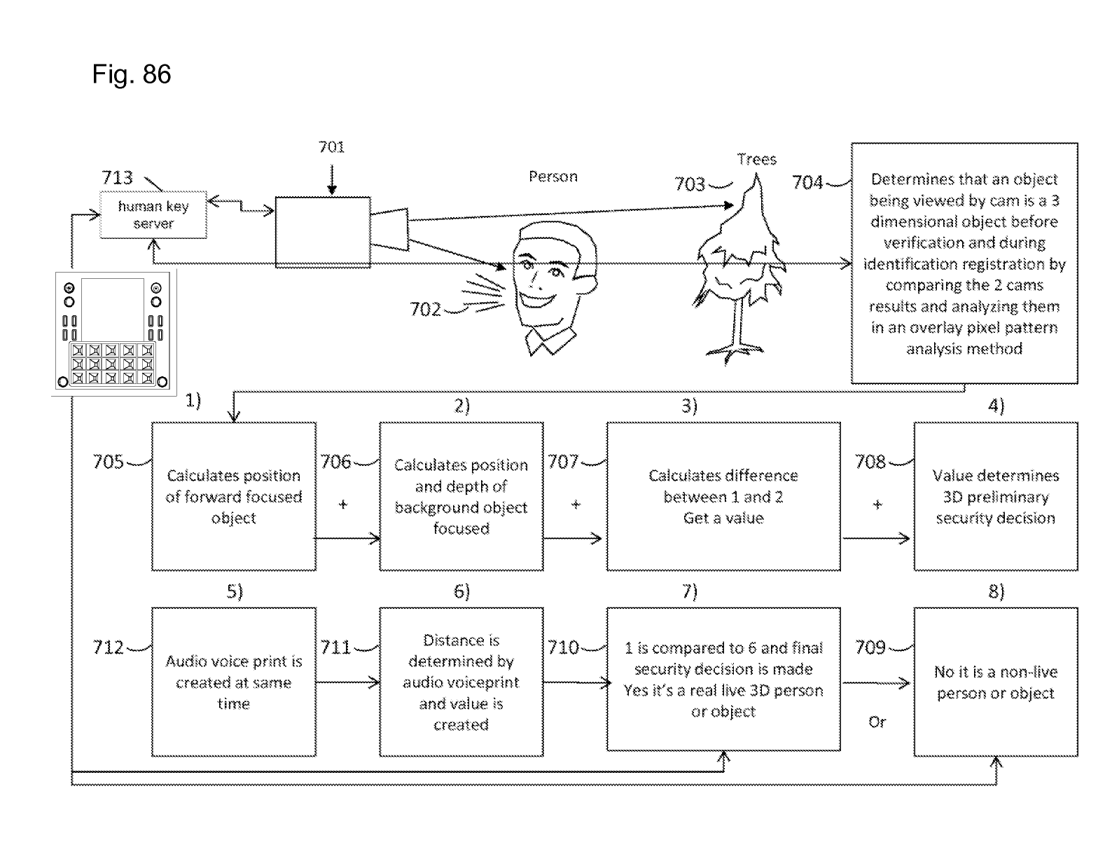

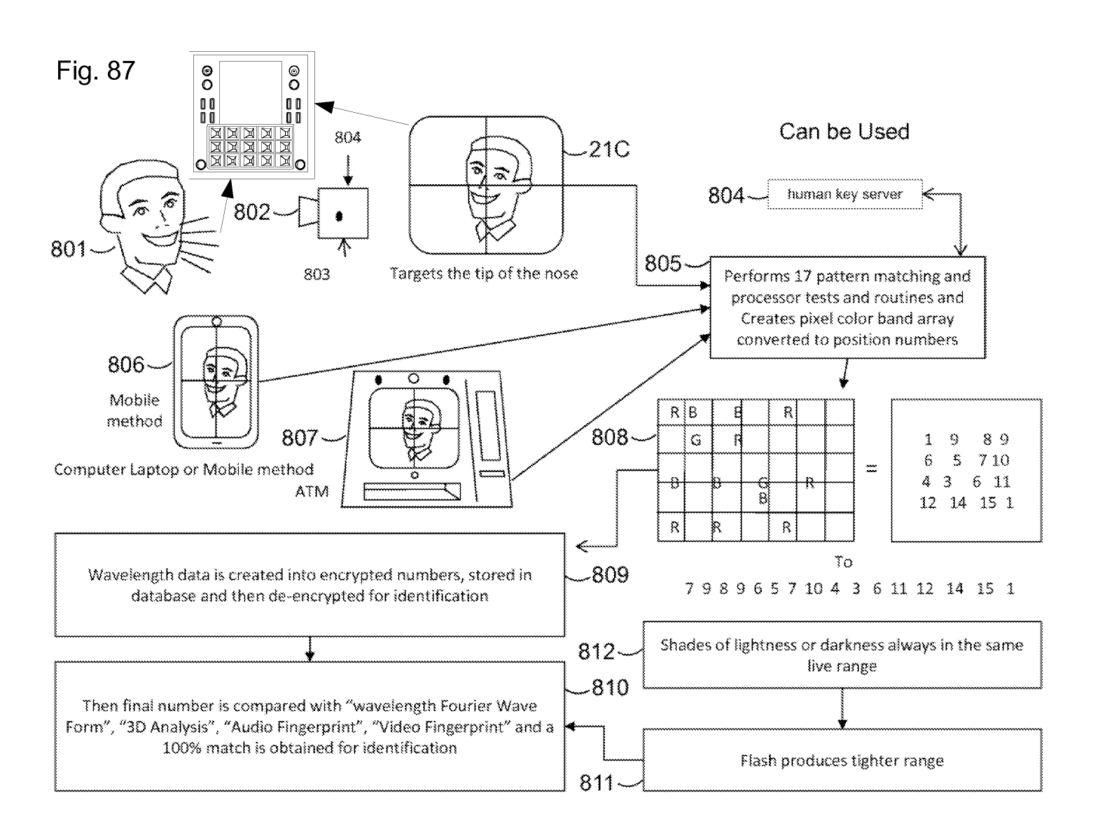

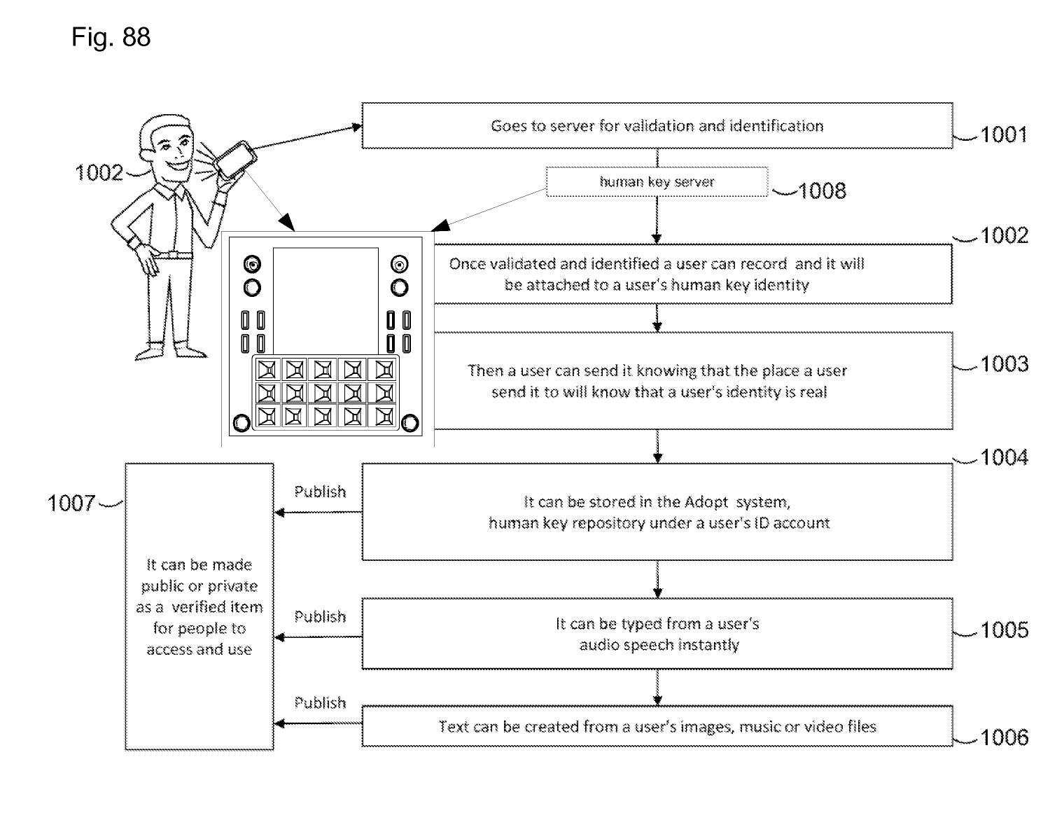

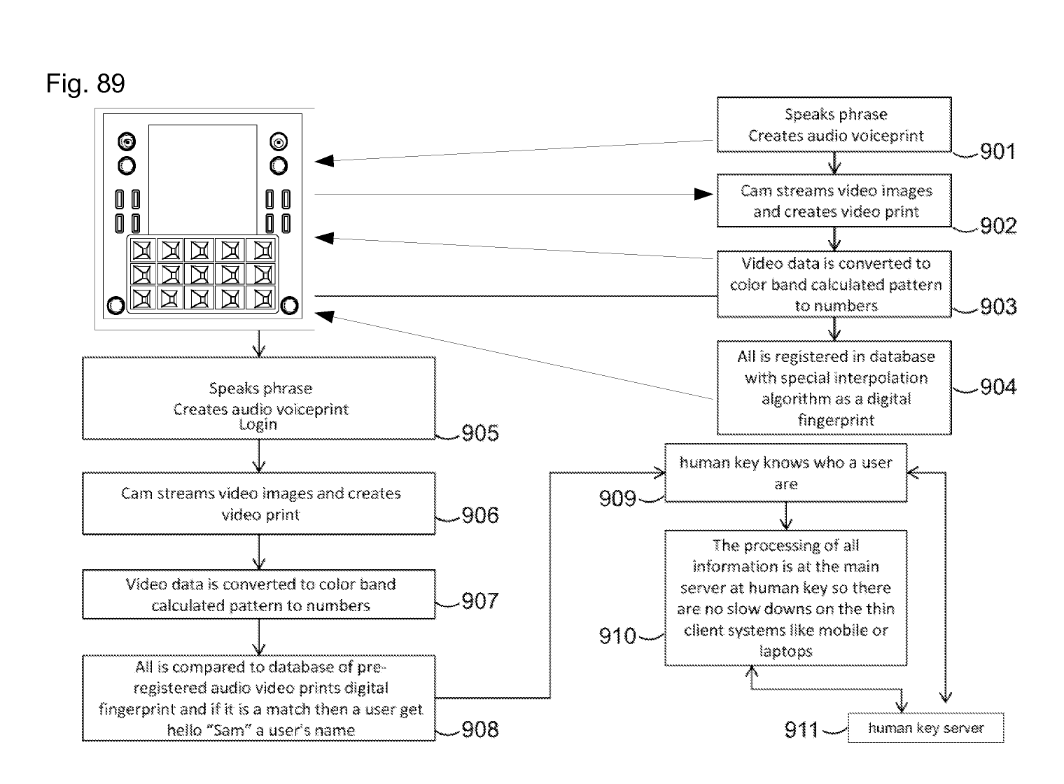

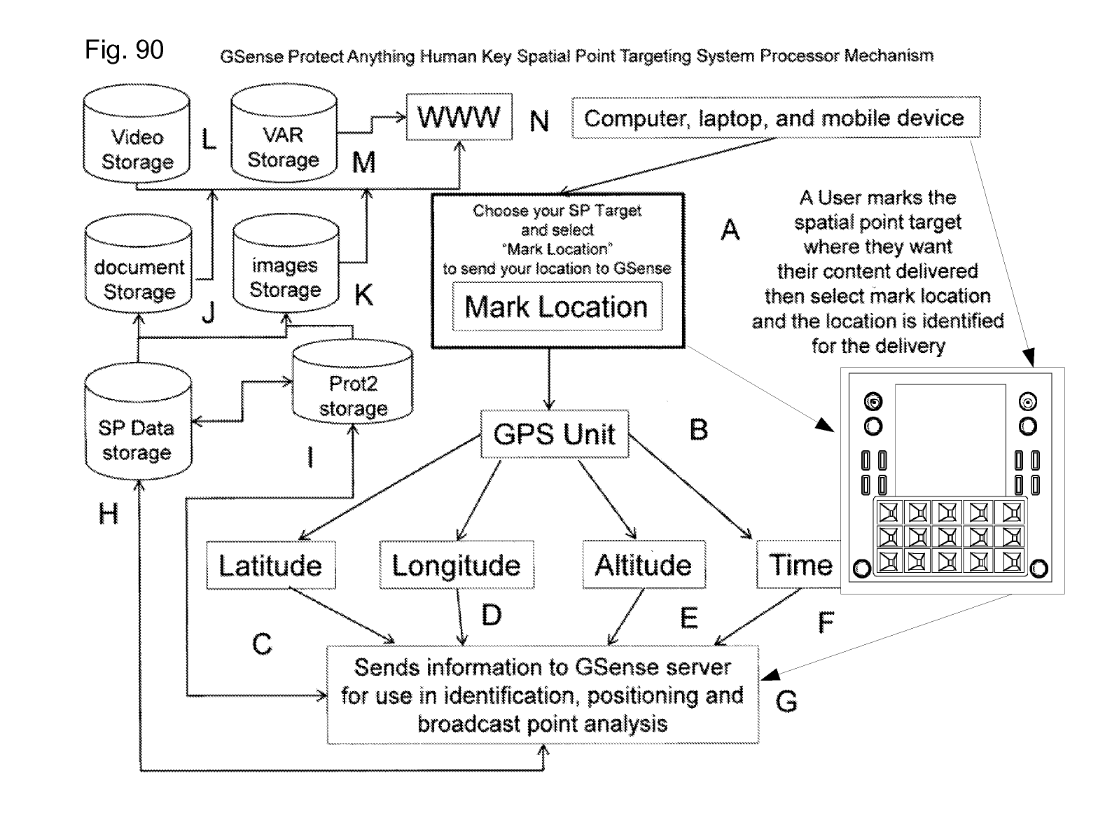

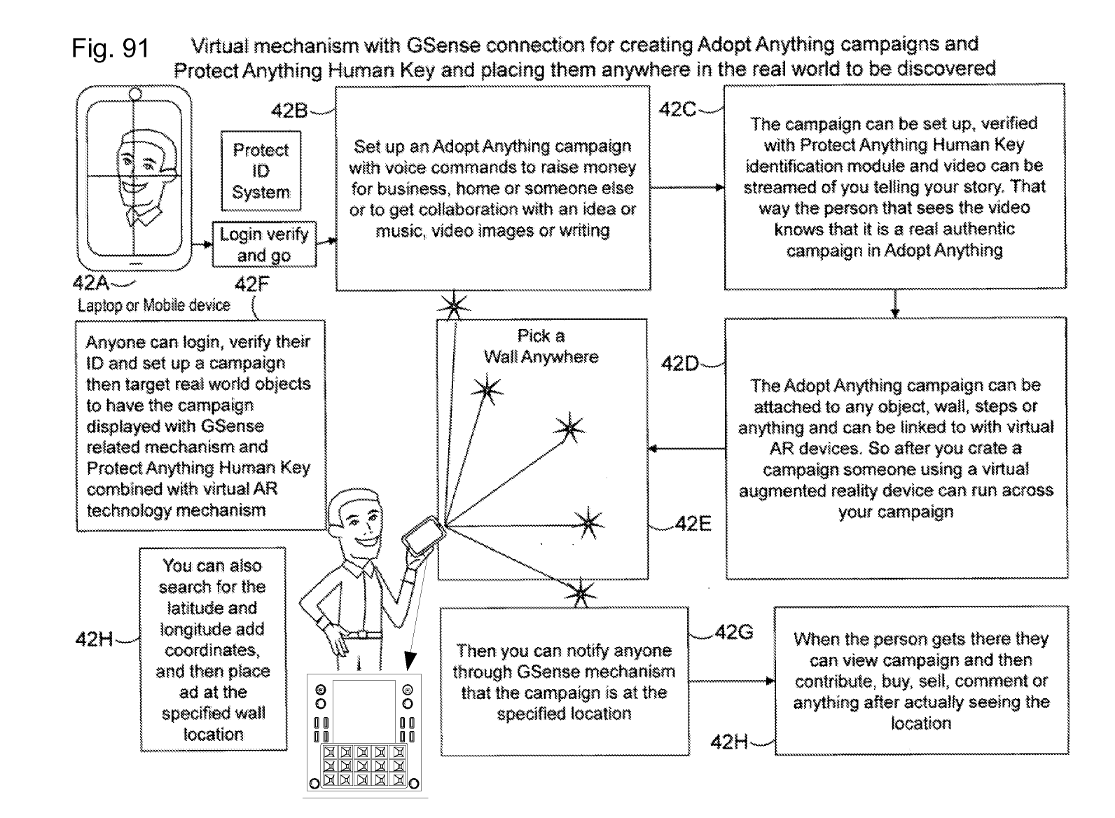

FIG. 82 Object Verification Process

All processes and transformations were know for many years as separate image and audio processing methods, used in open source softwares such as Bash Shell Scripts, Gimp, Open CV, Audacity for audio, FFMpeg and Mencoder.

Bash Shell Scripts is a Unix shell written by Brian Fox for the GNU Project as a free software replacement for the Bourne shell (sh).[3][4] Released in 1989,[5] it has been distributed widely as the shell for the GNU operating system and as a default shell on Linux and Mac OS X. It has been ported to Microsoft Windows and distributed with Cygwin and MinGW, to DOS by the DJGPP project, to Novell NetWare and to Android via various terminal emulation applications. In the late 1990s, Bash was a minor player among multiple commonly used shells, unlike presently where Bash has overwhelming favor.

Bash is a command processor that typically runs in a text window, where the user types commands that cause actions. Bash can also read commands from a file, called a script. Like all Unix shells, it supports filename wildcarding, piping, here documents, command substitution, variables and control structures for condition-testing and iteration. The keywords, syntax and other basic features of the language were all copied from sh. Other features, e.g., history, were copied from csh and ksh. Bash is a POSIX shell, but with a number of extensions.

The name itself is an acronym, a pun, and a description. As an acronym, it stands for Bourne-again shell, referring to its objective as a free replacement for the Bourne shell.[6] As a pun, it expressed that objective in a phrase that sounds similar to born again, a term for spiritual rebirth.[7][8] The name is also descriptive of what it did, bashing together the features of sh, csh, and ksh. [9]

Many of the processes in this invention are using common well known Bash Shell script open source software, used by programmers skilled in the art.

Gimp Initial release January 1996; 18 years ago,

GIMP (/gImp/;[4] GNU Image Manipulation Program) is a free and open-source raster graphics editor[5] used for image retouching and editing, free-form drawing, resizing, cropping, photo-montages, converting between different image formats, and more specialized tasks.

GIMP is released under LGPLv3 and GPLv3+ licenses and is available for Linux, OS X, and Windows.

Further information: Comparison of raster graphics editors

Animation Showing Brushes, Patterns, Gradients Created in GIMP

Tools used to perform image editing can be accessed via the toolbox, through menus and dialogue windows. They include filters and brushes, as well as transformation, selection, layer and masking tools.

Color

There are several ways of selecting colors including palettes, color choosers and using an eyedropper tool to select a color on the canvas. The built-in color choosers include RGB/HSV selector or scales, water-color selector, CMYK selector and a color-wheel selector. Colors can also be selected using hexadecimal color codes as used in HTML color selection. GIMP has native support for indexed color and RGB color spaces; other color spaces are supported using decomposition where each channel of the new color space becomes a black and white image. CMYK, LAB and HSV (hue, saturation, value) are supported this way.[39][40] Color blending can be achieved using the blend tool, by applying a gradient to the surface of an image and using GIMP's color modes. Gradients are also integrated into tools such as the brush tool, when the user paints this way the output color slowly changes. There are a number of default gradients included with GIMP; a user can also create custom gradients with tools provided.

Selections and Paths

GIMP selection tools include a rectangular and circular selection tool, free select tool, and fuzzy select tool (also known as magic wand). More advanced selection tools include the select by color tool for selecting contiguous regions of color—and the scissors select tool, which creates selections semi-automatically between areas of highly contrasting colors. GIMP also supports a quick mask mode where a user can use a brush to paint the area of a selection. Visibly this looks like a red colored overlay being added or removed. The foreground select tool is an implementation of Simple Interactive Object Extraction (SIOX) a method used to perform the extraction of foreground elements, such as a person or a tree in focus. The Paths Tool allows a user to create vectors (also known as Bezier curves). Users can use paths to create complex selections around natural curves. They can paint (or “stroke”) the paths with brushes, patterns, or various line styles. Users can name and save paths for reuse.

Image Editing

There are many tools that can be used for editing images in GIMP. The more common tools include a paint brush, pencil, airbrush, eraser and ink tools used to create new or blended pixels. Tools such as the bucket fill and blend tools are used to change large regions of space in an image and can be used to help blend images.

GIMP also provides ‘smart’ tools that use a more complex algorithm to do things that otherwise would be time consuming or impossible. These include a:

Clone tool, which copies pixels using a brush

Healing brush, which copies pixels from an area and corrects tone and color

Perspective clone tool, which works like the clone tool but corrects for distance changes

Blur and sharpen tool blurs and sharpens using a brush

Dodge and burn tool is a brush that makes target pixels lighter (dodges) or darker (burns)

GIMP transform tools include:

Align

Move

Crop

Rotate

Scale

Shear

Perspective

Flip

OpenCV (Open Source Computer Vision) is a library of programming functions mainly aimed at real-time computer vision, developed by Intel Russia research center in Nizhny Novgorod, and now supported by Willow Garage and Itseez.[1] It is free for use under the open source BSD license. The library is cross-platform. It focuses mainly on real-time image processing. If the library finds Intel's Integrated Performance Primitives on the system, it will use these proprietary optimized routines to accelerate itself. Officially launched in 1999, the OpenCV project was initially an Intel Research initiative to advance CPU-intensive applications, part of a series of projects including real-time ray tracing and 3D display walls. The main contributors to the project included a number of optimization experts in Intel Russia, as well as Intel's Performance Library Team. In the early days of OpenCV, the goals of the project were described as Advance vision research by providing not only open but also optimized code for basic vision infrastructure. No more reinventing the wheel. Disseminate vision knowledge by providing a common infrastructure that developers could build on, so that code would be more readily readable and transferable.

Advance vision-based commercial applications by making portable, performance-optimized code available for free—with a license that did not require to be open or free themselves.

Audacity Initial release 28 May 2000; 14 years ago

Audacity is a free open source digital audio editor and recording computer software application, available for Windows, Mac OS X, Linux and other operating systems.[3][4] Audacity was started in May 2000 by Dominic Mazzoni and Roger Dannenberg at Carnegie Mellon University.[6] As of 10 Oct. 2011, it was the 11th most popular download from SourceForge, with 76.5 million downloads. [7] Audacity won the SourceForge 2007 and 2009 Community Choice Award for Best Project for Multimedia. [8] [9]

Features and Usage

In addition to recording audio from multiple sources, Audacity can be used for post-processing of all types of audio, including podcasts by adding effects such as normalization, trimming, and fading in and out.[10] Audacity has also been used to record and mix entire albums, such as by Tune-Yards.[11] It is also currently used in the UK OCR National Level 2 ICT course for the sound creation unit.

Audacity's features include:

Importing and exporting of WAV, AIFF, MP3 (via the LAME encoder, downloaded separately), Ogg Vorbis, and all file formats supported by libsndfile library. Versions 1.3.2 and later support Free Lossless Audio Codec (FLAC).[12] Version 1.3.6 and later also support additional formats such as WMA, AAC, AMR and AC3 via the optional FFmpeg library.

Recording and playing back sounds

Editing via cut, copy, and paste, with unlimited levels of undo

Multitrack mixing

A large array of digital effects and plug-ins. Additional effects can be written with Nyquist

Built-in LADSPA plug-in support. VST support available through an optional VST Enabler.[13]

Amplitude envelope editing

Noise removal based on sampling the noise to be removed.[14]

Audio spectrum analysis using the Fourier transform algorithm

Support for multi-channel modes with sampling rates up to 96 kHz with 32 bits per sample

Precise adjustments to the audio speed (tempo) while maintaining pitch in order to synchronize it with video or run for a predetermined length of time

Adjusting audio pitch while maintaining speed

Features of modern multitrack audio software[15] including navigation controls, zoom and single track edit, project pane and XY project navigation, non-destructive and destructive effect processing, audio file manipulation (cut, copy, paste)

Conversion of cassette tapes or records into digital tracks by automatically splitting the audio source into multiple tracks based on silences in the source material

Cross-platform operation—Audacity works on Windows, Mac OS X, and Unix-like systems (including Linux and BSD)

Audacity uses the wxWidgets software library to provide a similar graphical user interface on several different operating systems.

Audacity supports the LV2 open standard for plugins and can therefore load software like Calf Studio Gear.[16]

FFMpeg

FFmpeg is a free software project that produces libraries and programs for handling multimedia data. FFmpeg includes libavcodec, an audio/video codec library used by several other projects, libavformat, an audio/video container mux and demux library, and the ffmpeg command line program for transcoding multimedia files. FFmpeg is published under the GNU Lesser General Public License 2.1+ or GNU General Public License 2+(depending on which options are enabled).[6]

History

The project was started by Fabrice Bellard[6] (using the pseudonym “Gerard Lantau”) in 2000, and has been maintained by Michael Niedermayer since 2004. Many FFmpeg developers are also part of the MPlayer project. The name of the project comes from the MPEG video standards group, together with “FF” for “fast forward”.[9] The logo uses a zigzag pattern that shows how MPEG video codecs handle entropy encoding.[10]

FFmpeg is developed under GNU/Linux, but it can be compiled under most operating systems, including Mac OS X, Microsoft Windows, AmigaOS and its heir MorphOS. Most computing platforms and microprocessor instruction set architectures are also supported, like x86 (IA-32 and x86-64), PPC (PowerPC), ARM, DEC Alpha, SPARC, and MIPS.[11]

Mencoder

MEncoder is a free command line video decoding, encoding and filtering tool released under the GNU General Public License. It is a sibling of MPlayer, and can convert all the formats that MPlayer understands into a variety of compressed and uncompressed formats using different codecs.[1]

MEncoder is included in the MPlayer distribution.

Capabilities

As it is built from the same code as MPlayer, it can read from every source which MPlayer can read, decode all media which MPlayer can decode and it supports all filters which MPlayer can use. MPlayer can also be used to view the output of most of the filters (or of a whole pipeline of filters) before running MEncoder. If the system is not able to process this in realtime, audio can be disabled using -nosound to allow a smooth review of the video filtering results.

It is possible to copy audio and/or video unmodified into the output file to avoid quality loss because of re-encoding. For example, to modify only the audio or only the video, or to put the audio/video data unmodified into a different container format.

Since it uses the same code as MPlayer, it features the same huge number of highly-configurable video and audio filters to transform the video and audio stream. Filters include cropping, scaling, vertical flipping, horizontal mirroring, expanding to create letterboxes, rotating, brightness/contrast, changing the aspect ratio, colorspace conversion, hue/saturation, color-specific gamma correction, filters for reducing the visibility of compression artifacts caused by MPEG compression (deblocking, deringing), automatic brightness/contrast enhancement (autolevel), sharpness/blur, denoising filters, several ways of deinterlacing, and reversing telecine.

All of these softwares were available to programmers skilled in the art at the time of the filing of this patent application, and the processes could have been created utilizing these software tools.

By having at least 9 identical comparisons in analysis of data aggregated from the 17 steps and processes of data aggregated at registration, we can identify the rightful human or object by these processes, methods of the invention.

The “human key” is a software identification method, run by a computer/machine. The “human key” enables a user to verify themselves to another user or another computer system. The software file, run by a computer/machine, of the human key enables a user to be verified and/or authenticated in a transaction and also provides tracking of the financial transaction by associating the transaction to one or more human keys which identify and authenticate one or more users in the system. The “human key” enables a user to verify themselves to another user or another computer system. The software file, run by a computer/machine, of the human key enables a user to be verified and/or authenticated in a transaction and also provides tracking of the financial transaction by associating the transaction to one or more human keys which identify and authenticate one or more users in the system. The “human key” enables the “authentication of users” with tracking, audio verification, and actual human identification, no merely password verification which does not verify the actual user.

The present invention teaches where a Human Key that is a method part of the Server, in many drawings in the specifications, which clearly shows the process used with a 3D camera to identify objects and humans. It is also shown step by step in the method patent application, Ser. No. 12/653,749, and referenced in the granted patent from application Ser. No. 12/768,981 and in application Ser. No. 12/830,344, and further in application Ser. No. 13/332,173.

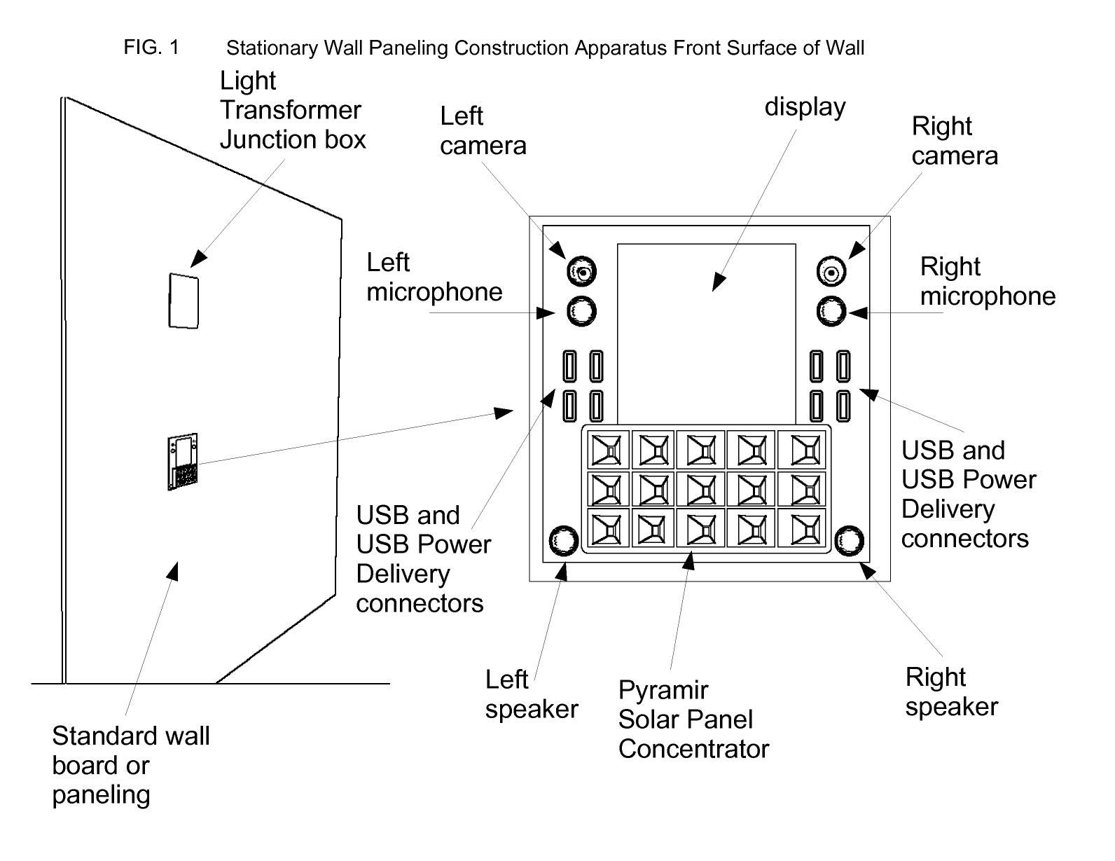

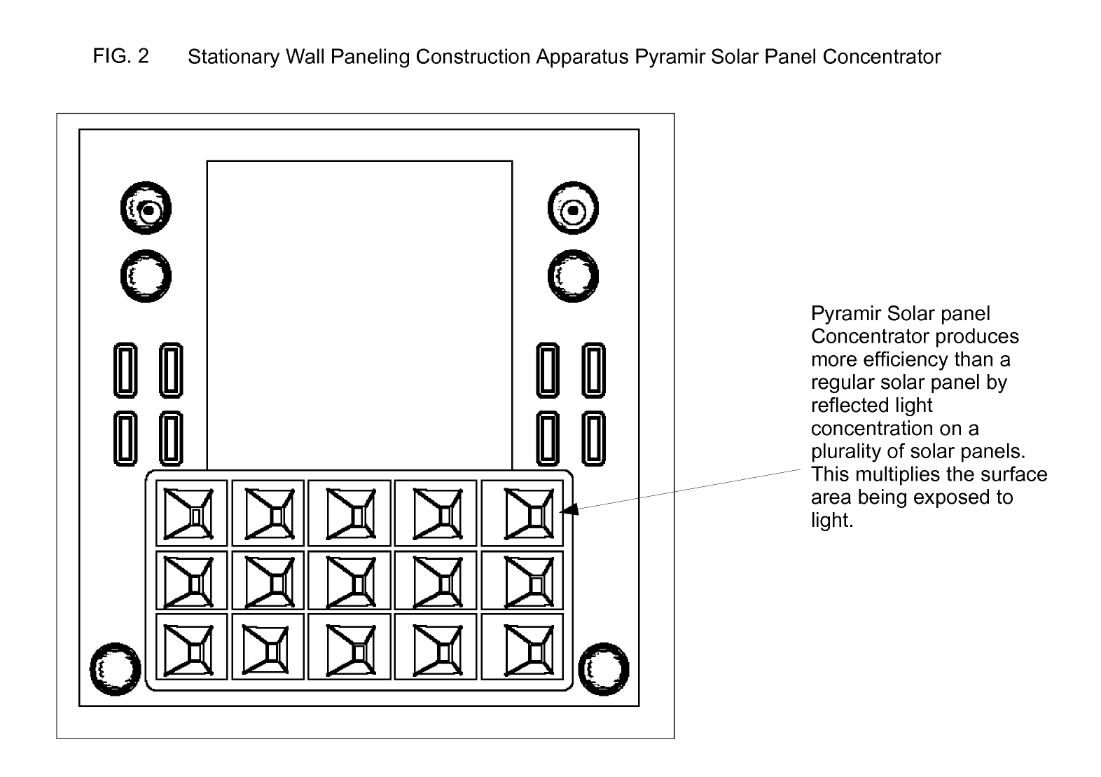

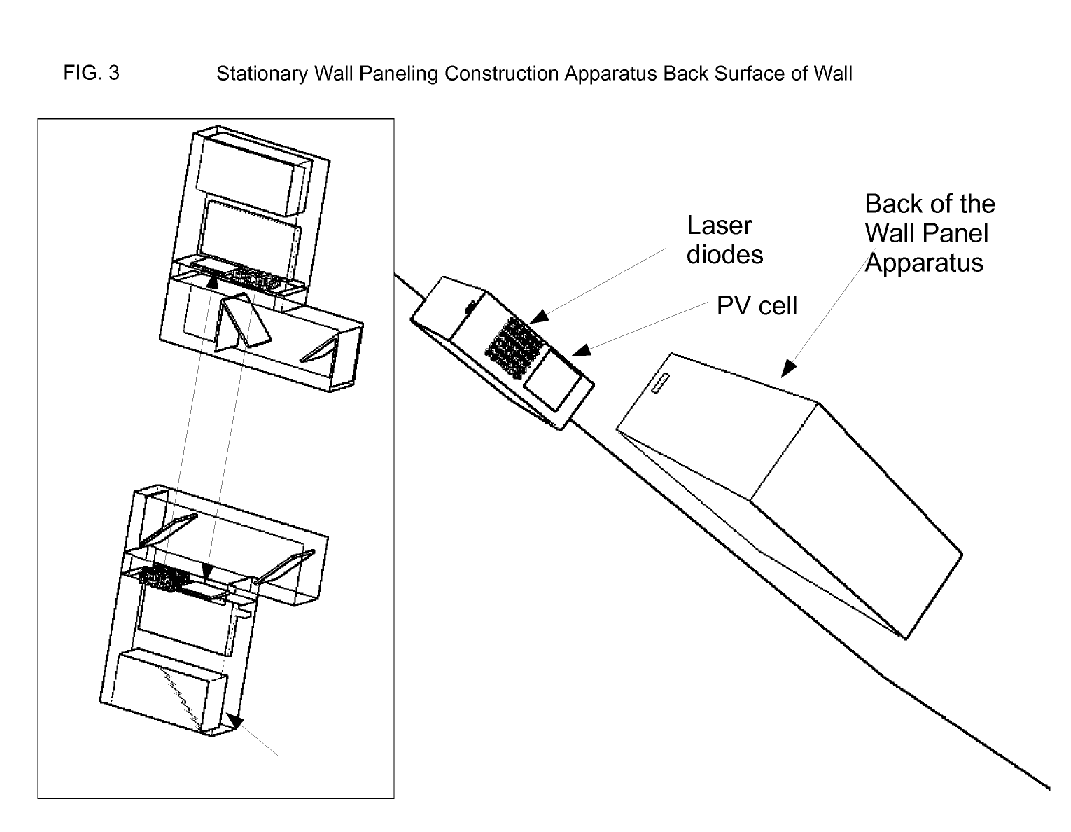

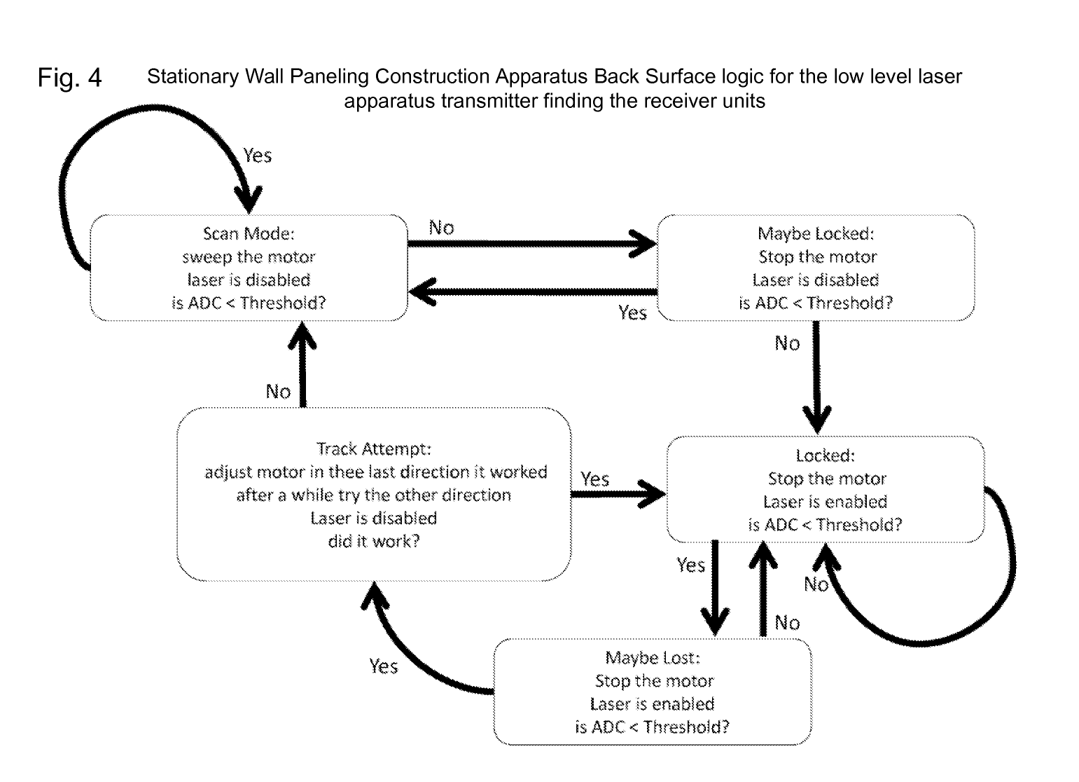

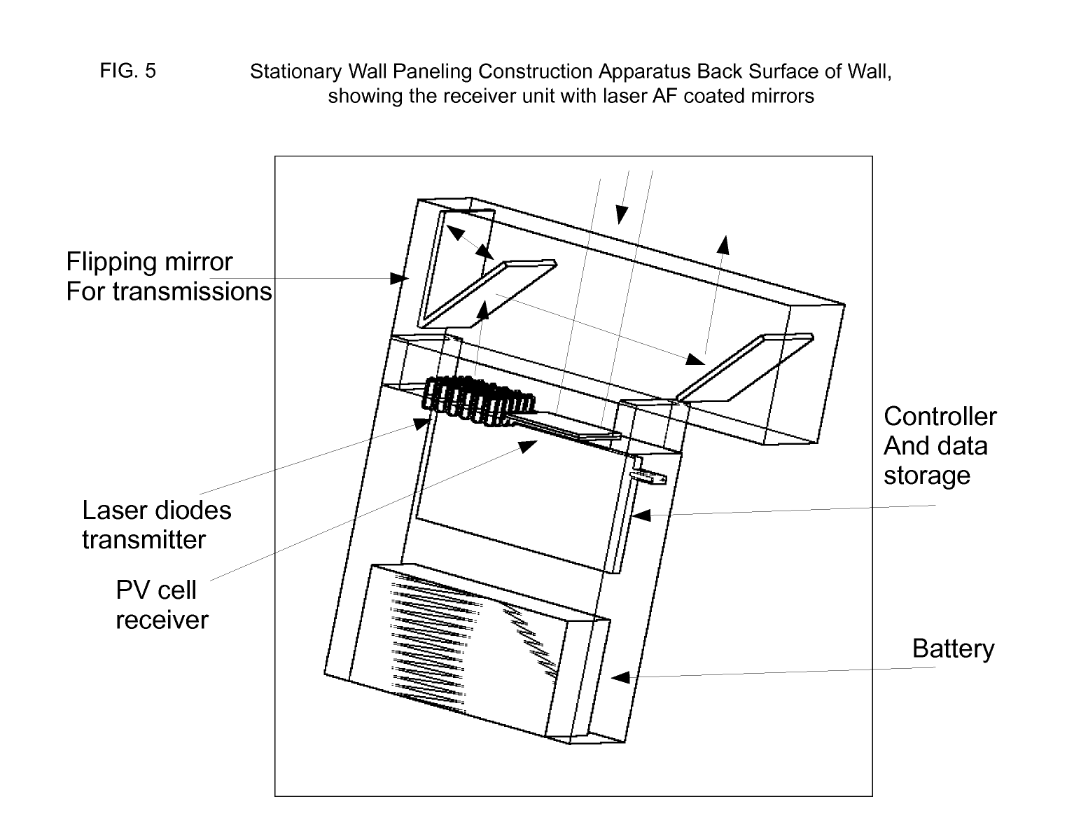

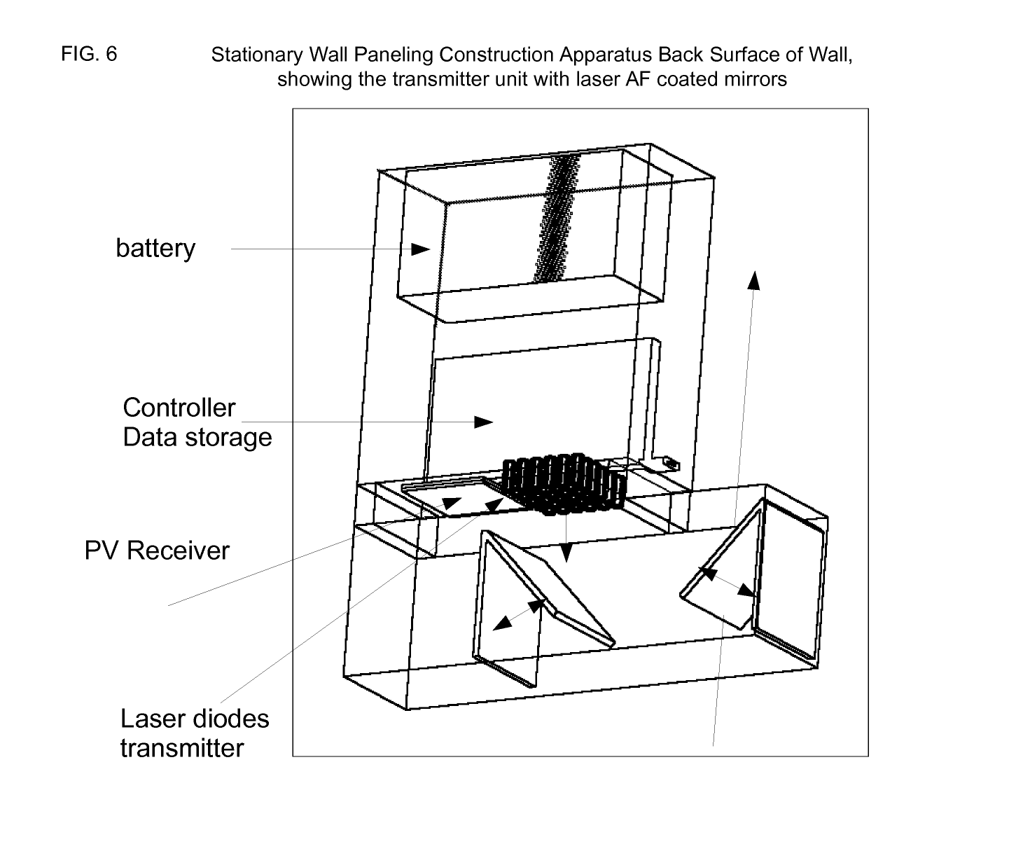

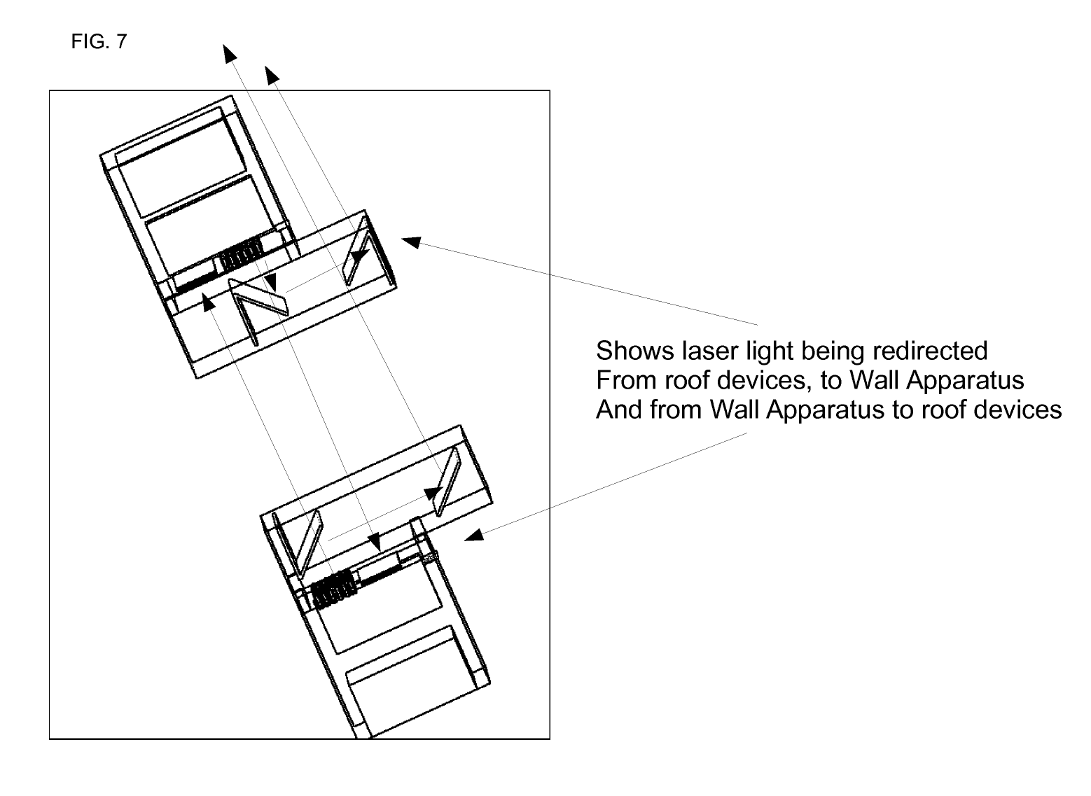

At the time of the filing of this patent, any programmer that was a skilled programmer, could have created the program to run on the computer servers presented in this document, simply from the processes that is presented here in FIG. 7, and combined with the processes that are shown in patent application Ser. No. 12/653,749, which included 18 redundancy processes, with very specific steps presented in Ser. No. 12/653,749, utilizing 3D camera, and a computer, anyone with even light programming skills could have created the invention to accomplish the steps presented at the time this was filed.

In the specifications, an algorithm is discussed; The Human Key method is used by a Server to transform “The audio voice print, video print, into color bands that are used to create calculated pattern to numbers that are registered in a database with spatial interpolation algorithm as a digital fingerprint. Processing of all audio and video input occurs on a human key system server so there is not usage by the thin client systems used by the user to access the human key server for authentication and verification. When a user/person registers in the system an audio and video fingerprint is created, which comprises audio file, video file, image files, text files, and all other files and data that is stored in the database, that are created as reference to identify the individual for the purpose of verification.”

“In identification of a human object the method needs to have protection from a user making a 3D model and putting it before the ATM and the system needs to be able to identify a live human object versus a fake human object, so this aspect would determine what the object is. The way to identify live humans, is that they are fluid not static and three dimensional, and with spatial reference points calculated in the background, a machine can identify fluid or static object.”

A plurality of 18 specific pre-processing aggregation and post processing verification redundancy steps used in identifying a human in the present invention are clearly demonstrated in the drawings and specification. And any programmer skilled in the art could use the steps to create the identification processes.

A quick view creator and viewer module is defined as a campaign and advertisement creation tool for making campaigns and advertisements that can be completely displayed, viewed and understood in a very short amount of time by the user. Utilizing an upload function that takes images, audio, text and assembles them together in a collage of a representation, and additionally where the text is converted to speech, for making it easy for a user to see and understand a campaign or advertisement in a short period of time.

A make an offer module is defined as a component where a user can create or make an offer for products, and/or services, on advertisements, campaigns, or embedded in QR codes revealed when scanned by device.

A search engine module is used for searching campaigns as related to advertisements, and QR code incentives, or color band coded currency, where a user can search for a product or service that they need, and can see what campaigns will benefit from the purchase, and at the same time what QR code offers are related, to the campaign and the advertisement, and what the QR Code pass along benefit will be if the user passes the QR Code off to their friends.

The word Fair is used in the invention with the context of, treating people or users in a way that does not favor some over others;

A Fair Value module, calculates the amount of money that something is worth the price or cost of something, in a fair way to all users.

To calculate fair value of a property we need these steps utilizing number, and currency values, aggregated into data for processing into the Fair Value amount with these aggregated data for processing fair value in a computer:
future growth rates of property in percentages (exp. 10% 20%);
profit margins (already profitable);
loss margins (already losing money);
risk factors (current similar issues publicized or published); Days to expiration of property
   (does it have a life span exp. −10 weeks not so good +10 weeks better);
amount of items that make up property (pieces, components, parts how many);
price total value of items that make up property; (total of the pieces cost, value)
amount of properties (how many properties being valued);
Fair Division of property calculated FDP;
contributions to properties (how much was added to the value);
cost of making a property (how much to make another similar property);
who owns property or pieces of property (does someone notable own property being valued);
what have other similar properties been valued at (requires aggregating all properties similar, and getting data about those properties publicized);
how is property stored and protected (warehouse, insurance costs);
where is property located (location based pricing);
how much is the maintenance of the property (people related to maintaining property costs);
what would the property bring at auction (estimate of auction value from previously similar auctioned property);
how many places has the property been publicized (public familiarity data);
how much was spent on creating the property (amounts time funds, real funds, virtual funds spent to create property);
how much credit funds (was credit used for funding);
how fast do the items that make up the property lose value (is there a depreciation factor amount);
how much outstanding loans on property;
then all of the above aggregated data is calculated to get a final CV Calculated Value;
then take CV value and search for similar properties;
add up the value of 4 CV equal priced similar properties which becomes X;
then where X=what ever reliable information was aggregated about similar properties,
and calculated into one value by adding them;
where ¼ of X=FV is dividing X by 4=FV;
where as FV is the resulting Fair Value of a property;
then we add the price of X similar properties and divide by ¼ of X=FV Fair Value or FVP Fair Value of Property.
where also FDP can also be divided between set specified numbers of users.

A Fair Share module, calculates a portion belonging to, due to, or contributed by an individual or group. And what their ownership, contribution, loan, donation or labor value is. And we use the following steps in aggregation by the method used in a processor on a computer for the calculation;
calculate and determine Fair Value of Property FVP;
calculate Fair Division of Property; FDP
how many users are sharing property US;
how many users are contributing to the property TUC Total User Contribution;
how much is each user contributing UC User Contribution
what is the total users combined contributing value UCV;
how much is the divided property pieces owned by the sharing users Price Per User PPU
how much % is time contribution worth TC
how much % is funding contribution worth FC
then calculate percentage by dividing FVP/US−UC=PPU
then calculate user fair share percentage FS % FVP/US+ or −TUC, UC, TC, FC=X
then divide FVP/X=FS %

A Fair Deal module, calculates how to give (something or an amount of something) to someone, to buy and sell as a business, and additionally to reach or try to reach a state of acceptance or reconciled agreement about real tangible or intangible object transactions.
Micro Share Request is calculated and performed by these steps;
we take Fair Share Percentage FS %;
we utilize Digital Semantic Agent to send email with FS % request to potential deal user participant;
we receive additional value added by user data;
we evaluate that data, for value;
we receive counter offer FS %;
   we send counter offer to owner of property with new additional data;
   we take acceptance or denial of counter offer, and forward to user to make and confirm deal or to take new counteroffer for deal;
   after sharing user and owner user agree to Fair Deal deal is transacted.

A Fair Price module, calculates the amount of money that you pay for something or that something costs, and calculates the thing that is lost, damaged, or given up in order to get or do something, and additionally calculates the amount of money needed to persuade someone to do something, and calculates the quantity of one thing that is exchanged or demanded in barter or sale for another thing, and additionally calculates the amount of money given or set as consideration for the sale of a specified thing all in a fair way to the users in the network.

Fair price is the same as Fair Value except damage variables, and transaction costs, exchange value, barter or sale value, fees set for transaction are added to the calculation.

A Fair Division module, calculates how a real or intangible property should be divided for immediate trading, and sales, taking into account;
participations of users;
contributions of users;
surface imaging of real properties;
file encryptions and de-encryption of non tangible files and transactions;
colors;
sizes;
shapes;
and main whole evaluation of the value of the property assembled or made whole by rightful owners in a fair way to users in a network.

A Fair Placement module, calculates putting something in a particular place, and finding an appropriate place for someone to live, work, or learn, or placing an object, advertisement, or website in a strategic location for best possible results, in a fair way to users in a network. So the more value a user adds to properties being placed, moves them to a more advantageous position in the crowd, cloud, group of users, Internet, search engine or network position.

Any programmer skilled in the art could take the aggregated data specified, keywords and semantic phrases, and rules utilizing an Open Source search application designed for relational searches such as the open source Nutch search engine, in the method presented, and create relational database decisions, and suggestions for Fair Value, Share, Deal, Price, Division, and Placement in the present invention.

A Micro Share Request Module, that calculates small shares of things, objects, real or intangible properties and makes an offer for a user in a network, for a fraction of the item. This is accomplished through a previously programmed Digital Semantic Agent, from a user submitting a form for a request to divide a property and make it available to the user so they can purchase a portion of a real or intangible property in a transaction. It is a proposal to divide a property, that can be submitted to a single or plurality of people.

A Digital Semantic Agent can perform any action a person, user or automated mechanism can perform. The digital semantic agent is a set of instructions executed by a machine, such as computer, which is equivalent to a software module, or equivalent method or software structure for identifying, determining, and effectuating a purchase or sale of a property or any agent or module for making value determinations as taught and claimed by the present invention.

The digital semantic agent is provided as a set of instructions executed by a machine, such as computer and made available by a display screen of such as device. A user then interacts with the machine/computer, and the digital semantic agent running the set of instructions as a method performs the steps claimed.

Digital” (adj.) Describes any system based on discontinuous data or events. Computers are digital machines because at their most basic level they can distinguish between just two values, 0 and 1, or off and on. There is no simple way to represent all the values in between, such as 0.25. All data that a computer processes must be encoded digitally, as a series of zeroes and ones. See http://www.webopedia.com

“Semantic Web application” is a term used to describe Web-based applications that incorporates principles or technologies of the W3C Semantic Web, such as RDF, OWL and other metadata standards. See http://www.webopedia.com

“Semantics” in linguistics, the study of meanings. In computer science, the term is frequently used to differentiate the meaning of an instruction from its format. The format, which covers the spelling of language components and the rules controlling how components are combined, is called the language's syntax. For example, if you misspell a command, it is a syntax error. If, on the other hand, you enter a legal command that does not make any sense in the current context, it is a semantic error. See http://www.webopedia.com

An “agent” is defined as (n.) A program that performs some information gathering or processing task in the background. Typically, an agent is given a very small and well-defined task. Although the theory behind agents has been around for some time, agents have become more prominent with the growth of the Internet. Many companies now sell software that enables you to configure an agent to search the Internet for certain types of information. See http://www.webopedia.com

In computer science, there is a school of thought that believes that the human mind essentially consists of thousands or millions of agents all working in parallel. To produce real artificial intelligence, this school holds, we should build computer systems that also contain many agents and systems for arbitrating among the agents' competing results.

A “user agent”, in Google Analytics, a user agent is a term used to mean any program used for accessing a Web site. This includes browsers, robots, spiders and any other program that was used to retrieve information from the site.

A “Semantic Web application” is a term used to describe Web-based applications that incorporates principles or technologies of the W3C Semantic Web, such as RDF, OWL and other metadata standards.

In the patent application Ser. No. 12/459,353 specification, when “Adopt Anything” is referenced it is defined as a “Digital Semantic Agent”. The agent of the present invention aggregates data by itself, to enable a machine to intelligently make decisions, transform things, communicate with other machines, and create forms, questions, and other different content.

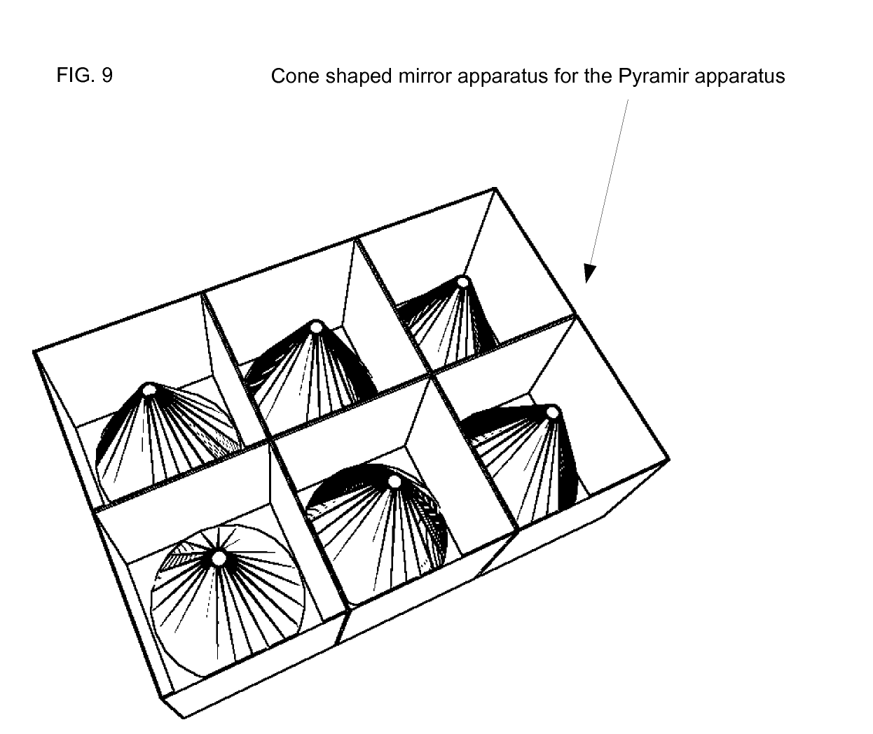

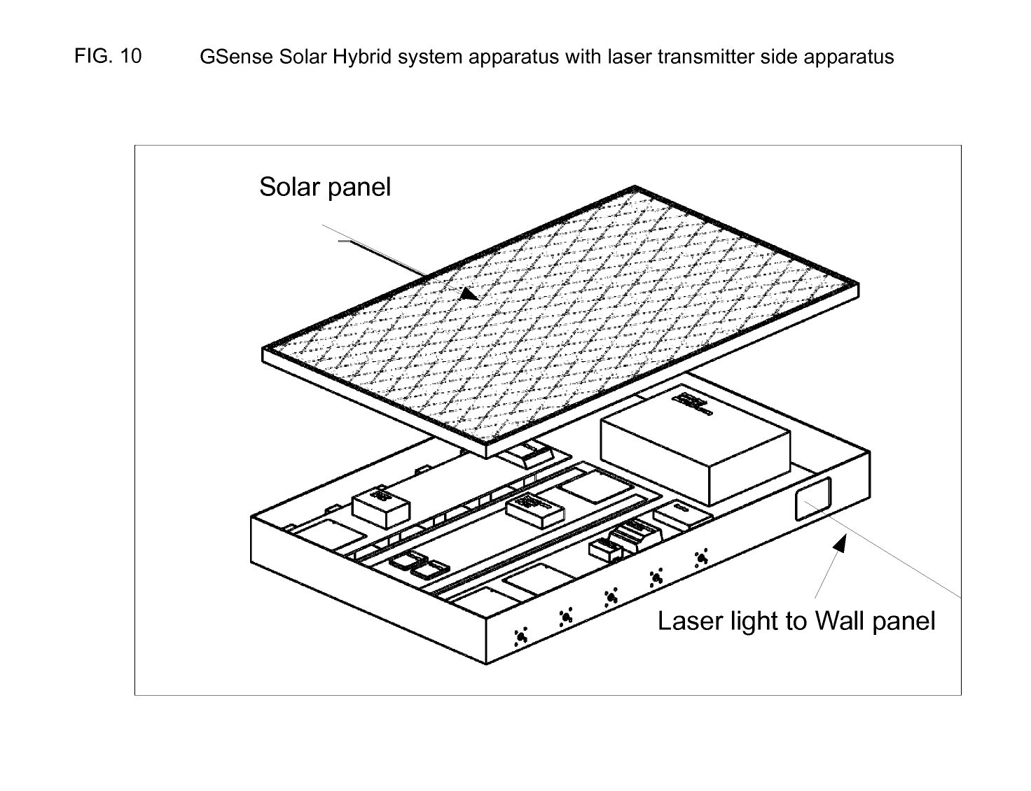

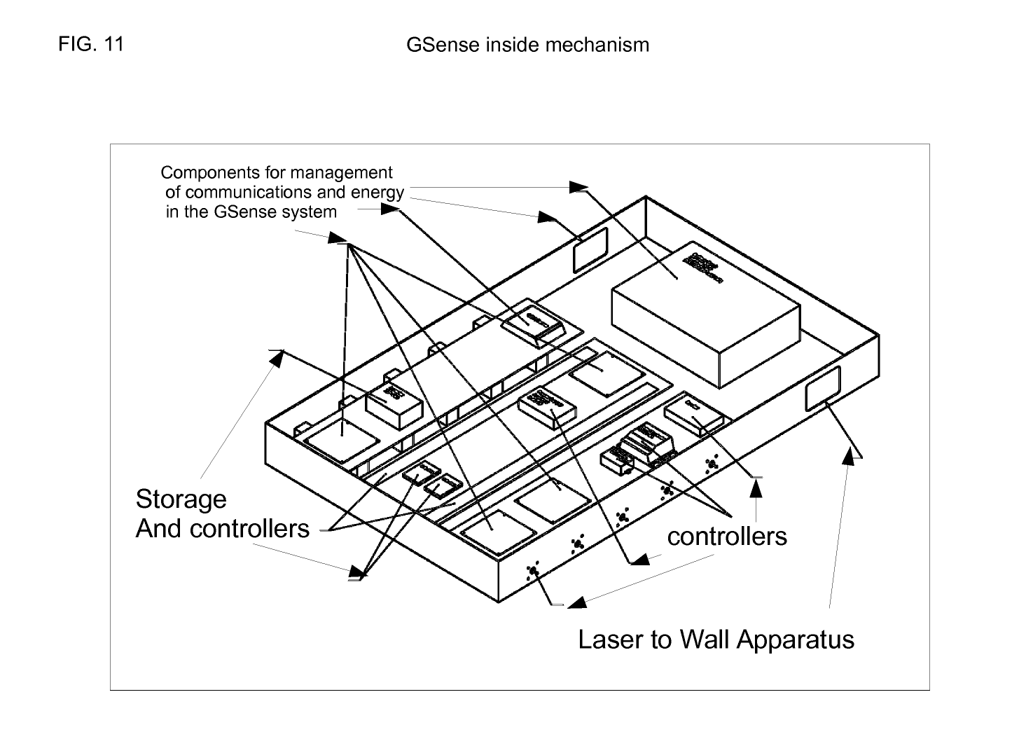

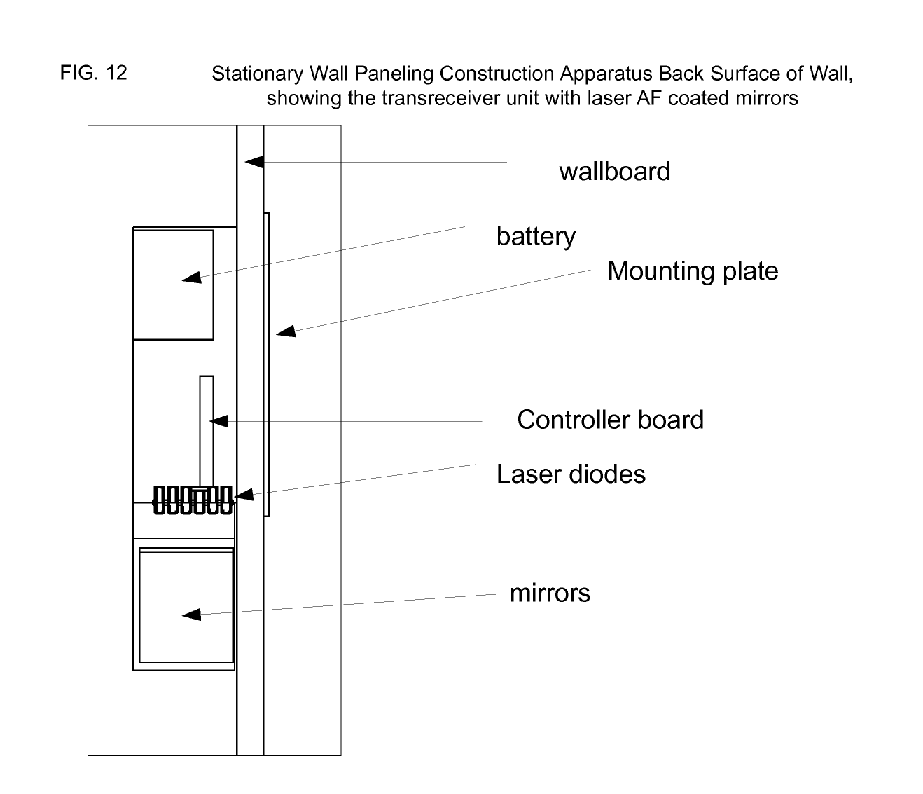

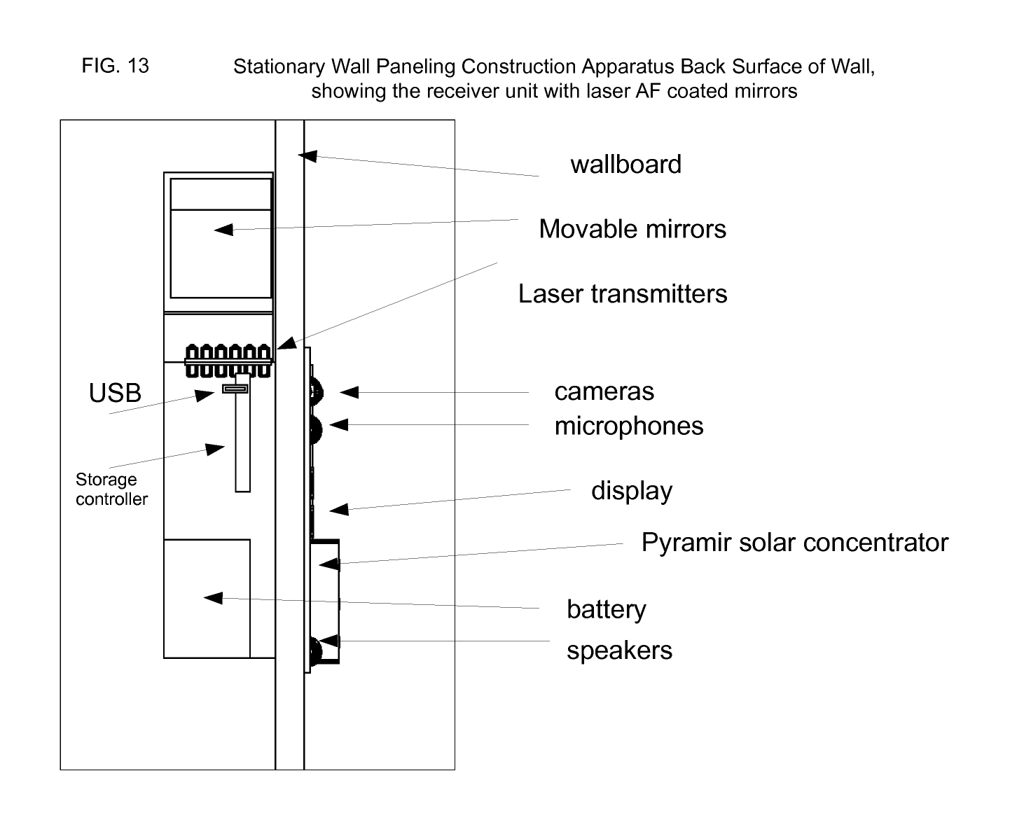

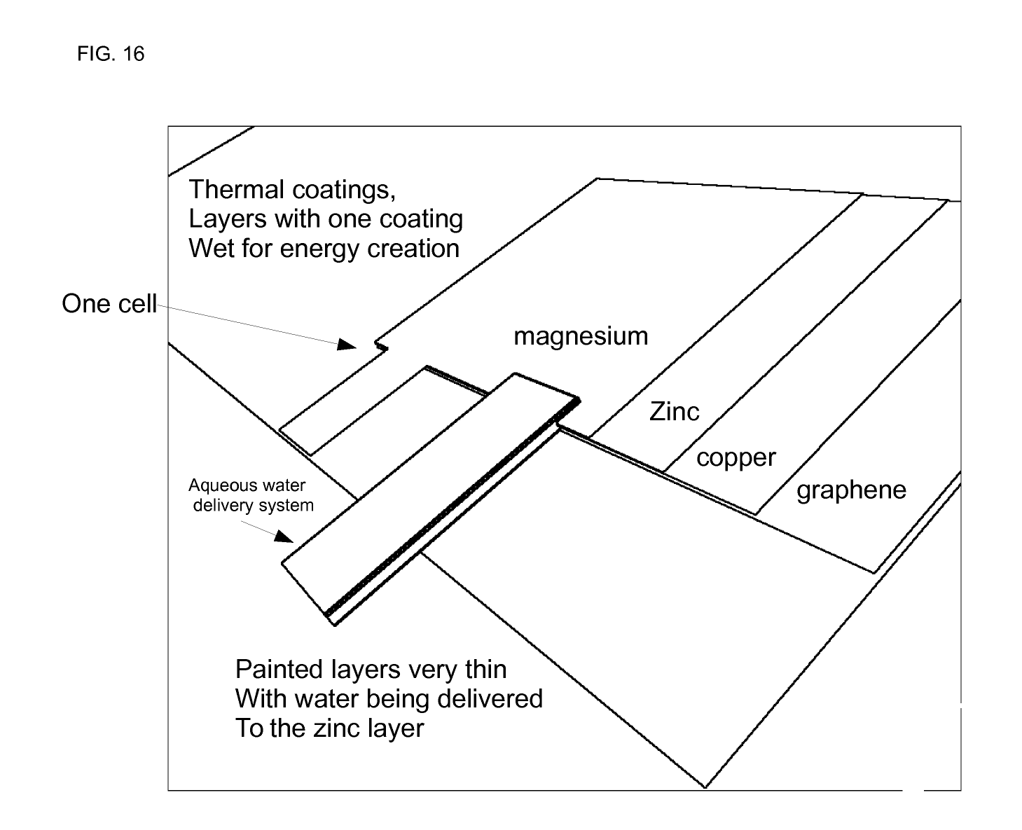

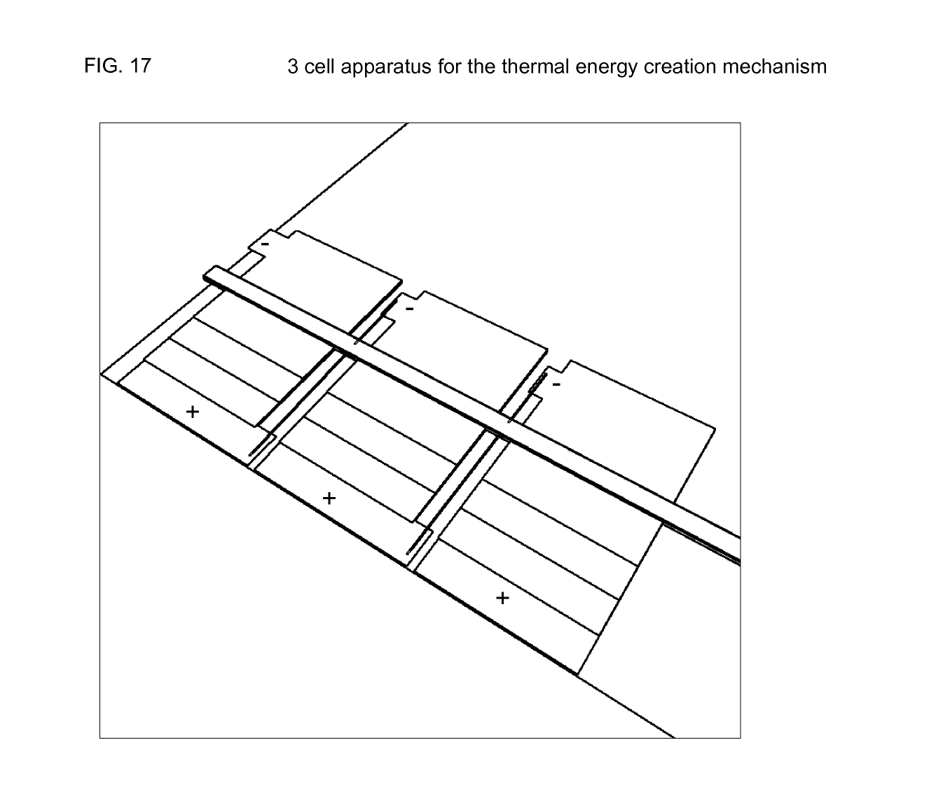

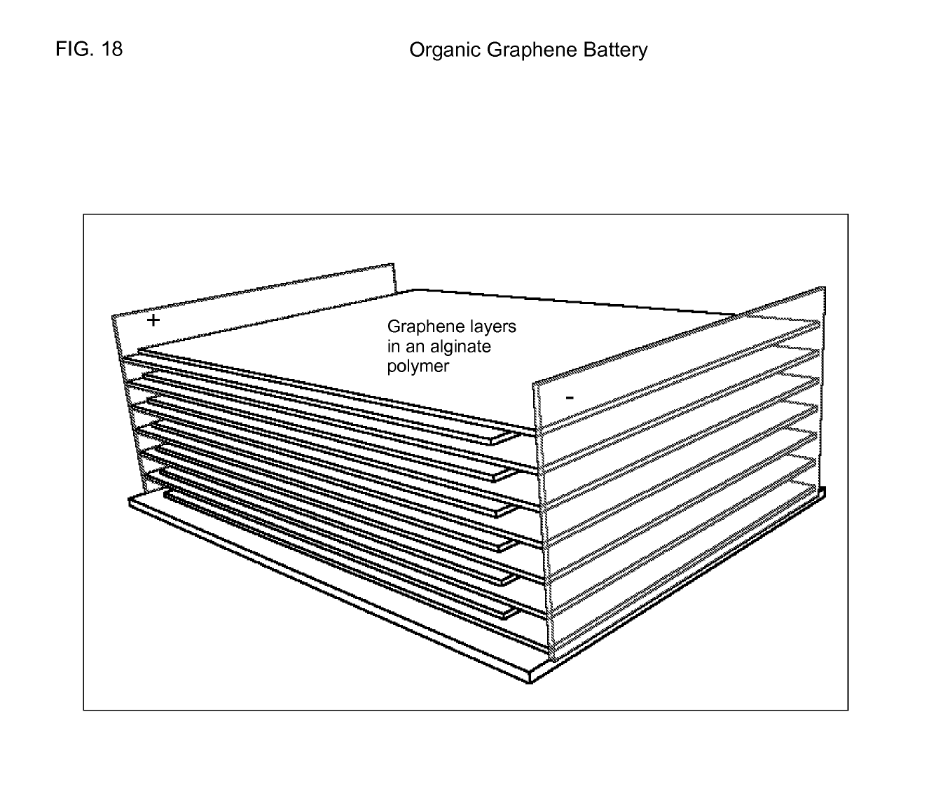

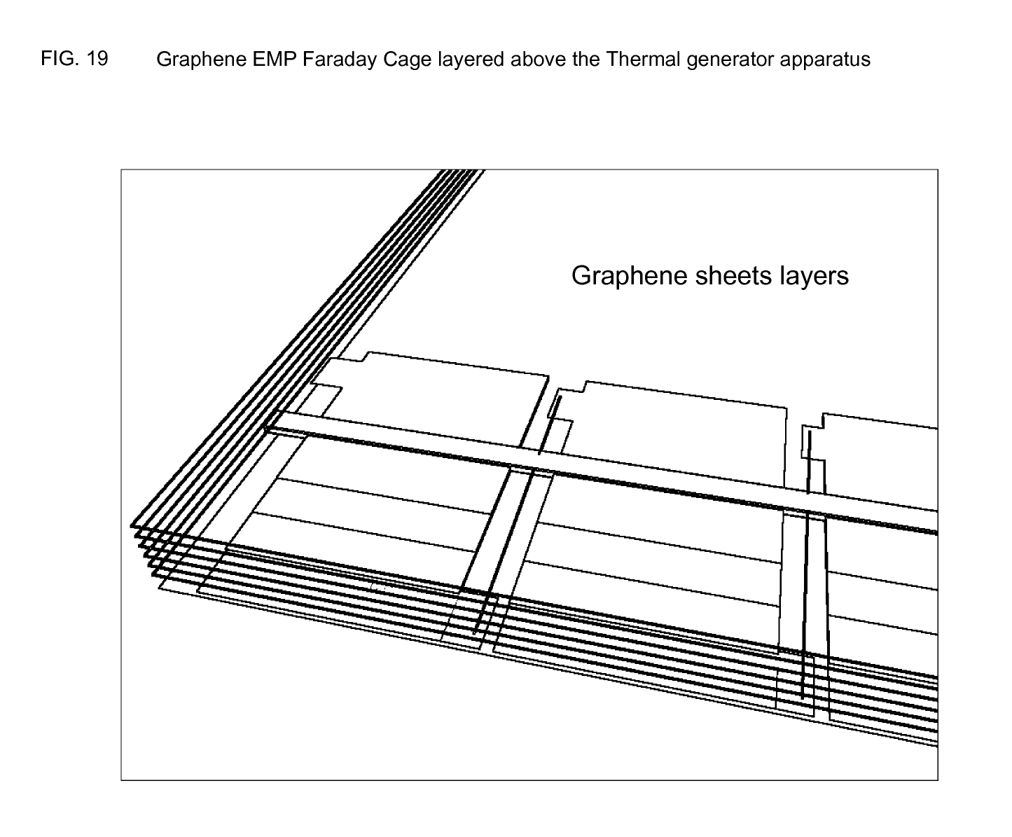

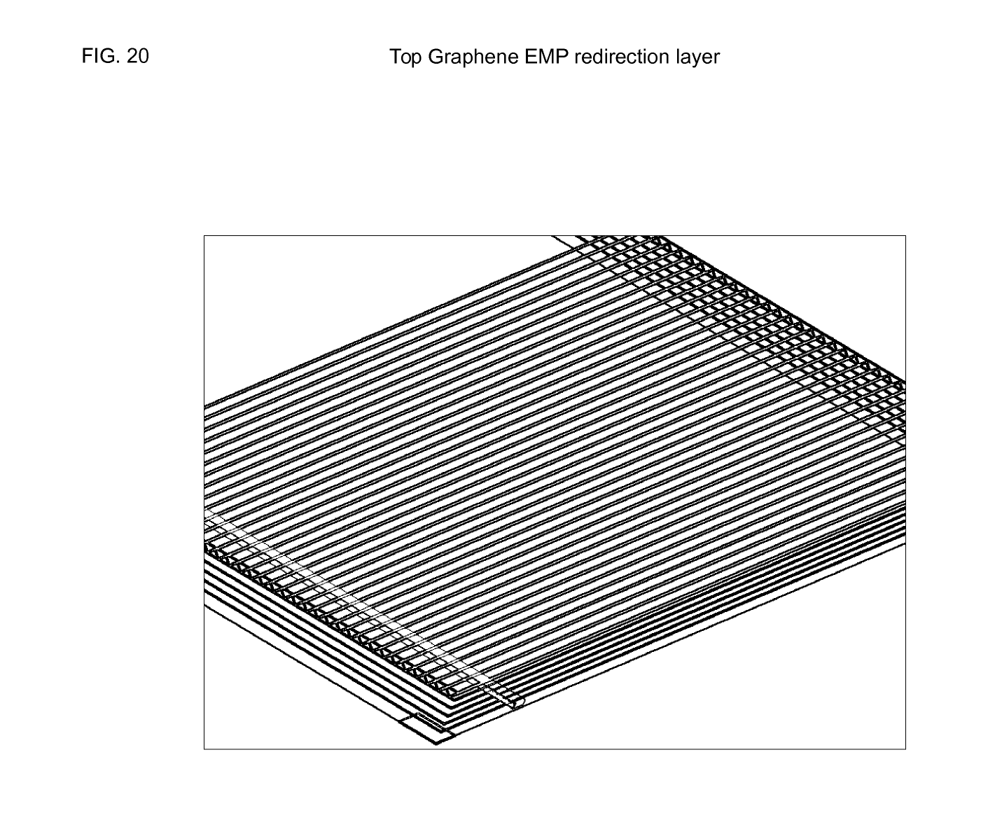

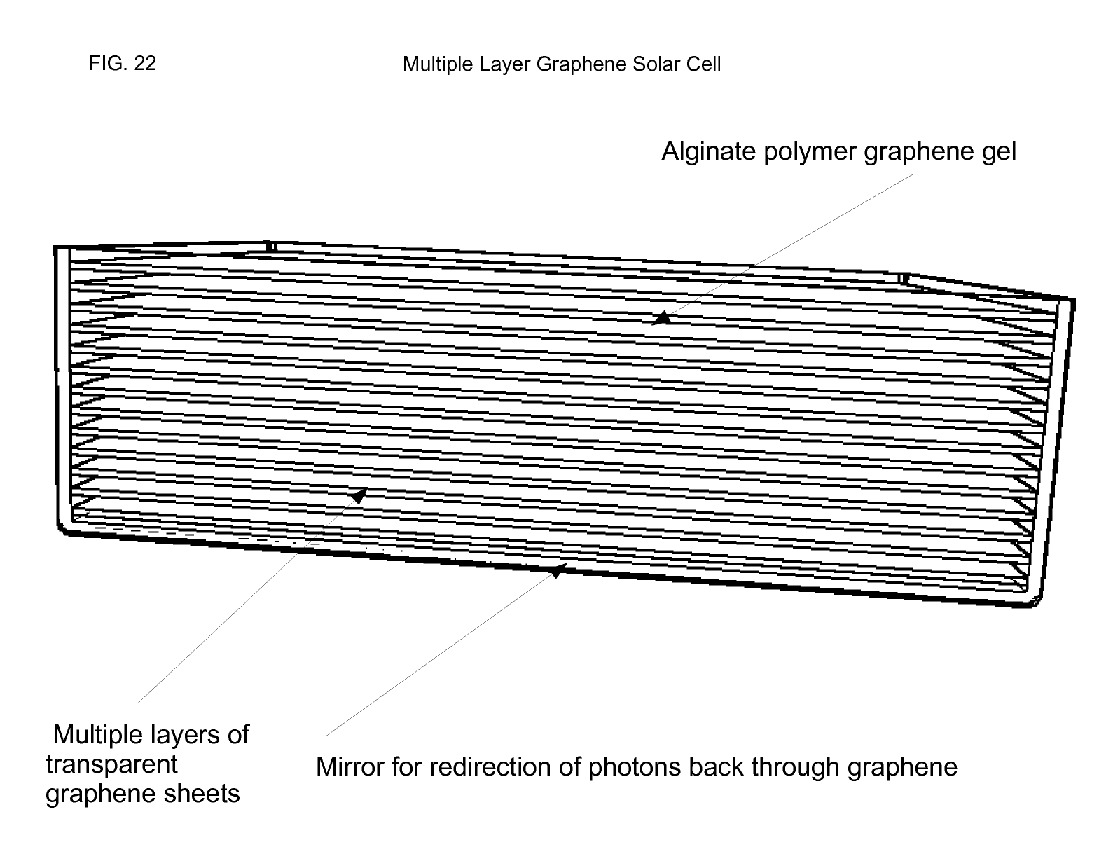

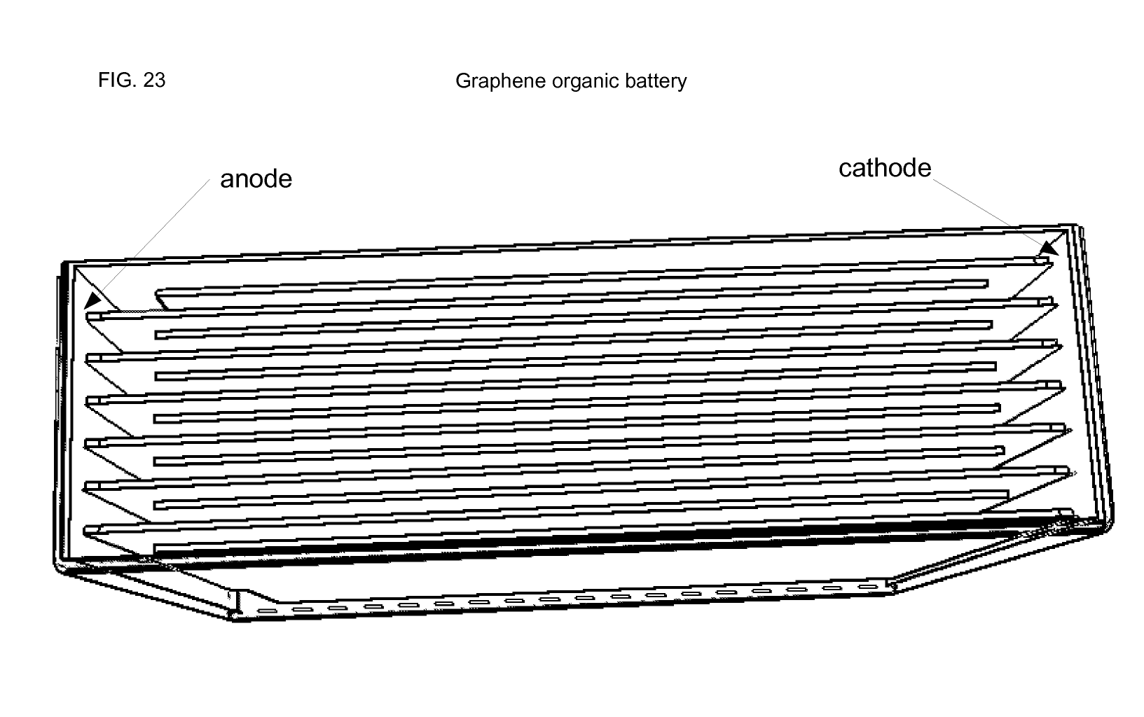

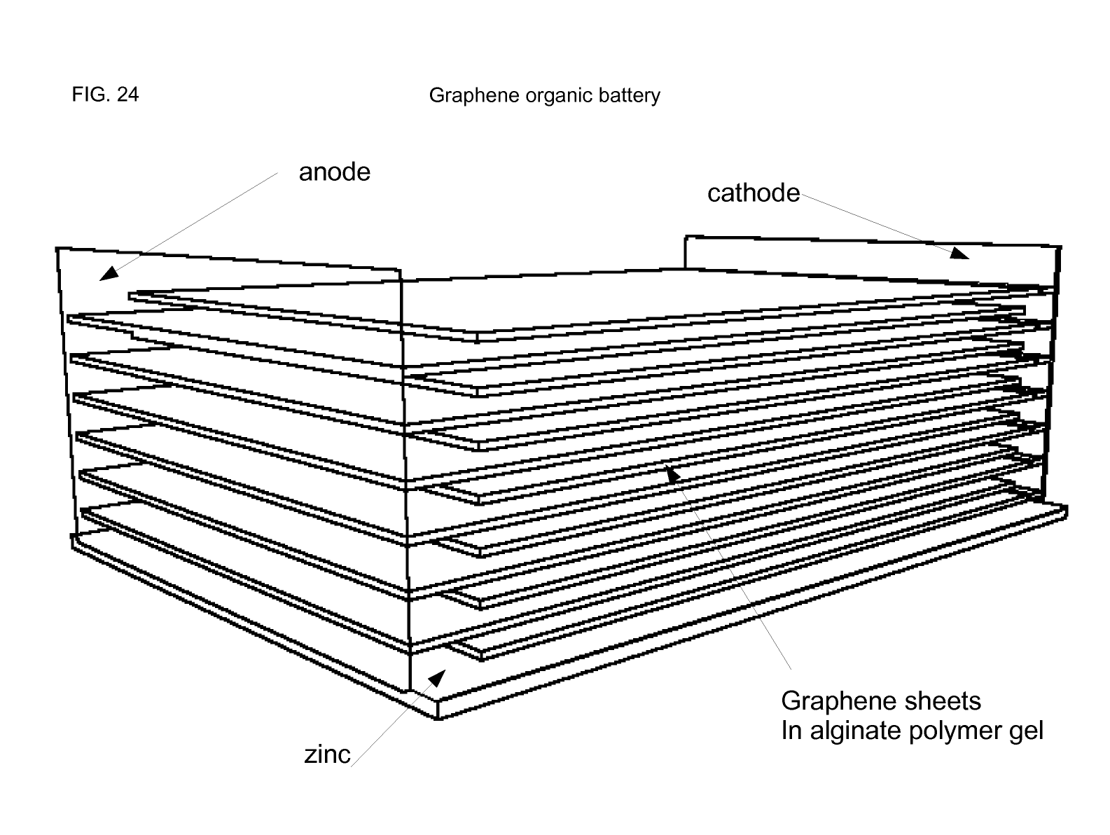

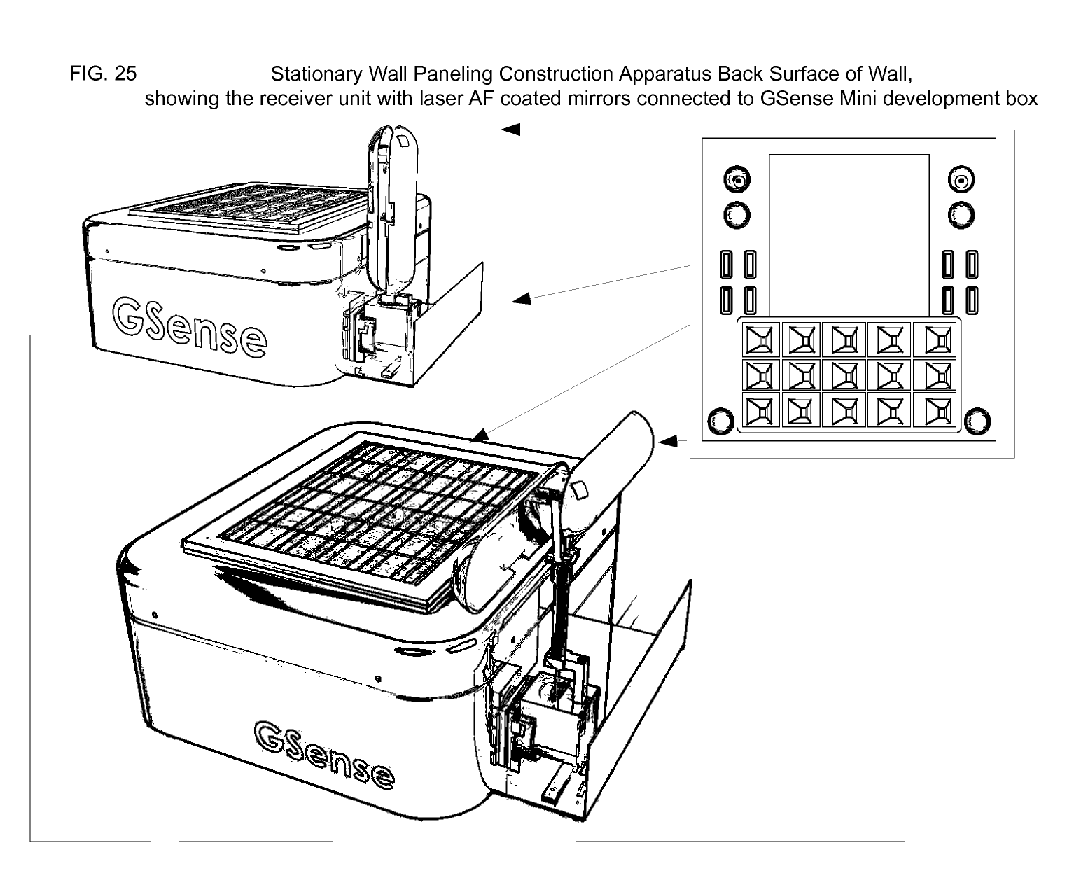

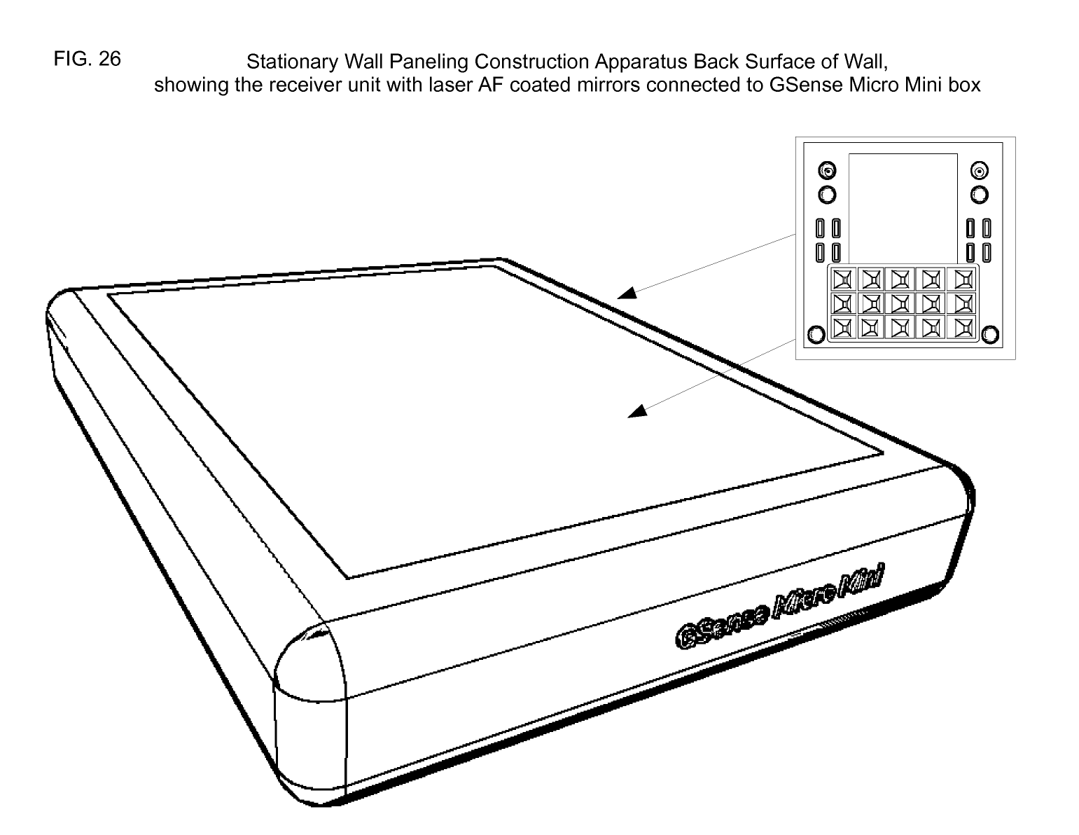

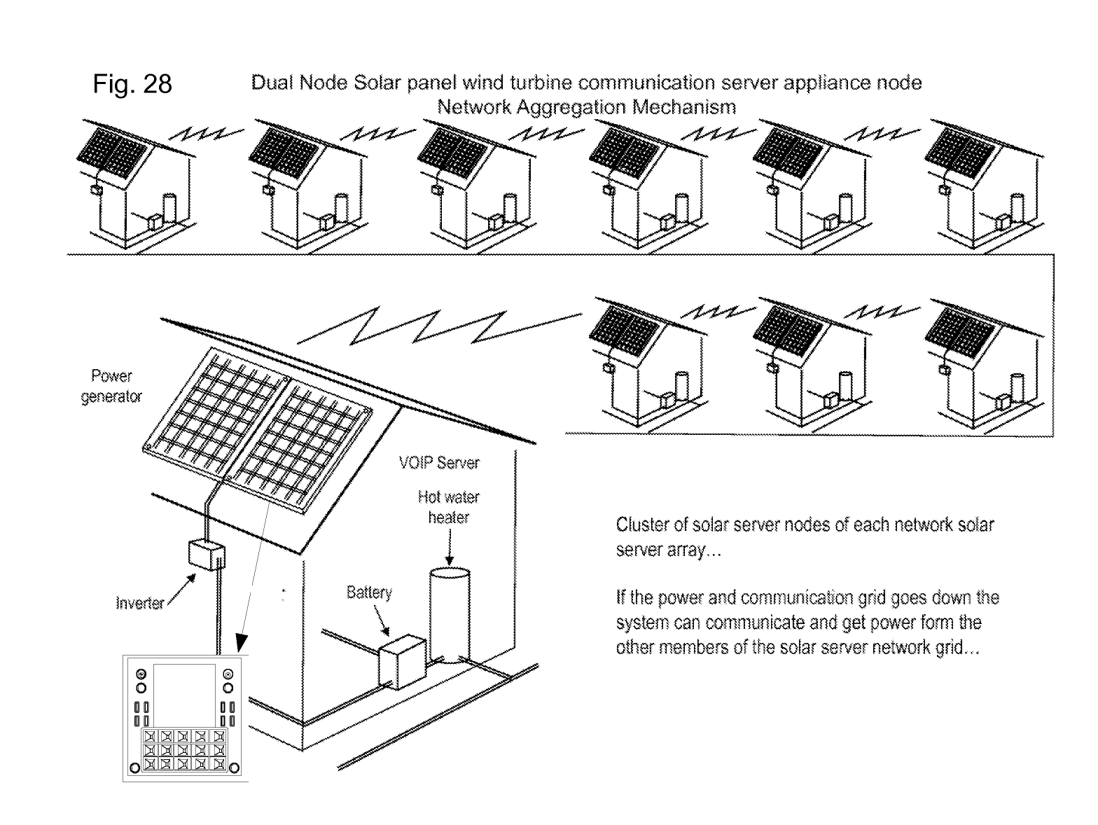

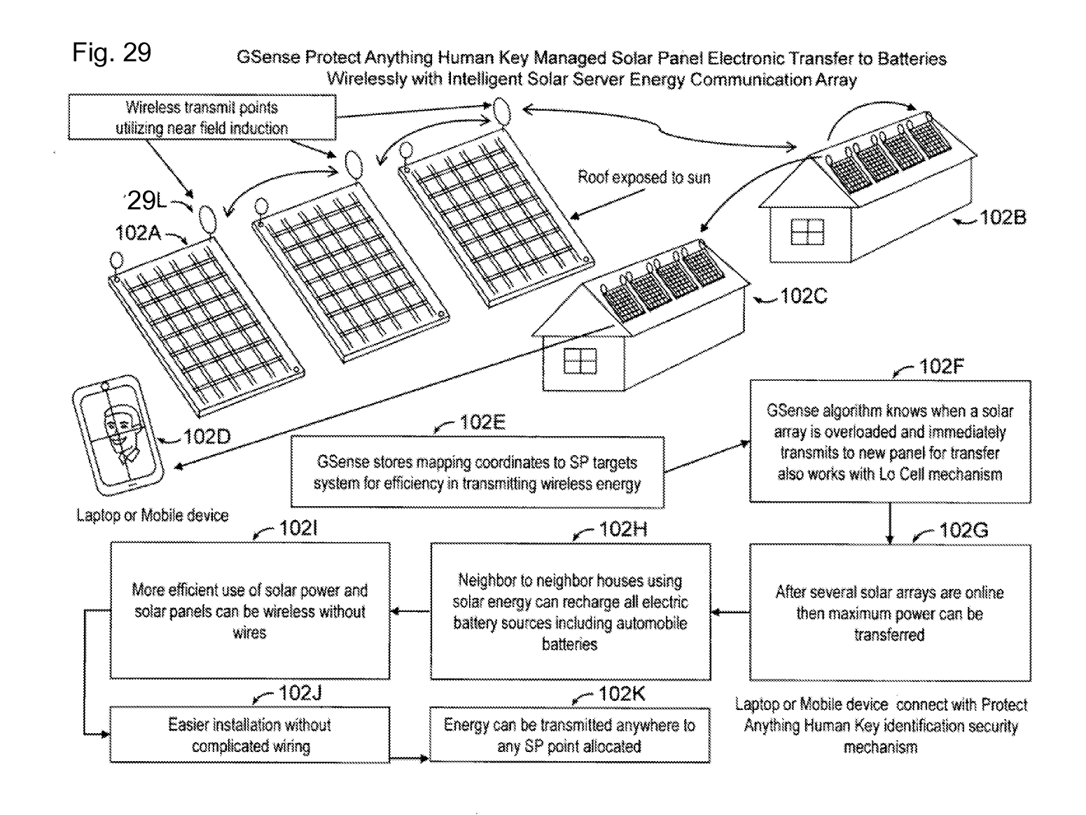

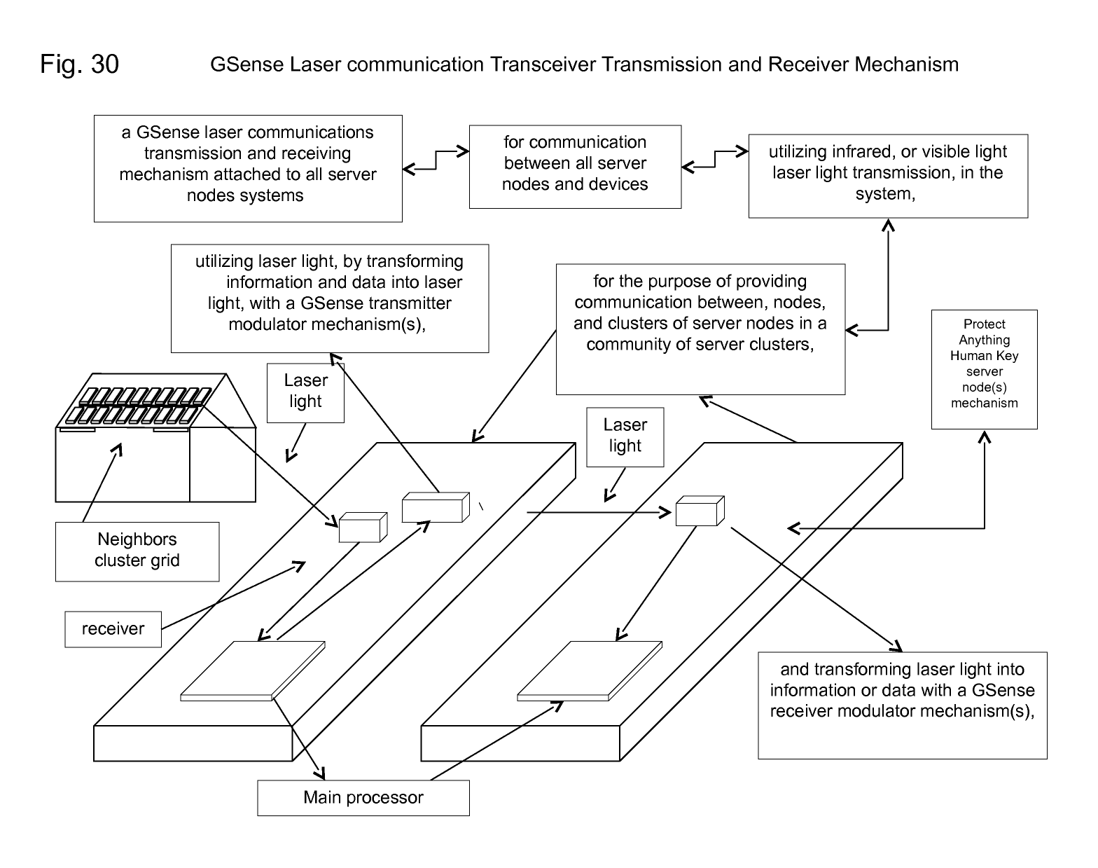

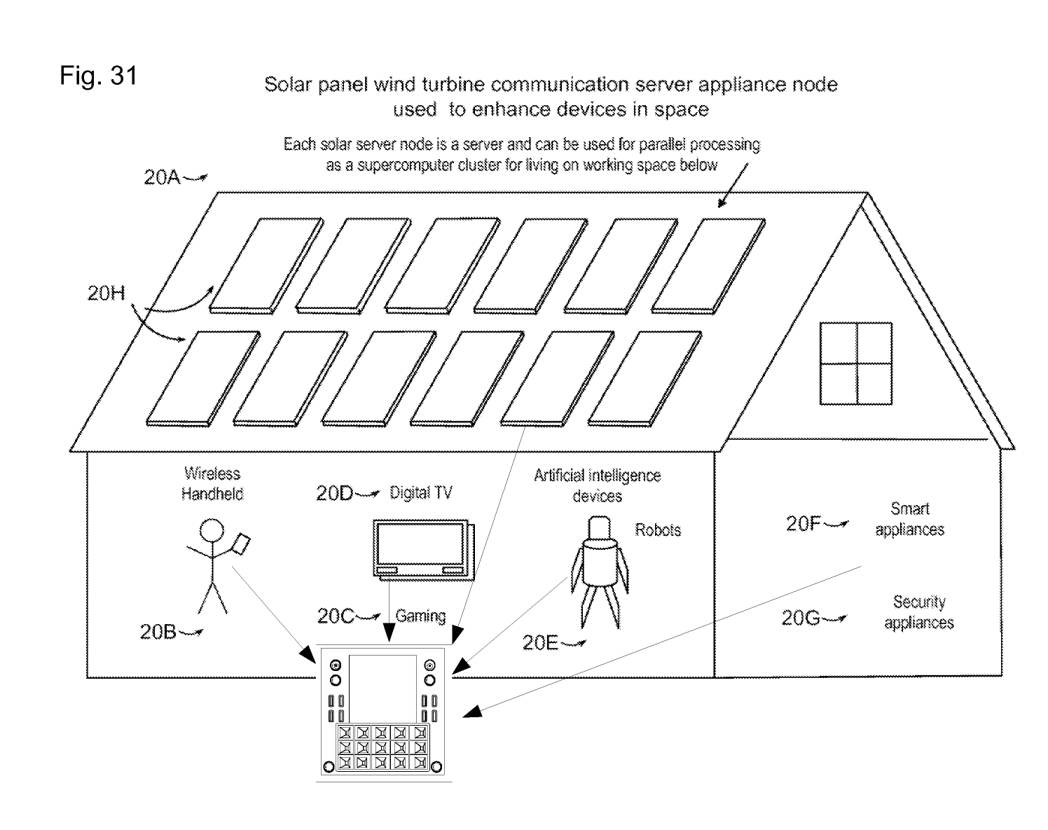

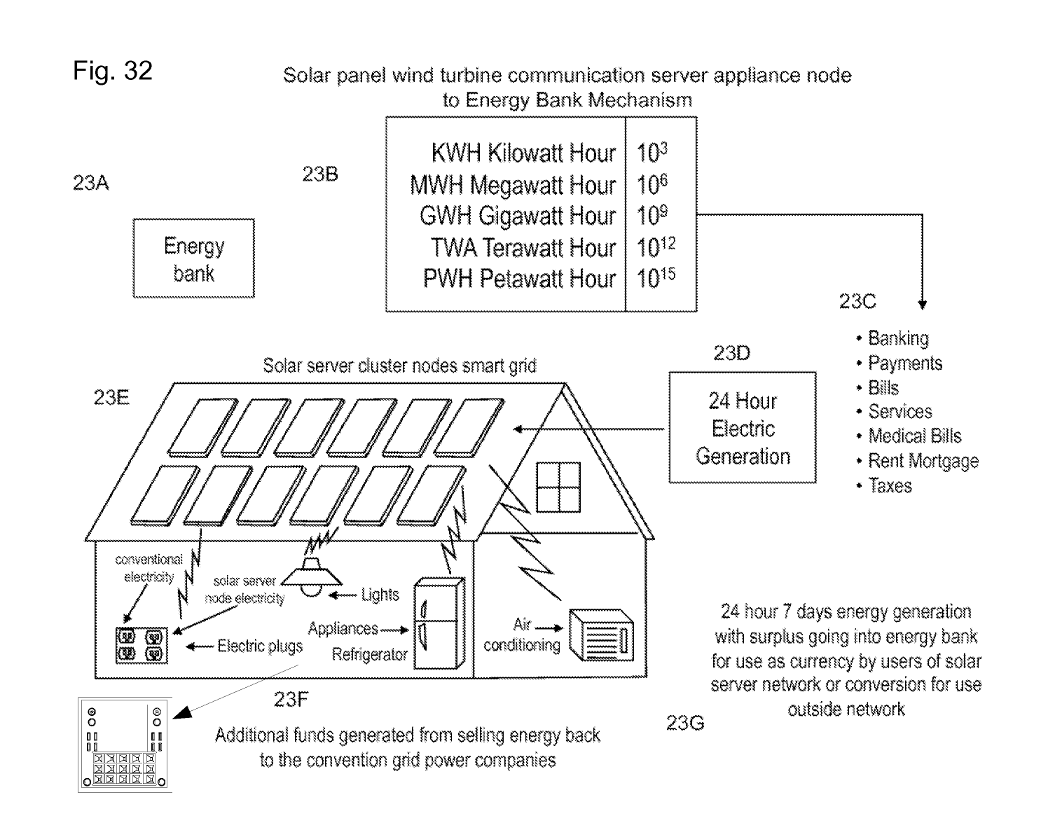

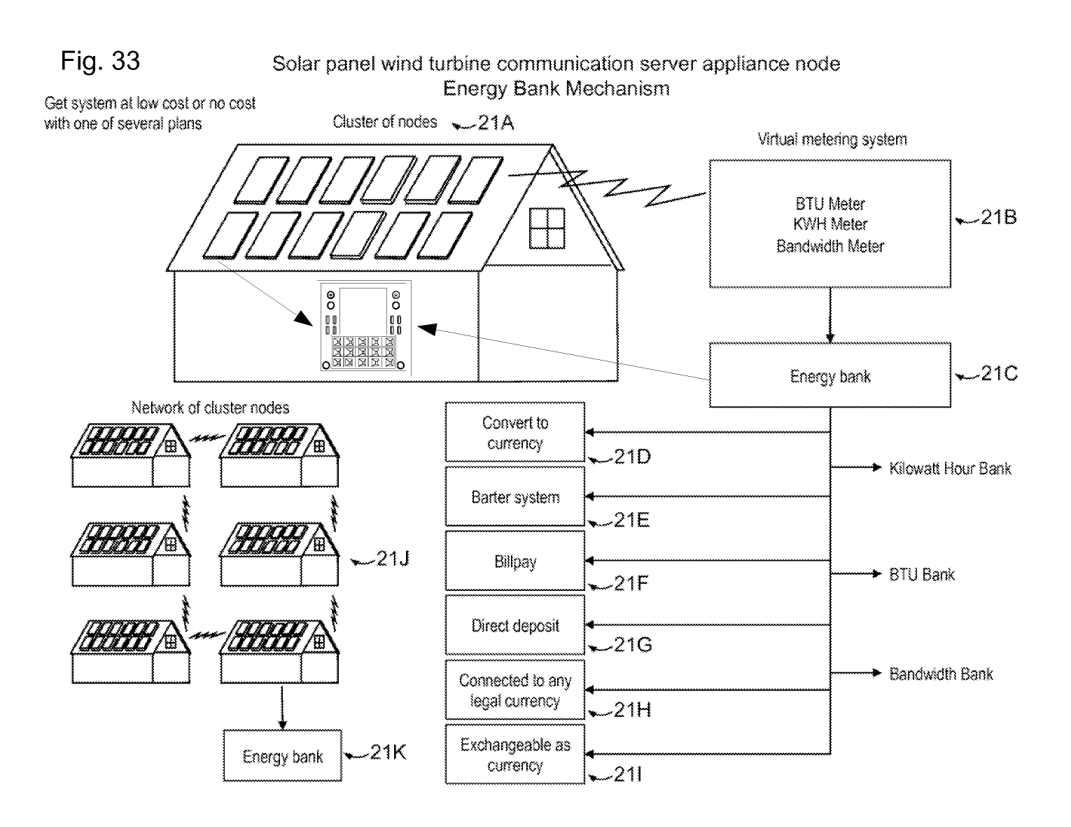

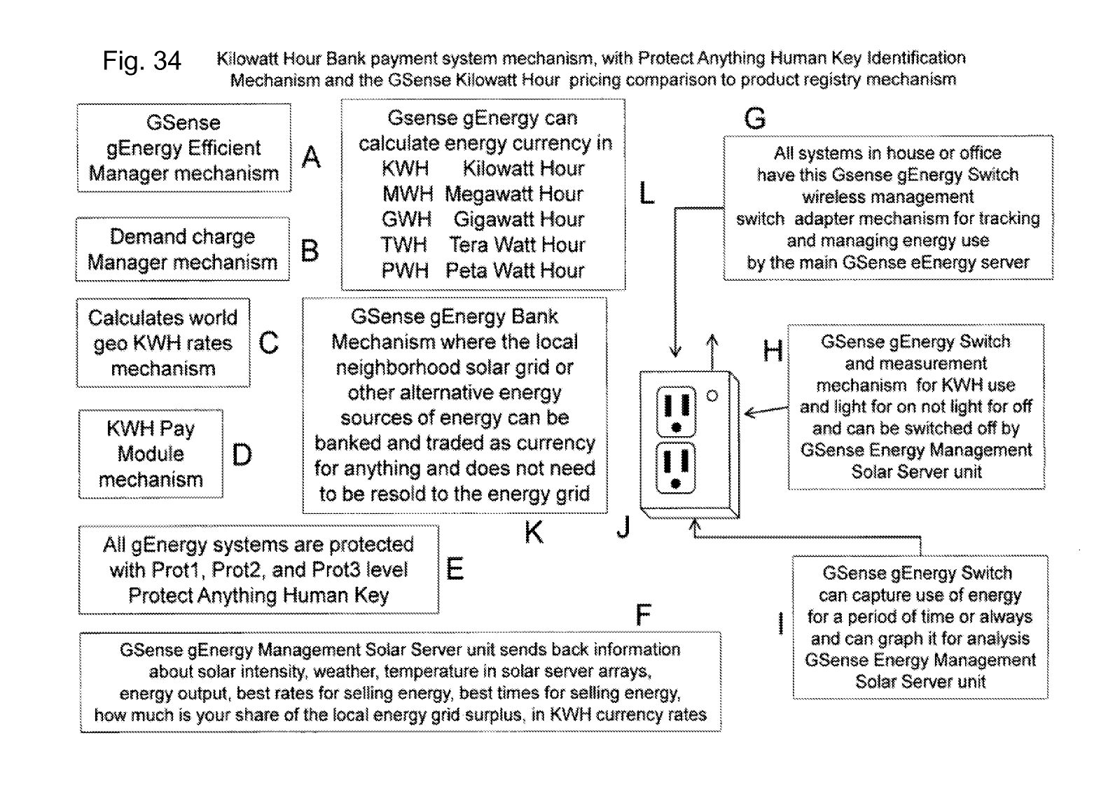

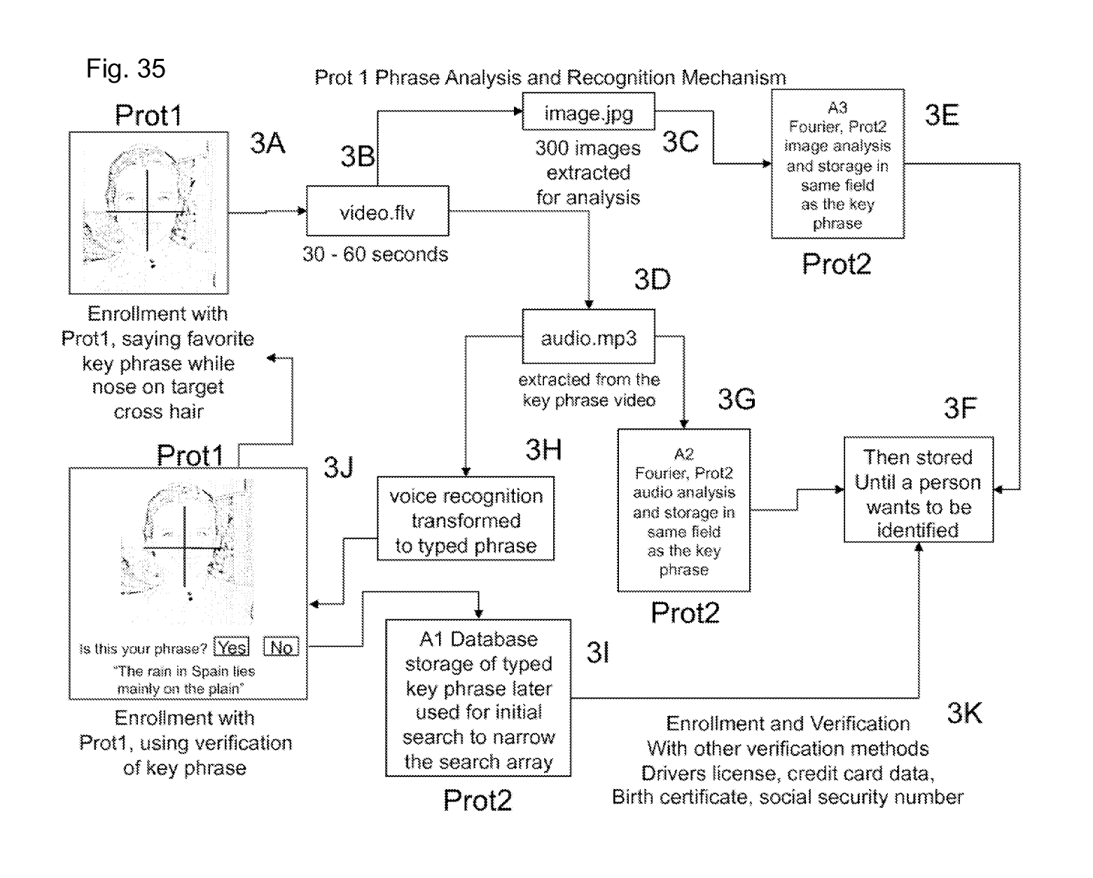

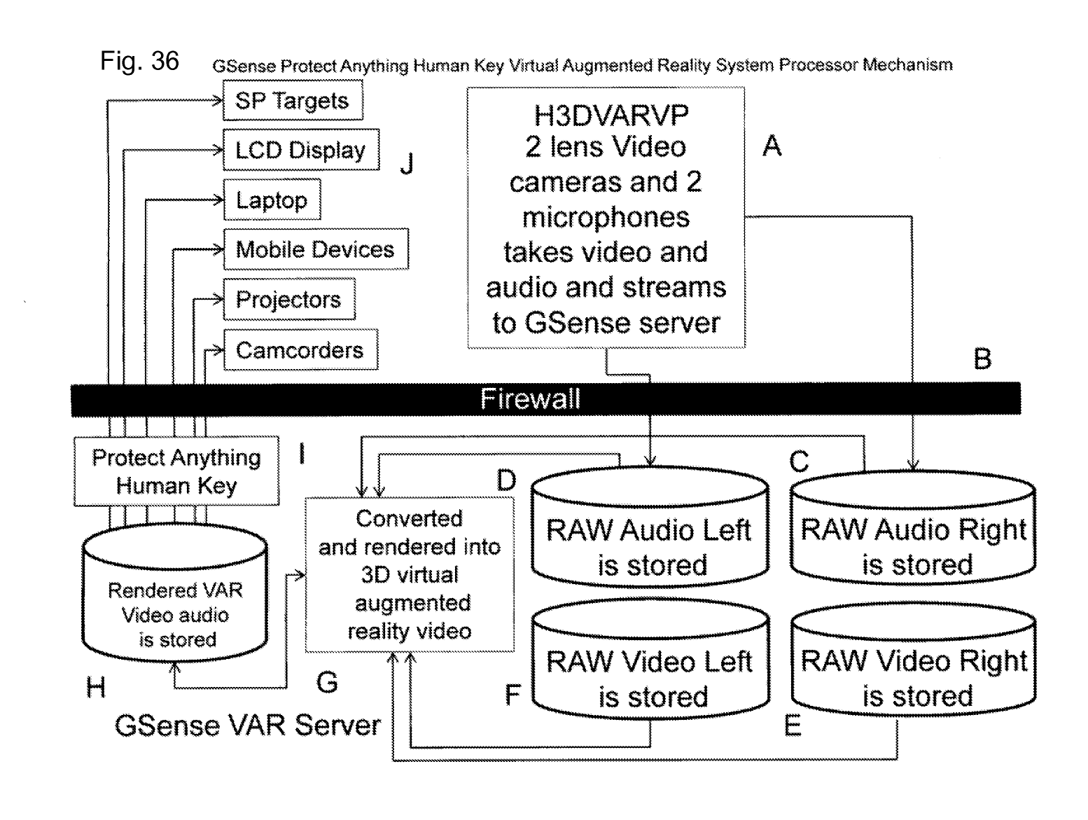

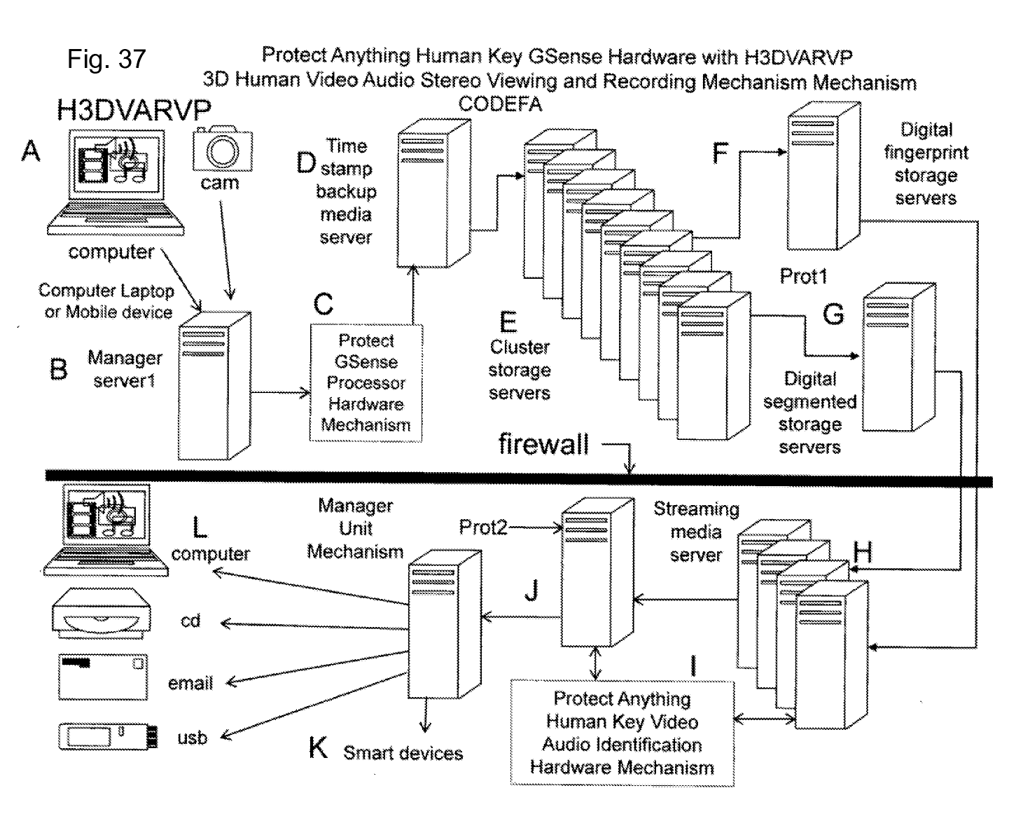

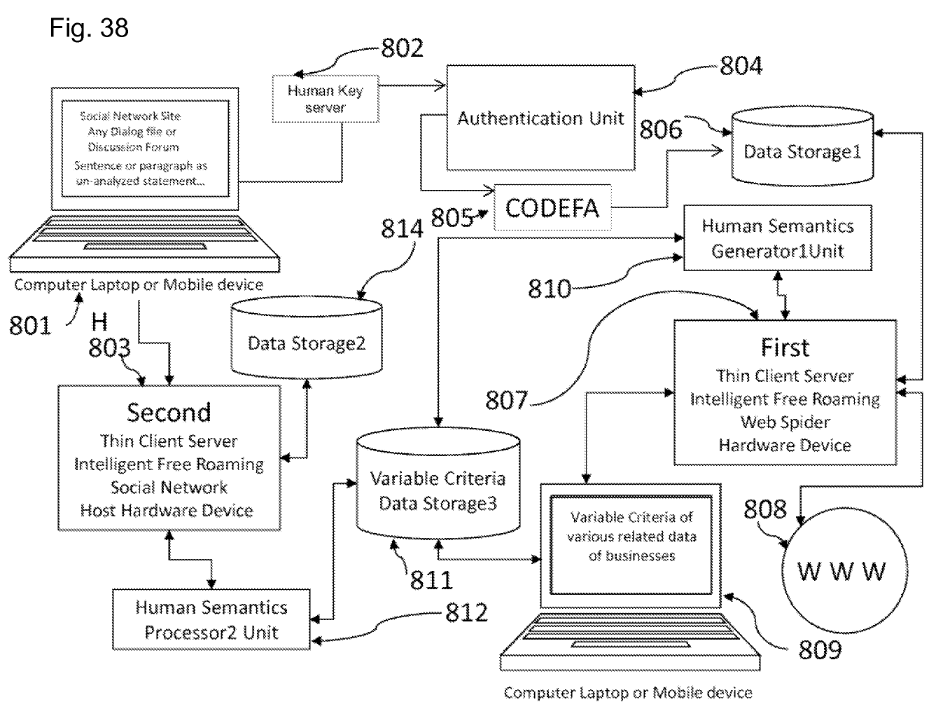

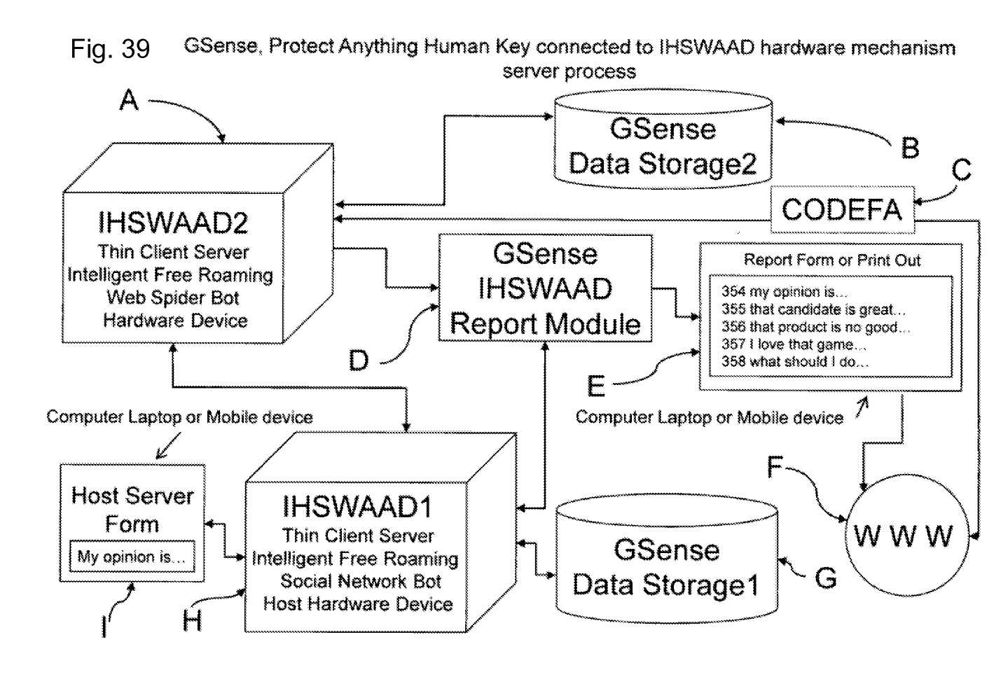

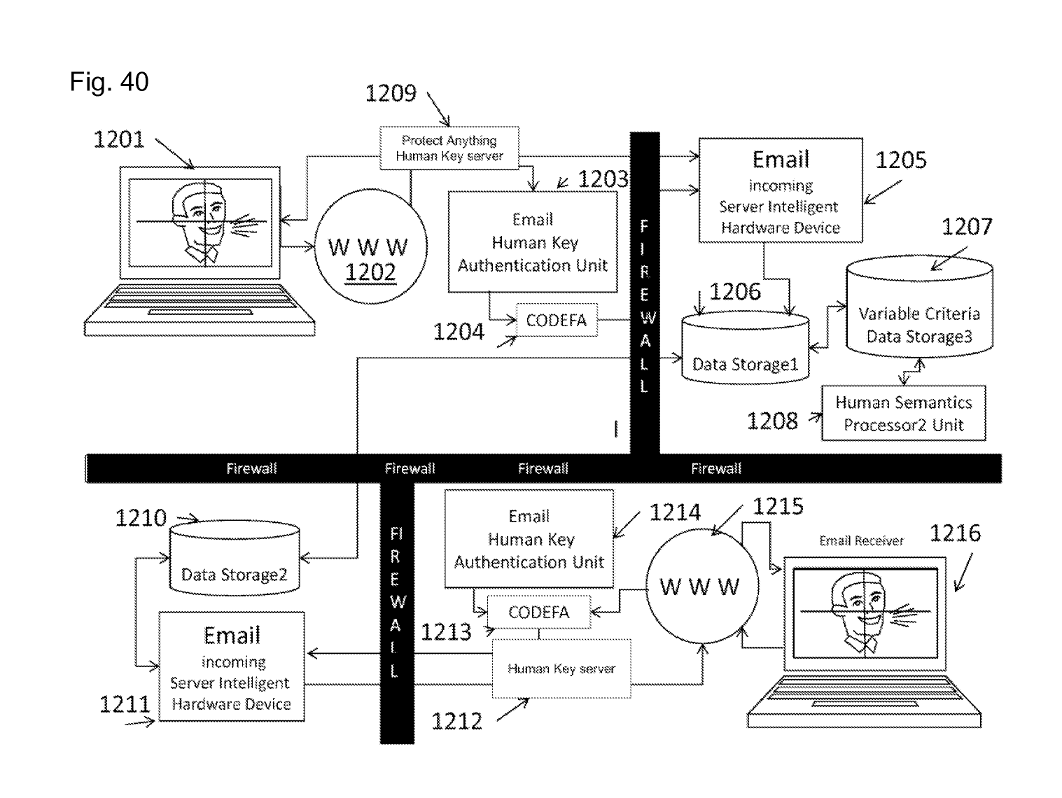

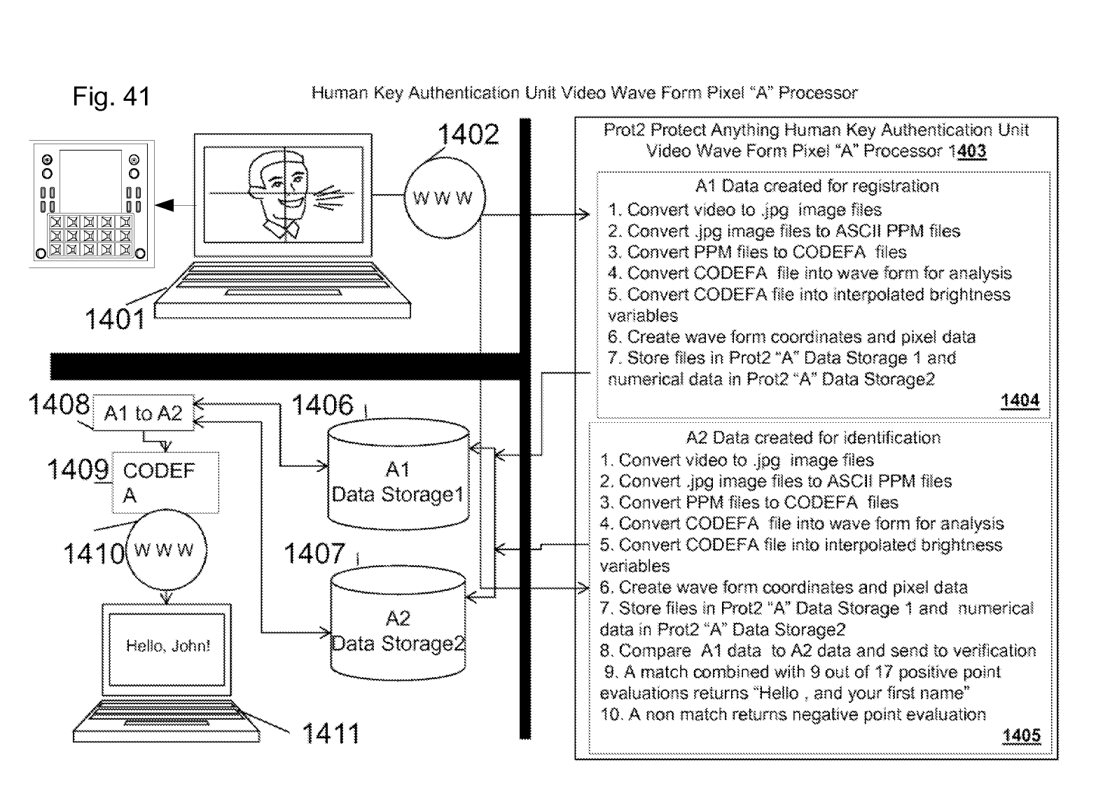

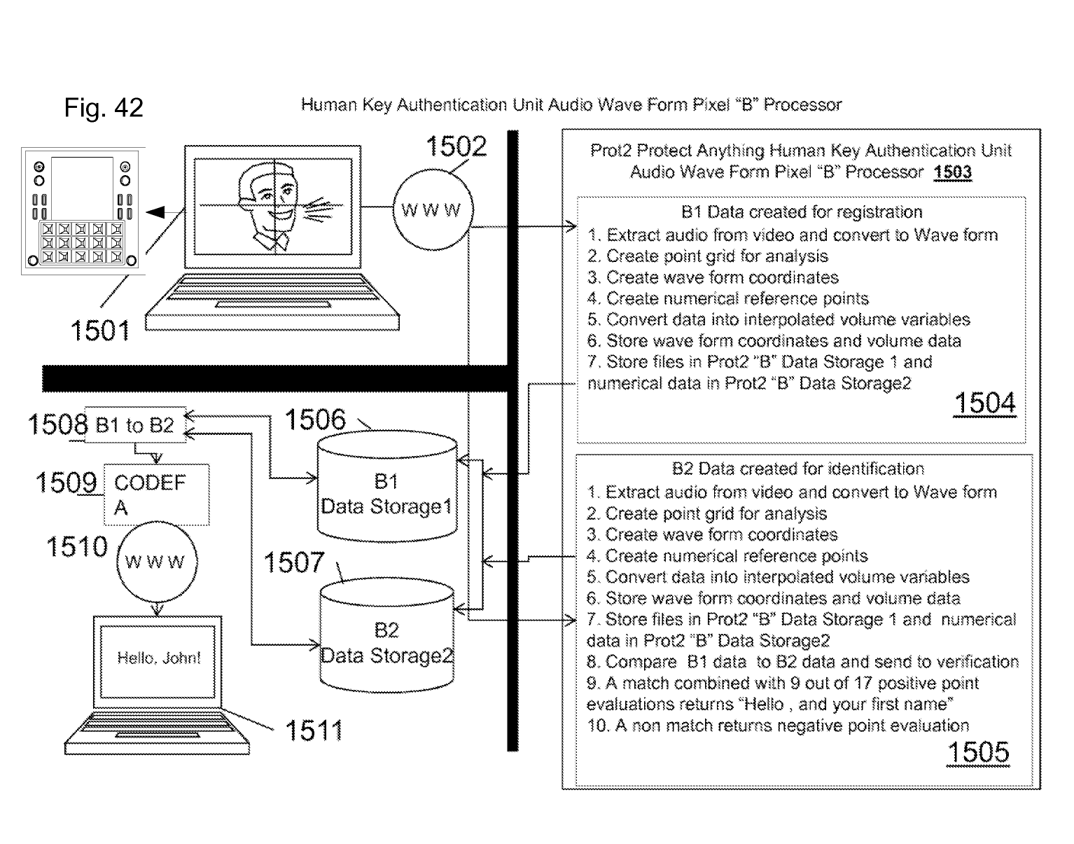

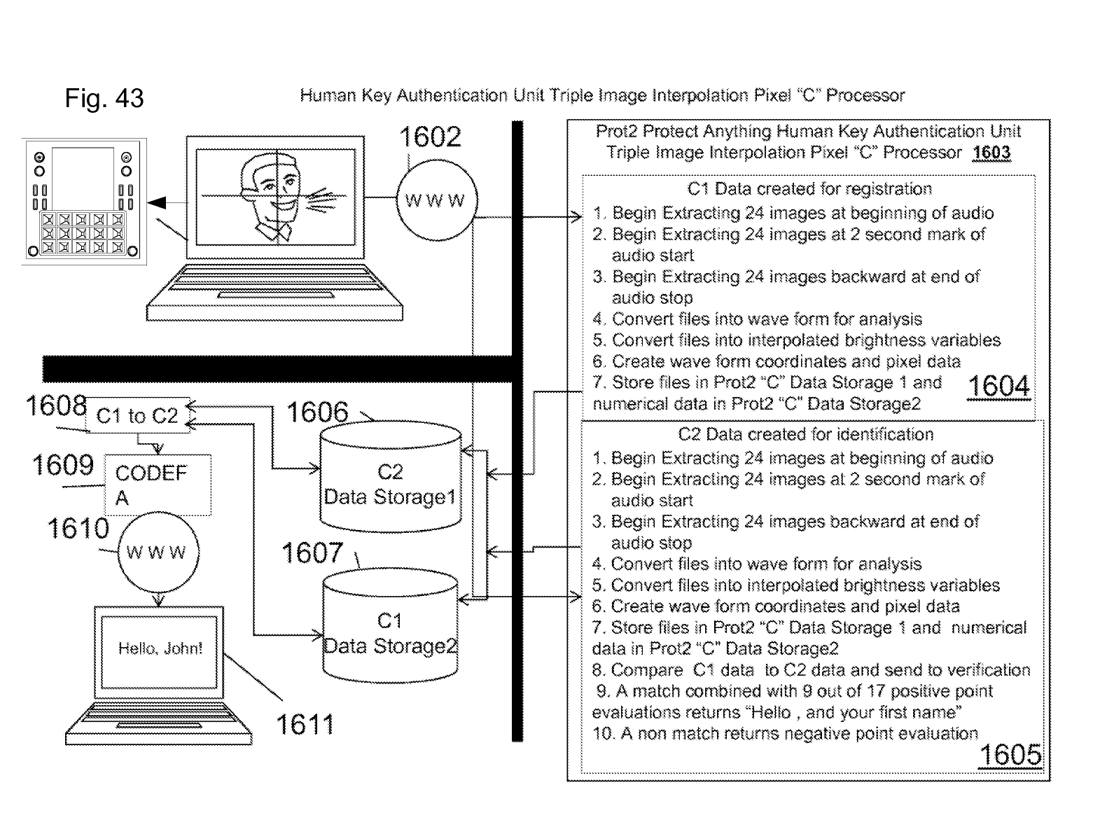

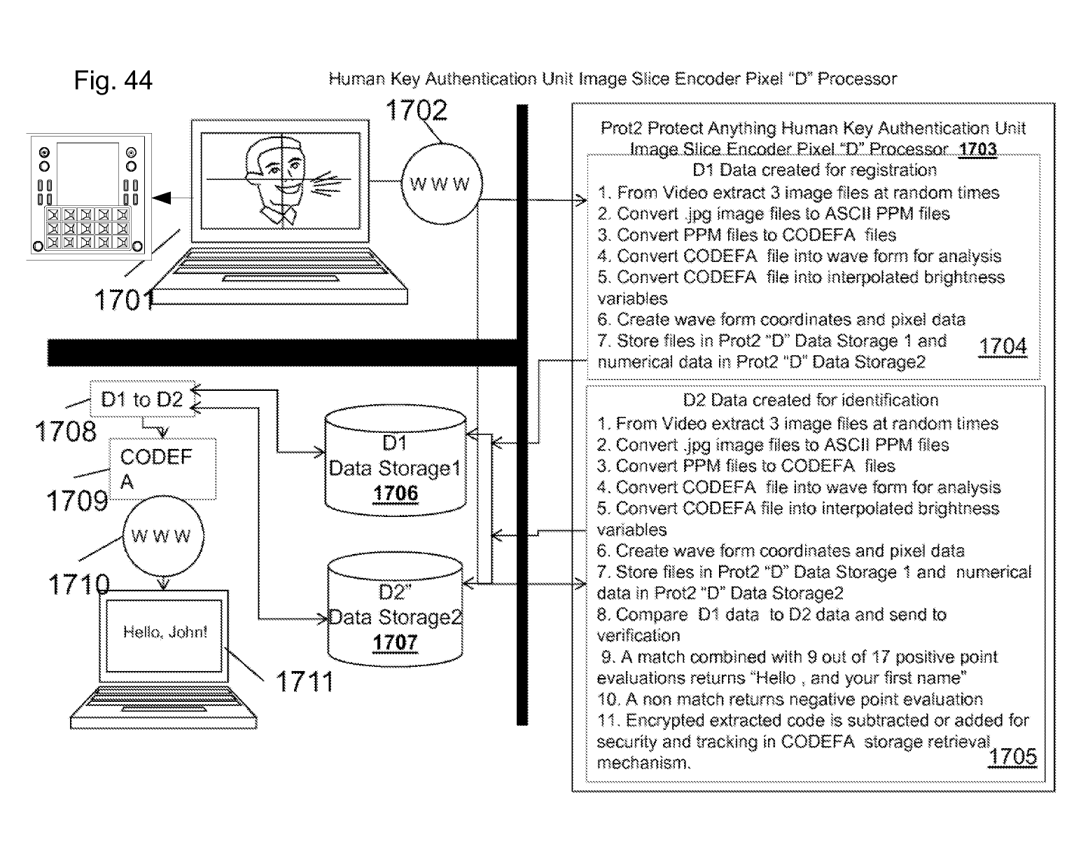

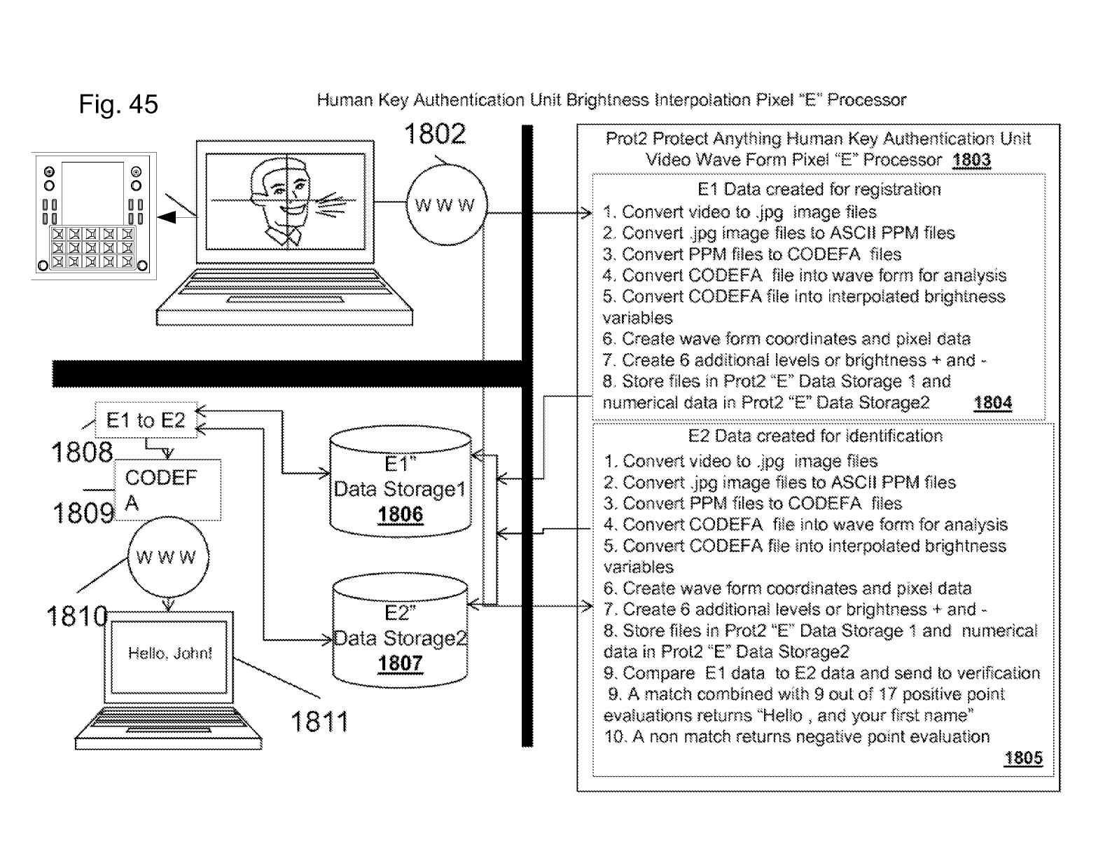

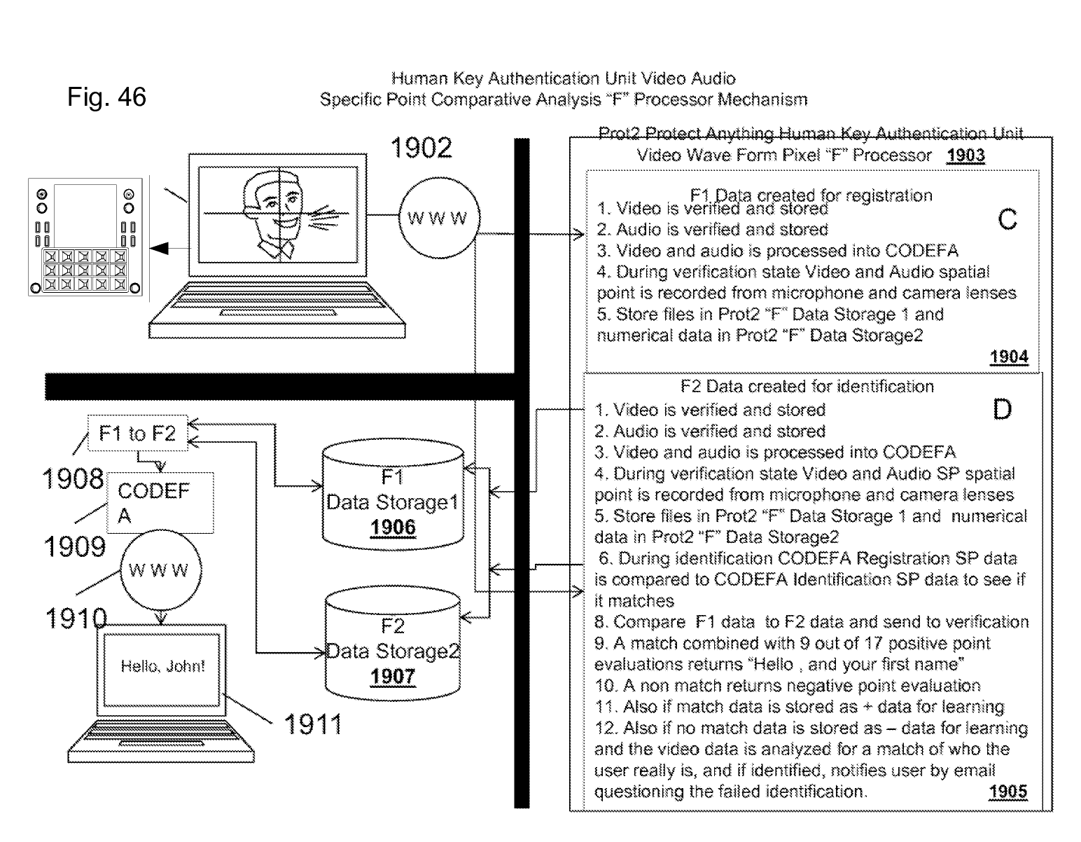

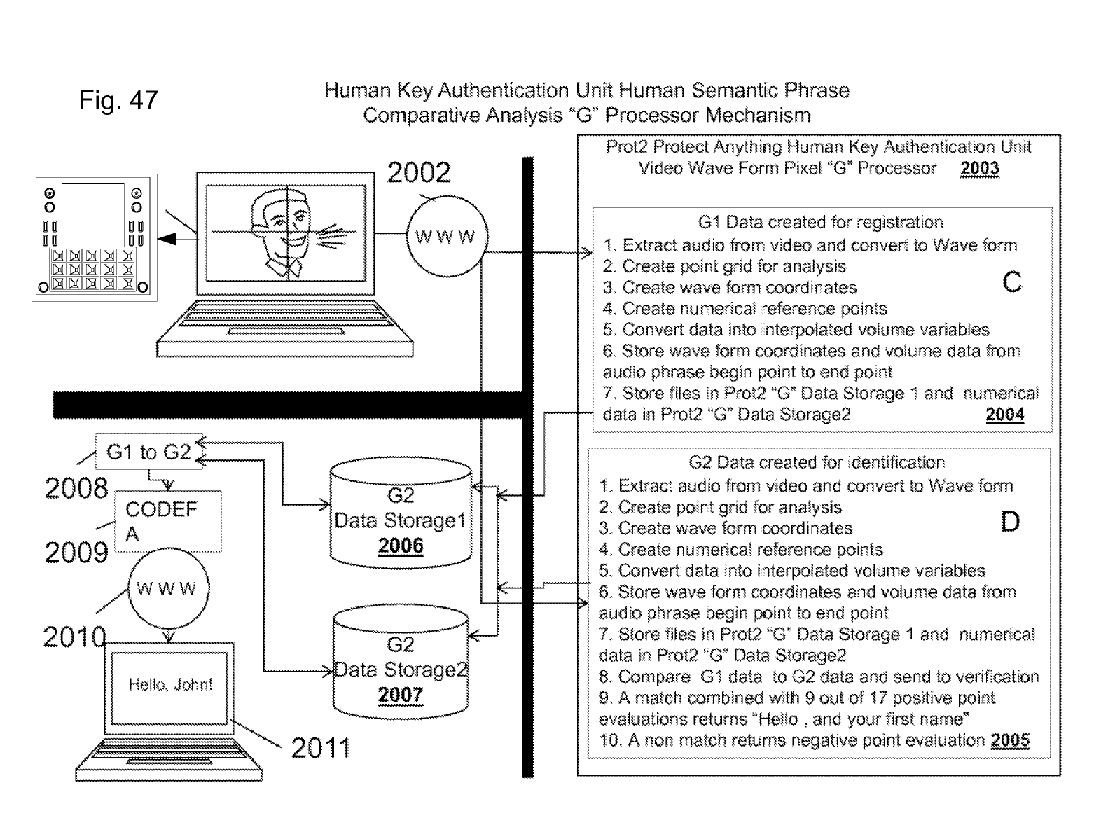

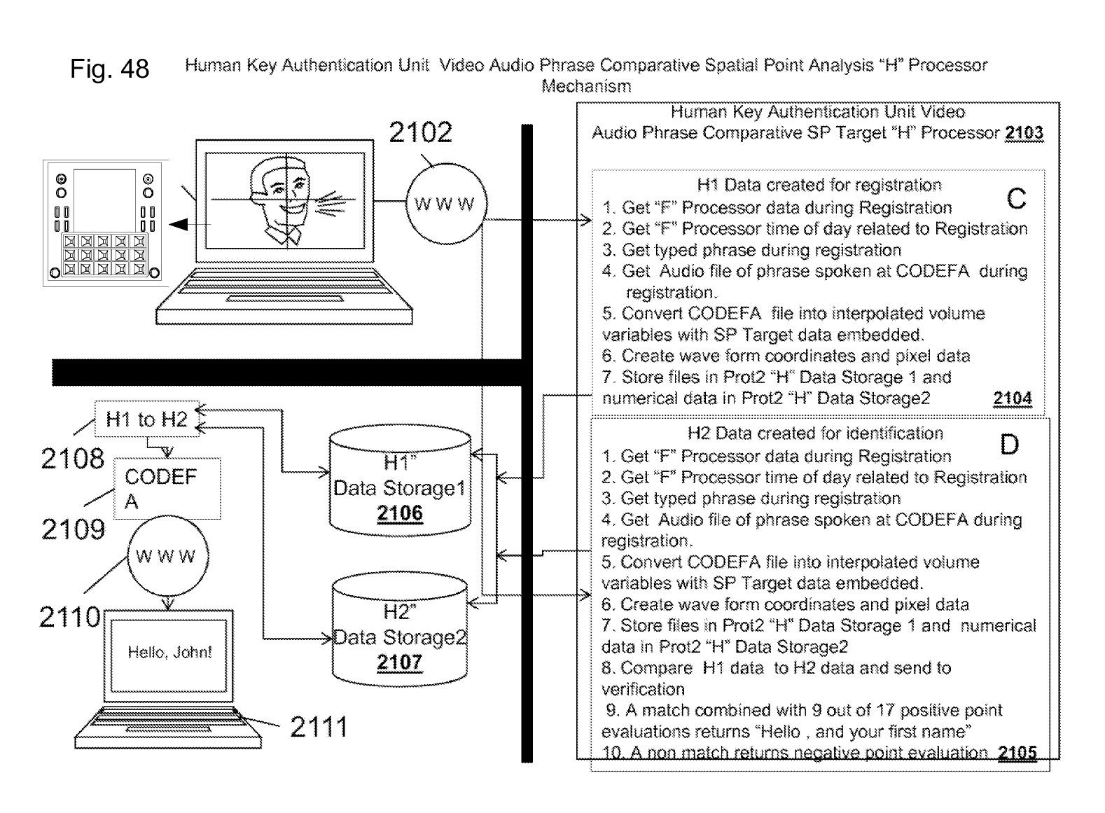

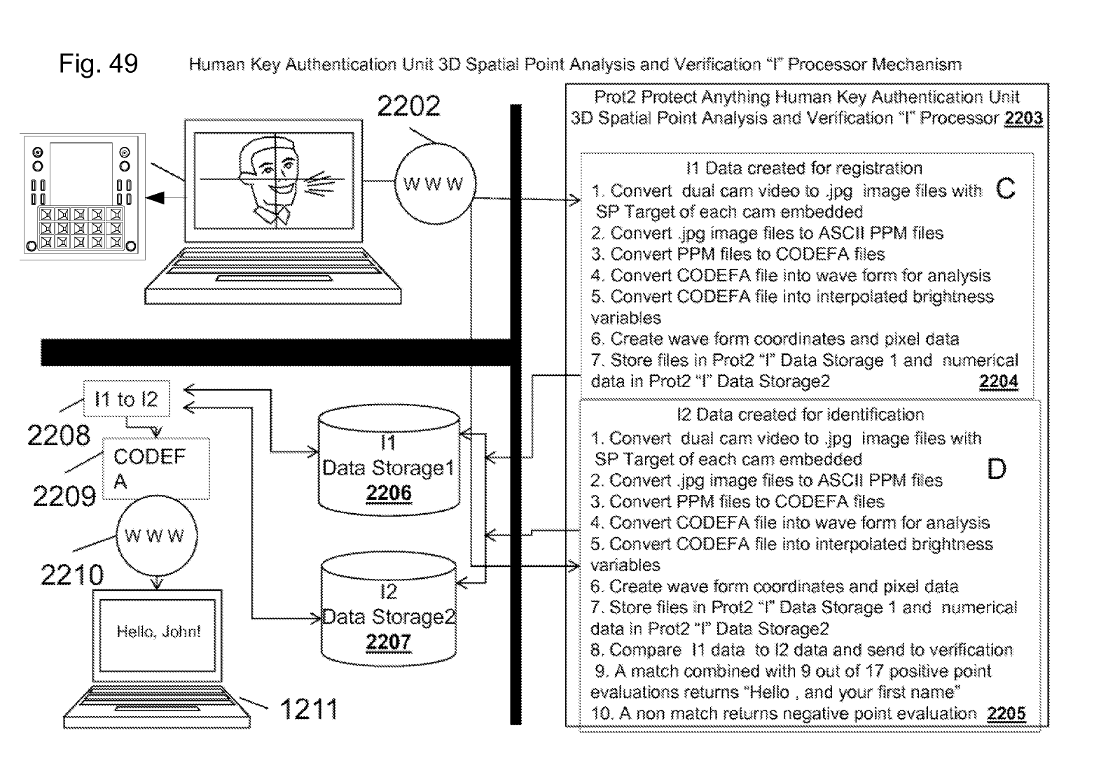

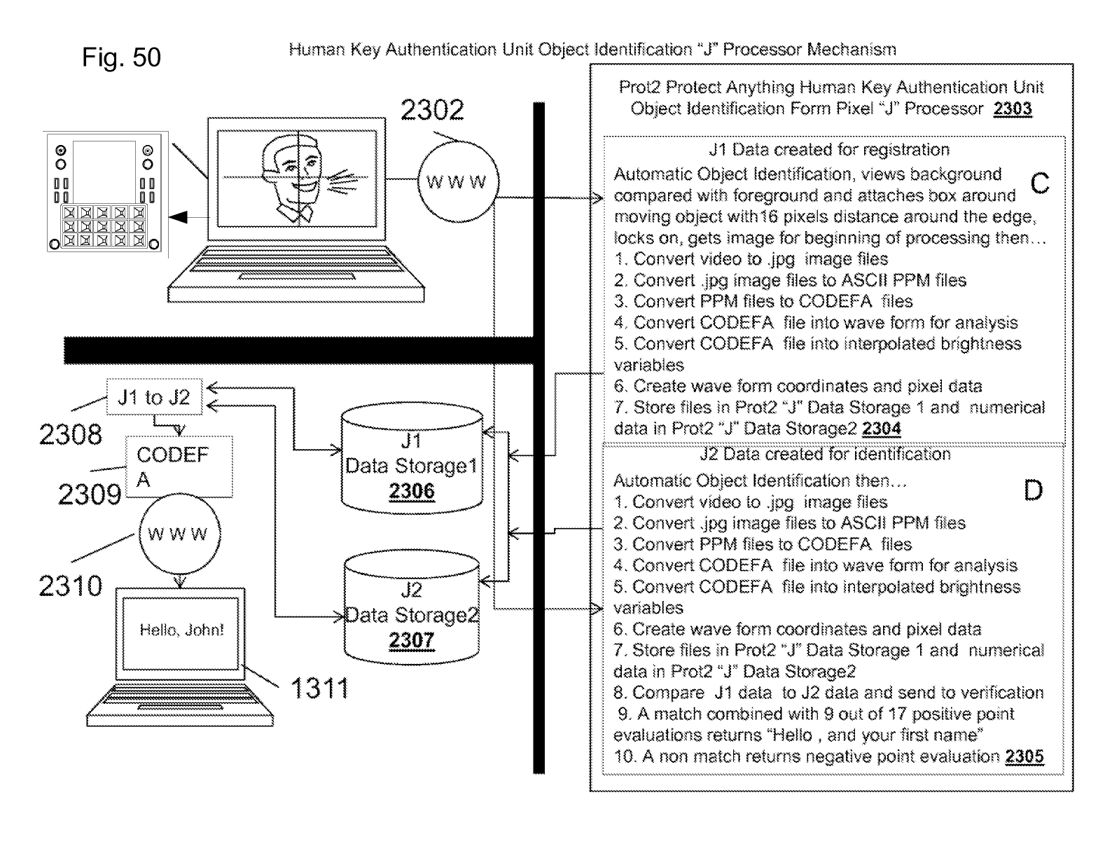

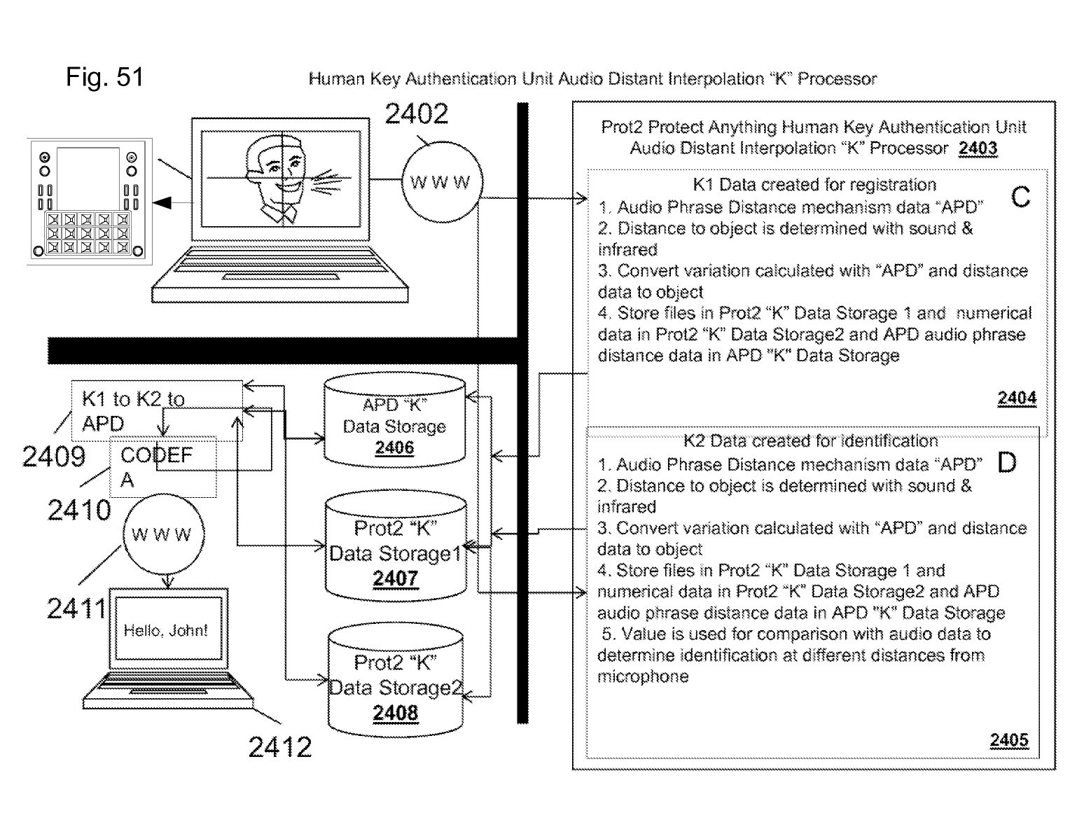

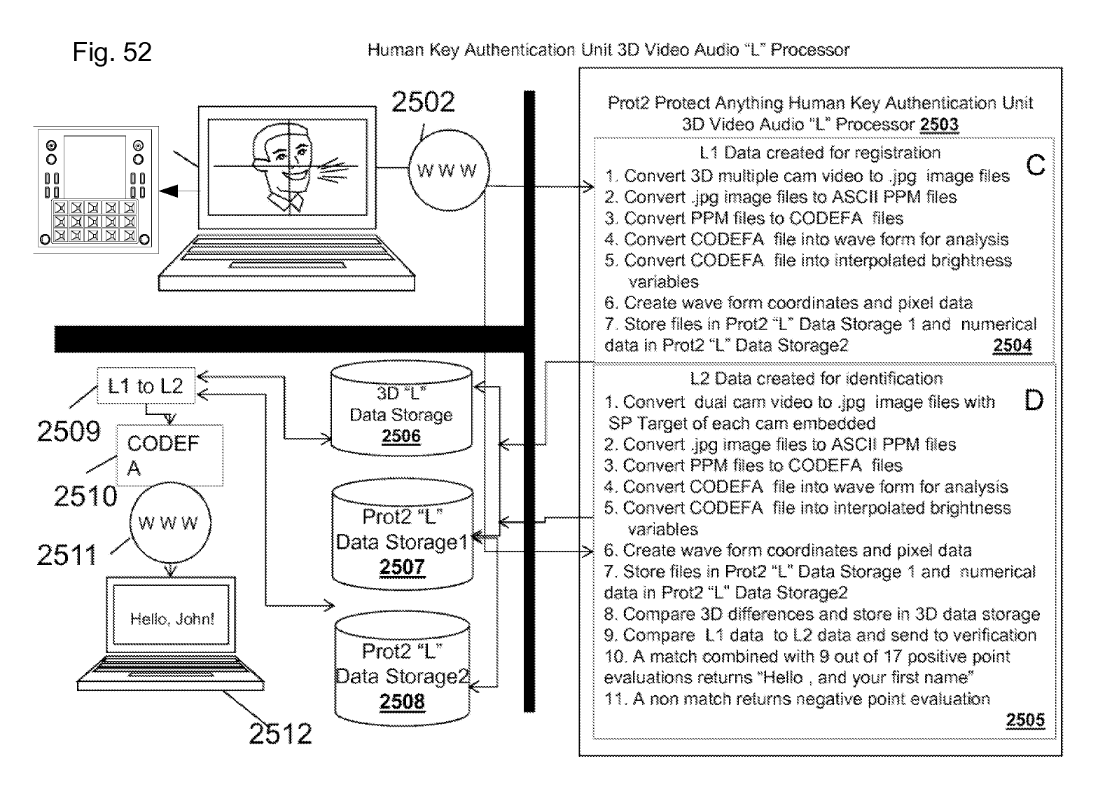

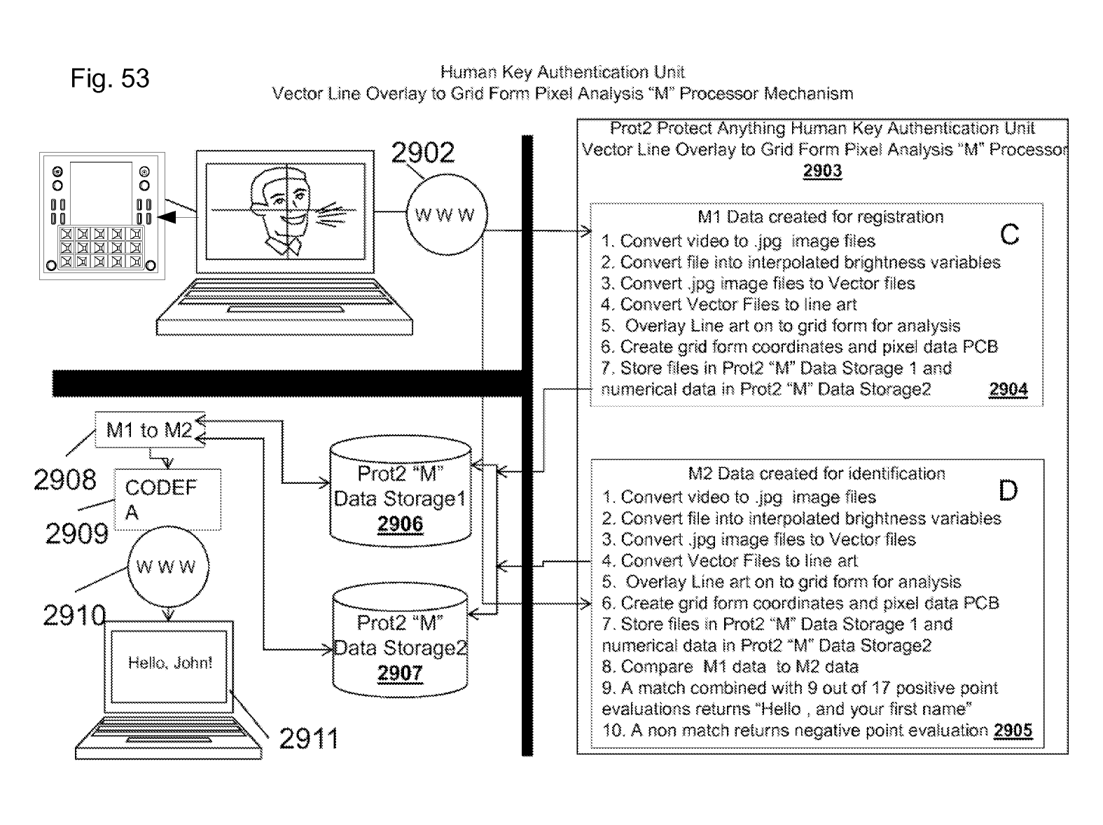

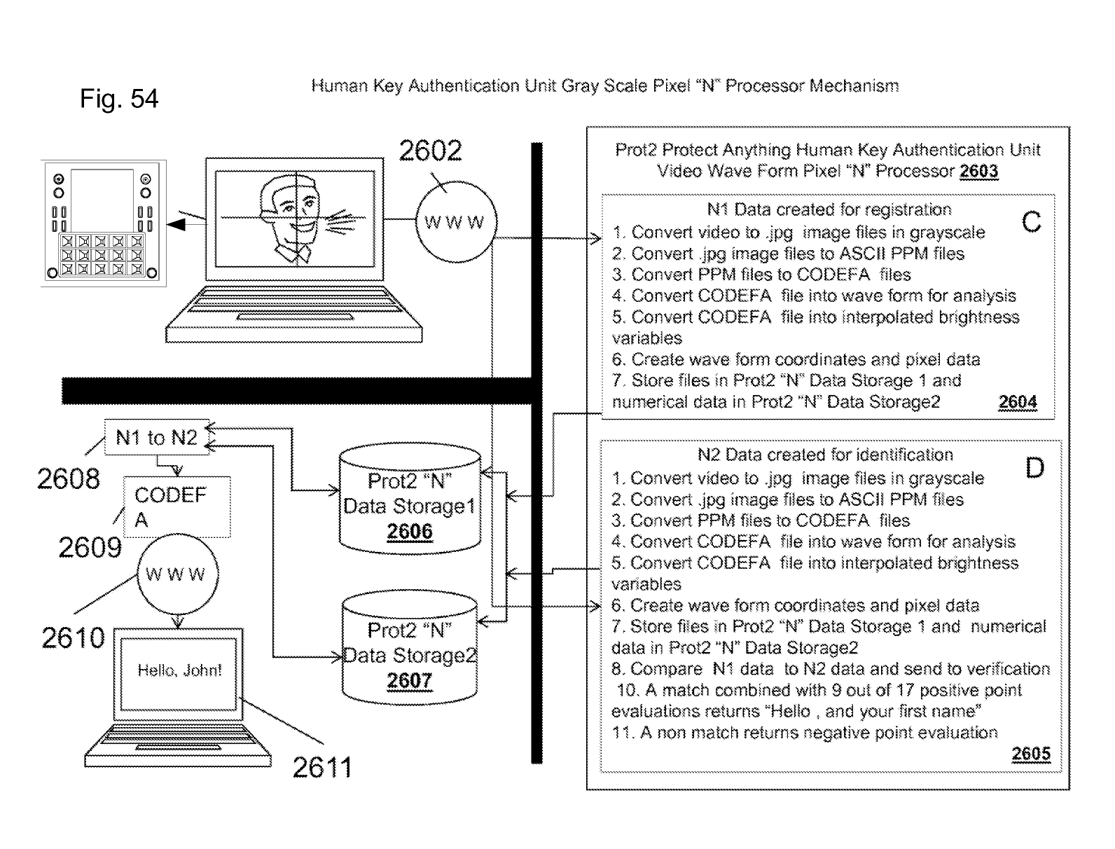

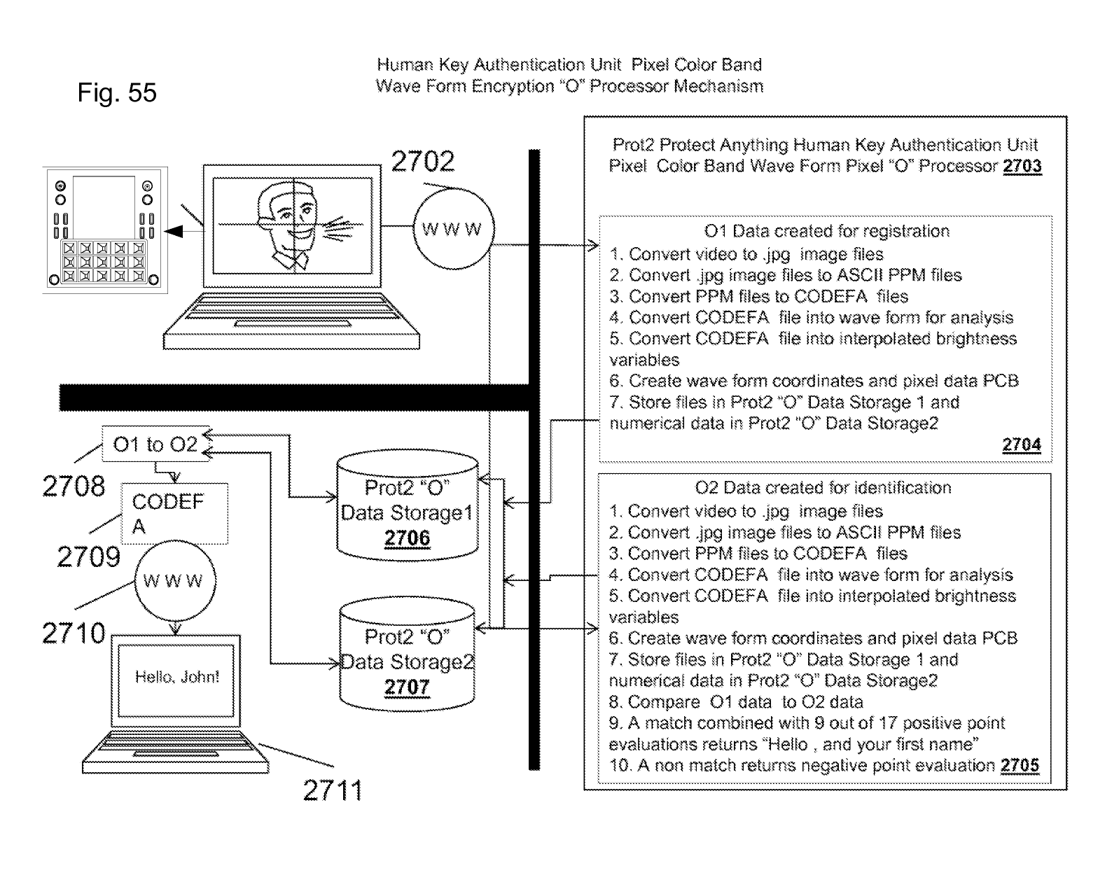

FIG. 7 in the specifications drawings of Ser. No. 12/459,353 shows the “Digital Semantic Agent” Adopt Anything aggregating data. FIG. 8 shows the “Digital Semantic Agent” Adopt Anything transformation of data. FIG. 9 shows another process by the “Digital Semantic Agent” Adopt Anything. FIG. 10-32 shows aggregation processes by the “Digital Semantic Agent” Adopt Anything. FIG. 33-39 Show results created by the “Digital Semantic Agent” Adopt Anything. FIGS. 48, 49, 50, 51 and 55 show more aggregation created by the “Digital Semantic Agent” Adopt Anything. FIG. 64, 65, 66 show the automatic generation of request for proposals and decisions created by the “Digital Semantic Agent” Adopt Anything

In an effort to assist in understanding what a “Semantic Agent” is in the industry, the following links are provided, but they are not prior art.
http://www-01.sil.org/linguistics/GlossaryOfLinguisticTerms/WhatIsAgentAsASemanticRole.htm
http://www-01.sil.org/linguistics/GlossaryOfLinguisticTerms/WhatIsASemanticRole.htm
http://code.google.com/p/semanticagent/
and
http://code.google.com/p/semanticagent/wiki/SemanticAgent

Also there is a book published in 2011 that describes the semantic web and agents taught by the present invention in 2009,
http://www.springer.com/engineering/computational+intelligence+and+complexity/book/978-3-642-18307-2

Semantic agent systems are about the integration of the semantic Web, software agents, and multi-agent systems technologies. Like in the past (e.g. biology and informatics yielding bioinformatics) a whole new perspective is emerging with semantic agent systems. In this context, the semantic Web is a Web of semantically linked data which aims to enable man and machine to execute tasks in tandem. Here, software agents in a multi-agent system as delegates of humans are endowed with power to use semantically linked data. This edited book “Semantic Agent Systems: Foundations and Applications” proposes contributions on a wide range of topics on foundations and applications written by a selection of international experts. It first introduces in an accessible style the nature of semantic agent systems. Then it explores with numerous illustrations new frontiers in software agent technology. “Semantic Agent Systems: Foundations and Applications” is recommended for scientists, experts, researchers, and learners in the field of artificial intelligence, the semantic Web, software agents, and multi-agent systems technologies.

In computing, a user agent is software (a software agent) that is acting on behalf of a user. For example, an email reader is a Mail User Agent, and in the Session Initiation Protocol (SIP), the term user agent refers to both end points of a communications session.

In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A Fractional Request Module, that calculates separating components of a transaction, real or intangible property, or object through differences, determined by using all the modules including Fair Modules, and Micro Share Request Module in the system to create potential deals, suggestions, motivations to play, and potential transactions combined with the function of asking for collaborations related to the dividing of properties in a network for the benefit of the individual users. So this module takes properties aggregated data in the Fair “Value, Share, Deal, Price and Placement,” modules and creates divided fractional pieces of properties, and then using the Digital Semantic Agent creates Requests through the Fair Deal Module. So properties can be divided by user owners, and Requests for people to share, buy, sell, collaborate, or provide business, services, or products can be publicized to users in a network.

The steps are:
Owner user uses form to submit files, text, images, video, and information to the system;
System modules divide the property for transactions;
Property is valued;
determining the market value of a property;
determining the value of an intellectual property;
determining ownership and control of a subsequent properties;
calculating an ownership percentage that is protected between two or more owners in relation to a shared and protected property;
calculating advertising rates and valuations of a property;
Deals are determined;
Potential deals are solicited to related users for participation in transactions;
arbitrating a deal;
suggesting and negotiating a deal between a two or more users;
requesting proposals and prices;
providing an advertising system for buying, selling, targeting, and placing advertisements, individually, in groups, or through the automatic digital semantic agent;

A Property is something that is owned by a person, business, government etc. and in most aspects of the invention, a property is something owned by a person that is changed or transformed by the invention.

A Change Request Search Module, that allows users to change other users content, websites, objects, real or intangible properties utilizing functions, utilizing the following modules aggregated data.

A Random and/or Specified, Generating Objects Function Module utilizing the digital semantic agent for aggregation of new or existing images, videos, shapes, ideas, and structures to create and modify old properties into new properties. Utilizing the following steps;
we take form submitted semantic keywords;
we search outside of web forms through shell the Internet utilizing multiple different search engines;

In the Random and/or Specified, Subjects, Thoughts and Goals Module that aggregates data for modifications of properties. We use the following aggregation steps:
User submits keywords specified in a form and Digital Semantic Agent selects similar keywords, related to submission in these aggregation areas;
   subjects from the Internet related;
   thoughts submitted by users related;
   and user goals that are related;
and aggregates data to be used by the system.
Digital Semantic Agent creates random keywords, and inputs them in a form and selects similar keywords, related to;
   subjects from the Internet related;
   thoughts submitted by users related;
   and user goals that are related;
and aggregates data to be used by the system.

A Random and/or Specified, Facts Module that aggregates facts for use in modifications of properties. And works with the following steps:

User submits keywords specified in a form and Digital Semantic Agent selects similar keywords, related to submission in these aggregation areas;
facts related subjects from the Internet related;
facts related thoughts submitted by users related;
and user facts related goals that are related;

and aggregates data to be used by the system.

Digital Semantic Agent creates random keywords, and inputs them in a form and selects similar keywords, related to;
facts related subjects from the Internet related;
facts related thoughts submitted by users related;
and user facts related goals that are related;

and aggregates data to be used by the system.

A Random and/or Specified, Emotional Module, that aggregates how a user feels at the moment of, and all through the process of modification of properties.

User submits keywords specified in a form and Digital Semantic Agent selects similar keywords, related to submission in these aggregation areas;
user emotional facts related subjects from the Internet related;
user emotional facts related thoughts submitted by users related;
and user emotional facts related goals that are related;

and aggregates data to be used by the system.

Digital Semantic Agent creates random keywords, and inputs them in a form and selects similar keywords, related to;
user emotional facts related subjects from the Internet related;
user emotional facts related thoughts submitted by users related;
and user emotional facts related goals that are related;

and aggregates data to be used by the system.

A Random and/or Specified, Current News Module, that aggregates news for modification of properties.

User submits keywords specified in a form and Digital Semantic Agent selects similar keywords, related to submission in these aggregation areas;
news related subjects from the Internet related;
user news related thoughts submitted by users related;
and user news related goals that are related;

and aggregates data to be used by the system.

Digital Semantic Agent creates random keywords, and inputs them in a form and selects similar keywords, related to;
news related subjects from the Internet related;
user news related thoughts submitted by users related;
and user news related goals that are related;

and aggregates data to be used by the system.

A Random and/or Specified, Potential Negative Results (Adverse Reactions) Module, that calculates adverse reactions to the changed property.

User submits keywords specified in a form and Digital Semantic Agent selects similar keywords, related to submission in these aggregation areas;
Potential Negative Results (Adverse Reactions) related subjects from the Internet related;
user Potential Negative Results (Adverse Reactions) related thoughts submitted by users related;
and user Potential Negative Results (Adverse Reactions) related goals that are related;

and aggregates data to be used by the system.

Digital Semantic Agent creates random keywords, and inputs them in a form and selects similar keywords, related to;
Potential Negative Results (Adverse Reactions) related subjects from the Internet related;
user Potential Negative Results (Adverse Reactions) related thoughts submitted by users related;
and user Potential Negative Results (Adverse Reactions) related goals that are related;

and aggregates data to be used by the system.

A Random and/or Specified, Potential Positive Results (Benefits) Module that calculates beneficial reactions to changed properties. In this invention this works within the Request module.

User submits keywords specified in a form and Digital Semantic Agent selects similar keywords, related to submission in these aggregation areas;
Potential Positive Results (Benefits) related subjects from the Internet related;
user Potential Positive Results (Benefits) related thoughts submitted by users related;
and user Potential Positive Results (Benefits) related goals that are related;

and aggregates data to be used by the system.

Digital Semantic Agent creates random keywords, and inputs them in a form and selects similar keywords, related to;
Potential Positive Results (Benefits) related subjects from the Internet related;
user Potential Positive Results (Benefits) related thoughts submitted by users related;
and user Potential Positive Results (Benefits) related goals that are related;

and aggregates data to be used by the system.

A Random and/or Specified, Provocative Keywords, Images, and Videos converted into Text Module, that converts graphical objects and keywords into text, sentences, and phrases.

User submits keywords specified in a form and Digital Semantic Agent selects similar keywords, related to submission in these aggregation areas;
Provocative Keywords, Images, and Videos converted into Text related subjects from the Internet related;
user Provocative Keywords, Images, and Videos converted into Text related thoughts submitted by users related;
and user Provocative Keywords, Images, and Videos converted into Text related goals that are related;

and aggregates data to be used by the system.

Digital Semantic Agent creates random keywords, and inputs them in a form and selects similar keywords, related to;
Provocative Keywords, Images, and Videos converted into Text related subjects from the Internet related;
user Provocative Keywords, Images, and Videos converted into Text related thoughts submitted by users related;
and user Provocative Keywords, Images, and Videos converted into Text related goals that are related;

and aggregates data to be used by the system.

A Random and/or Specified, Provocative Text converted into Keywords, Images, and Videos Module that converts text, sentences, and phrases into other text, images and videos.

User submits keywords specified in a form and Digital Semantic Agent selects similar keywords, related to submission in these aggregation areas;
Provocative Text converted into Keywords, Images, and Videos related subjects from the Internet related;
user Provocative Text converted into Keywords, Images, and Videos related thoughts submitted by users related;
and user Provocative Text converted into Keywords, Images, and Videos related goals that are related;

and aggregates data to be used by the system.

Digital Semantic Agent creates random keywords, and inputs them in a form and selects similar keywords, related to;
Provocative Text converted into Keywords, Images, and Videos related subjects from the Internet related;
user Provocative Text converted into Keywords, Images, and Videos related thoughts submitted by users related;
and user Provocative Text converted into Keywords, Images, and Videos related goals that are related;

and aggregates data to be used by the system.

A Random and/or Specified, transformation module that transforms, re-purposes, and/or reformats all Random and/or Specified aggregated data into brand new divided, and/or color banded property.

User submits keywords specified in a form and Digital Semantic Agent selects similar keywords, related to submission in these aggregation areas;
transforms, re-purposes, and/or reformats related subjects from the Internet related;
user transforms, re-purposes, and/or reformats related thoughts submitted by users;
and user Transforms, re-purposes, and/or reformats related goals;

and aggregates data to be used by the system.

Digital Semantic Agent creates random keywords, and inputs them in a form and selects similar keywords, related to;
transforms, re-purposes, and/or reformats related subjects from the Internet;
user Transforms, re-purposes, and/or reformats related thoughts, submitted by users;
and user Transforms, re-purposes, and/or reformats related goals;

and aggregates data to be used by the system.

A Self Publishing Publicity module takes newly created, transformed and re-purposed web pages, images, videos, text, IP, and/or real tangible or intangible properties, and creates press release, and distributes the materials utilizing Digital Semantic Agent, and aggregated data in the presented invention.

The steps that are taken in the module are:

Assembly of aggregated data into press releases utilizing the Digital Semantic Agent;

Sending out requests to new agencies;

Tracking requests, and publicity created;

Purchasing higher ranking distribution;

Aggregating feedbacks and related comments to the submitted press releases;

Record time and response rates;

Recording the spatial point target for each press release for global analysis;

Validating press release resulting sales, participation and global interest;

Re submitting press releases on given time frames for maximum impact.

Any programmer skilled in the art could take the aggregated data specified, keywords and semantic phrases, and rules utilizing an Open Source search application designed for relational searches such as Nutch, in the method presented, and create relational database decisions for requests for participation, invitations to request, and request suggestions presented to users, by creating Microshare Requests, Fractional Requests, Change Request Searches, Random and/or Specified, Generating of Objects, Subjects, Thoughts, Goals, Facts, Emotional, Current News, Potential Negative or Positive Results, and potential provocative text, images, videos and media, and random transformations of all aggregated items for re-purposing of divided or un-divided properties searched by keywords, and key phrases utilizing a search engine form, entered by user, and aggregated stored data for creating real time request comparative responses and PHP and Mysql database relationship programming, in the present invention.

The method invention presented here utilizes Python, PHP, and Pysal for Spatial Point Targeting for distribution, and identification and is embedded into the ITAVMIST Server System-on-a-chip (SoC) processor. All of these open source softwares would have been available and used by programmers skilled in the art at the time of the filing. Also Spatial Point Targeting is used in the system in all servers running software and methods run on those servers as a security feature.

The Python Software Foundation (PSF), is a non-profit organization devoted to the Python programming language, launched on Mar. 6, 2001. The mission of the foundation is to foster development of the Python community and is responsible for various processes within the Python community, including developing the core Python distribution, managing intellectual rights, developer conferences including PyCon, and raising funds. In 2005, the Python Software Foundation received the prestigious Computerworld Horizon Award for “cutting-edge” technology.

PySAL is an open source library of spatial analysis functions written in Python intended to support the development of high level applications. PySAL is open source under the BSD License. PySAL: Open Source Python Library for Spatial Analytical Functions

ASU's GeoDa Center for GeoSpatial Analysis and Computation, a research unit closely affiliated with the School of Geographical Sciences and Urban Planning, develops PySAL, an open source library of computational tools for spatial analysis.

PySAL grew out of a collaborative effort spearheaded by Professor Sergio Rey and Luc Anselin, Walter Isard Chair and Director of the School of Geographical Sciences and Urban Planning. The project integrates two analytical tools, STARS and PySpace, that were developed separately by the two researchers prior to their arrival at ASU.

PySAL provides a suite of spatial analytical methods that developers can incorporate into their own application development, and that spatial analysts may customize to further their research. The PySAL tools are programmed in the Python language, which is increasingly used in geographic information systems.

The Virtual World Airport Server (VWA) is a software application that is run on a System-on-a-chip (SoC) that includes a search transaction based primary management of Virtual Worlds, Virtual World objects, and Virtual World places built into the apparatus. This is accomplished by using multiple search engine technologies, with multiple processor cores, and parallel System-on-a-chip (SoC) processing for rapid processing of graphics components. This component of the system apparatus, and methods related to being served in that system effectively takes a user in the Virtual World environment to other Virtual Worlds, Virtual World objects, and Virtual World places, providing processing rapidly as an independent System-on-a-chip (SoC).

The following software applications and methods are embedded in the System-on-a-chip (SoC) that makes up the Virtual World Airport Server: Scrapy, Open Search Server, and Nutch.

Scrapy was readily known and used by programmers at the time of this patent filing, to create web scraping and has the following capabilities:

Scrapy is a web crawling framework with support for web scraping. It is open-source and written in Python. It is controlled using command line tools, that can be used to trigger the scrapers written in Python.

Scrapy was born at London-based web aggregation and e-commerce company Mydeco, where it was developed and maintained by employees of Mydeco and Insophia (a web consulting company based in Montevideo, Uruguay). The first official release was in August 2008, and it has been continually improved since then.

OpenSearchServer was readily known and used by programmers at the time of this patent filing, for application serving, and Virtual World Search and has the following capabilities:

OpenSearchServer is an open source application server allowing development of index-based applications such as search engines. Available since April 2009 on SourceForge for download, OpenSearchServer was developed under the GPL v3 license and offers a series of full text lexical analyzers. It can be installed on different platforms (Windows, Linux, Macintosh).

The main features of OpenSearchServer are:

An integrated crawler for databases, web pages and rich documents;

a user-friendly GUI allowing development of most applications through a web page interface built in Zkoss;

snippets;

faceting;

an HTML renderer for integrating search results in a page; and monitoring and administration features.

OpenSearchServer is written in Java and it can be integrated into almost any kind of application without the need to produce Java code. REST/XML APIs make OpenSearchServer connectable to other programming languages. The “advanced plugins” capability allows sophisticated customizations.

Nutch was readily known and used by programmers at the time of this patent filing, and was used for web search engine, and Virtual World Search and has the following capabilities:

Nutch is an effort to build an open source web search engine based on Lucene and Java for the search and index component. Nutch is coded entirely in the Java programming language, but data is written in language-independent formats. It has a highly modular architecture, allowing developers to create plug-ins for media-type parsing, data retrieval, querying and clustering. The fetcher (“robot” or “web crawler”) has been written from scratch specifically for this project.

Nutch originated with Doug Cutting, creator of both Lucene and Hadoop, and Mike Cafarella. In June, 2003, a successful 100-million-page demonstration system was developed. To meet the multimachine processing needs of the crawl and index tasks, the Nutch project has also implemented a MapReduce facility and a distributed file system. The two facilities have been spun out into their own subproject, called Hadoop. In January, 2005, Nutch joined the Apache Incubator, from which it graduated to become a subproject of Lucene in June of that same year.

Virtual Cash Virtual Currency Server is a software application that is run on a System-on-a-chip (SoC) that includes management, distribution and banking storage of Virtual Currencies utilizing MyBanco, and the Automatic Clearing House functions of OpenACH. And further works in the method and system, with the Human Key or Human Identity Key as well as the Object Key or Object Identification Key for security.

CODEFA is the identification registration encryption, decryption and function software application for registering media objects, video, audio, files, images in the system. By combining identification of media objects and human objects the apparatus can accomplish the purpose of the present invention.

CODEFA software application performed on a computer System-on-a-chip (SoC) that includes all the steps from patent '936 and '344 related to security of an actual file in the system. During the actual encryption and decryption, the following steps occur:

Encryption Steps for breaking file and storage:

The file is uploaded to the CODEFA Server;

The actual file is opened into the actual code;

Code is added that makes the file broken;

Then the file is renamed, and this code name is used for identification;

and stored in a folder;

the file is secure as it can not function;

Decryption Steps for fixing file and serving:

Then when use of the file is needed;

the name of the file is searched for;

the file is opened to it's code;

the code that was added is searched for and removed;

and then the file is saved in the folder;

and served to the user;

All of these software application functions and methods are embedded in the CODEFA Server System-on-a-chip (SoC) processor for the purpose of rapid deployment and use. This CODEFA processor is a different security system, that works inside the actual code of a file, than the Human Key which works to identify a human, or object.

By combining the software application CODEFA processor, for identification of actual files, and using the Human Key, for identification of the user as security features, combined with the other System on Chip (SOC) software application processor servers, we can accomplish attaching security and identification to objects, and content, with tracking, and delivery functions.

By combining the functions of the CODEFA Server software application for identifying objects and data files, and managing the Virtual Currency encryption de-encryption, we have protection and identification of virtual currency files. And when you combine the Human Key Server software application that is run a System on chip processor, to the process you have attachment of virtual currency (object file) to a human user (human verification identity file).

Publicity is the notice or attention given to someone or something by the media, and further the process of the giving out of information about a product, person, or company for advertising or promotional purposes, and involves special news material or information used for publicity.

A Self Publishing Publicity module utilizes the Digital Semantic Agent module and takes newly created, transformed and re-purposed web pages, images, videos, text, IP, and/or real tangible or intangible properties, entered into the search form or uploaded to the system by a user and creates assembled press releases, and further distributes the materials through the system request search engine functionality.

A server is a computer that provides data to other computers. It may serve data to systems on a local area network (LAN) or a wide area network (WAN) over the Internet.

Many types of servers exist, including web servers, mail servers, and file servers. Each type runs software specific to the purpose of the server. For example, a Web server may run Apache HTTP Server or Microsoft IIS, which both provide access to websites over the Internet. A mail server may run an advertising and marketing program like Exim or iMail, which provides SMTP services for sending and receiving email. A file server might use Samba or the operating system's built-in file sharing services to share files over a network.

A Clearing House is a financial institution that provides clearing and settlement services for financial and commodities derivatives and securities transactions. These transactions may be executed on a futures exchange or securities exchange, as well as off-exchange in the over-the-counter (OTC) market. A clearing house stands between two clearing firmis software application running on a computer which acts as a server for transmitting the information and executing the software from input and generating output as discussed above as the functions of a “clearing house”.s (also known as member firms or clearing participants) and its purpose is to reduce the risk of one (or more) clearing firm failing to honor its trade settlement obligations. A clearing house reduces the settlement risks by netting offsetting transactions between multiple counterparties, by requiring collateral deposits (also called “margin deposits”), by providing independent valuation of trades and collateral, by monitoring the credit worthiness of the clearing firms, and in many cases, by providing a guarantee fund that can be used to cover losses that exceed a defaulting clearing firm's collateral on deposit.

Clearing House functions can be: 1. Banking: Affiliated agency or a facility operated by banks within a geographical area to act as a central site for collection, exchange, and settlement of checks drawn on each other. Modern clearance houses also clear electronic funds transfers. 2. Futures: Agency or affiliate of a governing exchange (such as a stock exchange) which, as a counter-party to every transaction on that exchange, is responsible for guaranteeing, reconciling, settling, collecting, and clearing, on all trades.

An “Independent Clearing House Agent Server (ICHA) is software application running on a computer which acts as a server for transmitting the information and executing the software from input and generating output as discussed above as the functions of a “clearing house”. The Independent Clearing House Agent Server (ICHA) software application is a System-on-a-chip (SoC) server component of the system includes Automatic Clearing House open source software readily known at the time of the filing of this patent, by programmers with knowledge in the art utilizing software application components Open ACH, My Banco, and PHP Bank which were available at the time of filing.

Automated Clearing House (ACH) is an electronic network for financial transactions in the United States. ACH processes large volumes of credit and debit transactions in batches. ACH credit transfers include direct deposit payroll and vendor payments. ACH direct debit transfers include consumer payments on insurance premiums, mortgage loans, and other kinds of bills.

Open ACH is an open source Clearing House application with the following capabilities, that was known to programmers at before the time of this filing as early as Sep. 6, 2011.

Multiple Originators

Using a single OpenACH installation, you could run multiple payment processing companies, or offer origination “sub-accounts” for others to process payments through your installation (each through their own banks).

Multiple Banks and Bank Accounts

Each originator can set up multiple banking relationships, and even multiple ACH originating accounts at each bank. This allows intelligent decisions to be made about where to process payments on a per-customer basis, as well as the ability for a single originator to internally transfer of funds between their own banks and bank accounts using the OpenACH system.

Role-Based User Accounts

User logins can be configured with roles to individually control how many originators, banks, transfers, files, batches, etc., are allowed. This enables the system administrator to easily allow other originators to limit how users are utilizing the ACH system in a way that is adaptive to most third-party processing business models.

Automated Return/Change Handling

As payments are processed in the ACH system, financial institutions may send back ACH Return or Change records. Since there are a large number of possible return and change codes, OpenACH is designed to handle them in an automated fashion, relieving the administrator from the overwhelming workload that would be required to process these returns/changes by hand.

Modular API

Developed with a modular application programming interface (API), OpenACH is designed to allow others to easily extend the functionality and integrate it into other systems including, but not limited to, e-commerce, billing/invoicing systems, accounting systems, and websites.

Banking Plugins

Because there are a large number of banking choices available to your business, OpenACH provides a easy way to connect to many popular banks “out of the box”. The banking plugins contain all the information needed to successfully connect to a given bank, transfer files, and execute a full suite of tests required by the banks before processing can begin. This takes the guesswork out of adding a new bank to your payment workflow, or even moving all your business to a new bank.

International ACH (IAT)

OpenACH is designed to function on the International ACH system as well as the traditional, US Treasury system. This allows you to debit and credit Canadian accounts, and credit accounts in several other countries. Note that due to security limits on the International ACH system, at this time outbound debits are only allowed to Canadian accounts. Other IAT countries support only credits.

PCI Data Security Standards

The Payment Card Industry (PCI) Data Security Standards (e.g. PCI-DSS) are a set of rules for merchants processing debit and credit card payments. These requirements are proven to minimize fraud and protect customer information. Although OpenACH does not have anything to do with these types of payments, OpenACH is designed to meet these specifications wherever possible. This level of commitment to security minimizes your risk when processing ACH payments, both for your own business and for third-parties. All sensitive information is fully encrypted using military-grade encryption, and all inbound and outbound connections to the system require appropriate encryption.

MyBanco available as early as June 2008 from the day of it's conception, was built to process large volumes of transactions in a fast but safe environment that was able to be horizontally scaled out, that is, to add the ability to perform more transactions in a second, all that is needed is to add another node into the system. This is a major benefit that MyBanco has over other systems such as PHPbank, who's speed can only be improved on if it is scaled vertically.

MyBanco was programmed by Tim Groeneveld for a study in large scale scalability. A cheap MyBanco install can do 100 transactions a second.

Present features of MyBanco include:

Many-to-many bank account links

(that is, three people might all be able to access three accounts).

Detailed transaction history.

Easy to use API based on JSON-RPC. (This means applications can be written in any programming language that leverage the MyBanco platform)

Internet Banking frontend

Phone Banking frontend

MyInfo backend can be compiled with Roadsend PHP Compiler for an extra speed boost.

MyBanco requirements:

PHP 5.2 or newer

pcre module enabled

json module enabled

mail module enabled

mysql module enabled

Apache (other servers can be used with a little fiddling)

MyInfo is a network-aware Remote procedure call protocol encoded in JavaScript Object Notation (JSON).

MyInfo wraps around databases (currently only MySQL) to provide frontends securely information about anything. MyBanco uses MyInfo to store and retrieve data about users, bank accounts, documents in the customer relations management system and to also calculate past and present bank bal-ances.

A. Web Frontend

Internet Banking is built into MyBanco by building onto the pre-exisThe Translation Server is a System-on-a-chip (SoC) server component of the system includes translation components gtranslator, GlobalSight, Moses SMT Decoder and Virtaal.ting MyInfo system.

B. Phone Frontend

Phone Banking is built into MyBanco by building onto the pre-existing MyInfo system and Aster-isk, meaning people can literally dial into a physical phone line! No-one else can do this!

MyBanco is a kit made to run a ‘bank’. This ‘bank’ only does core banking, so the software does not take in account things like FOR-EX (foreign exchange) and other forms of trading (such as a stock exchange). MyBanco is modular software, which splits all functions into easy to manage separate applications which can be installed on separate machines to scale high loads.

PHPBank was written by Sander Dieleman, with the last known version, version 1.0 released 14 Aug. 2006. PHPBank is still widely used by micronation

A person having ordinary skill in the art would clearly understand the recitation of the claim, and any skilled programmer in the art would have known how to create the Independent Clearing House utilizing the known open source software available at the time.

A Virtual World or massively multiplayer online world (MMOW) is a computer-based simulated environment. The term has become largely synonymous with interactive 3D virtual environments, where the users take the form of avatars visible to others. These avatars can be textual, two or three-dimensional graphical representations, or live video avatars with auditory and touch sensations. In general, virtual worlds allow for multiple users.

The user accesses a computer-simulated world which presents perceptual stimuli to the user, who in turn can manipulate elements of the modeled world and thus experience a degree of telepresence. Such modeled worlds and their rules may draw from the reality or fantasy worlds. Example rules are gravity, topography, locomotion, real-time actions, and communication. Communication between users can range from text, graphical icons, visual gesture, sound, and rarely, forms using touch, voice command, and balance senses.

Massively multiplayer online games depict a wide range of worlds, including those based on science fiction, the real world, super heroes, sports, horror, and historical milieus. The most common form of such games are fantasy worlds, whereas those based on the real world are relatively rare. Most MMORPGs have real-time actions and communication. Players create a character who travels between buildings, towns, and worlds to carry out business or leisure activities. Communication is usually textual, but real-time voice communication is also possible. The form of communication used can substantially affect the experience of players in the game.

Virtual Worlds are not limited to games but, depending on the degree of immediacy presented, can encompass computer conferencing and text based chat rooms. Edward Castronova is an economist who has argued that “synthetic worlds” is a better term for these cyberspaces, but this term has not been widely adopted.

Open Cobalt is a free and open source software platform for constructing, accessing, and sharing virtual worlds both on local area networks or across the Internet, without any requirement for centralized servers.

The technology makes it easy to create deeply collaborative and hyperlinked multi-user virtual workspaces, virtual exhibit spaces, and game-based learning and training environments that run on all major software operating systems. By using a peer-based messaging protocol to reduce reliance on server infrastructures for support of basic in world interactions across many participants, Open Cobalt makes it possible for people to hyperlink their virtual worlds via 3D portals to form a large distributed network of interconnected collaboration spaces. It also makes it possible for schools and other organizations to freely set up their own networks of public and private 3D virtual workspaces that feature integrated web browsing, voice chat, text chat and access to remote desktop applications and services.

Open Cobalt uses the Squeak software environment, which is an open source Smalltalk system freely available for Windows, Mac and Unix. As is true of almost any Smalltalk application, Open Cobalt has identical functionality on any supported platform. As a Smalltalk system, it can usually be updated while the system is running without requiring a restart.

Open Cobalt user interface and avatar-enabled virtual environment containing kmz mesh content imported from Google's 3D Warehouse. Users are able to provision content to Open Cobalt spaces that can be developed and managed using third-party tools and resources. Open Cobalt is derived from the Croquet software development kit (SDK) that was publicly released under the MIT License by Hewlett-Packard and the Croquet Consortium in early 2007.

In early 2008, and with the support of the Andrew W. Mellon Foundation,[2] Julian Lombardi and Mark P. McCahill, at Duke University, launched the community-based software development effort to build Open Cobalt as an open source virtual world browser application and construction toolkit.

The goals of the Open Cobalt effort are to stimulate the use of distributed virtual environments, advance visual simulations, and deepen collaboration in education, research, and personal entertainment—and in so doing to: stimulate the development and dissemination of shared cyber environments for the staging, observation and evaluation of collaborative decision-making, problem finding, and problem solving among members of distributed virtual organizations and educational communities, and create the conditions for the emergence of a free, open, and scalable 3D-enabled global information space.

Open Cobalt was readily known and used by programmers at the time of this patent filing, to create Virtual Worlds and has the following capabilities: Open Cobalt is both an end-user application and full featured software development environment for creating a rich network of end-user created interlinked virtual worlds. It is more extensible than the proprietary technologies behind collaborative worlds such as Second Life, and before that ViOS. This is because:

It is free (there are no fees for its use or distribution); The entire system is open source (it is licensed under the MIT free software license);

It features the ability to create 3D hyperlinks in the form of doorways that connect virtual worlds to one another (in much the same manner by which 2D hyperlinks connect webpages);

It supports VoIP (users can communicate with each other via voice while in-world);

It does not require the use of servers to create and share virtual worlds (since it is based on a peer-to-peer synchronization architecture/messaging protocol);

It is platform and device independent (because it is a virtual machine-based technology that runs on Mac OS X, Windows, and Linux);

It provides a complete professional programmer's language (Smalltalk/Squeak, IDE, and class library in every distributed, running participant's copy (with the programming environment itself being simultaneously shareable and extensible);

It is based on Squeak's late-binding architecture and metaprogramming facilities (that allow for efficient handling of media);

Users/developers within virtual worlds may freely access, modify and view the source code of the entire system (they can access running code from in-world);

Users/developers can import 3D content directly into their worlds (Google 3D Warehouse content (.kmz) and content in other formats can be drag-and-dropped directly into Open Cobalt worlds);

Users/developers can import a variety of media content directly into their worlds (Open Cobalt worlds support audio and mpeg media content);

Its software code can be updated/changed while the system is live (making it possible to program worlds from within worlds while they are running); and

It is not hosted on a single organization's server (and hence not governed by any such organization) It is independent.

Croquet open source software development kit, The Croquet Project was an international effort to promote the continued development of the Croquet open source software development kit to create and deliver deeply collaborative multi-user on line applications. Implemented in Squeak Smalltalk, Croquet supports communication, collaboration, resource sharing, and synchronous computation among multiple users. Applications created with the Croquet software development kit (SDK) can be used to support highly scalable collaborative data visualization, virtual learning and problem solving environments, 3D wikis, online gaming environments (massively multiplayer online role-playing games), and privately maintained or interconnected multiuser virtual environments.

Real time, interactive, 3D map of this very same world. Change something in the world, the map changes. Move something in the map (as one would a chess piece), the object in the world represented by it moves the same way. Croquet is a software development kit (SDK) for use in developing collaborative virtual world applications.

Applications created using the Croquet SDK are automatically collaborative since application objects in Croquet share a common protocol that allows them to cooperate with each other by employing the principle of replicated computation (synchronization) together with a peer-based messaging protocol. The technology is designed to facilitate replication of computation between peers in order to greatly reduce the overhead required for widespread deployment of collaborative virtual worlds.

This efficiency, combined with the ability to deploy Croquet-based virtual worlds on consumer-level hardware, makes it possible for developers to deploy large-scale and highly participatory collaborative worlds at very low cost compared with virtual world technologies that are entirely dependent on server-based infrastructures to support the activities of their users.

Croquet is the confluence of several independent lines of work that were being carried out by its six principal architects, Alan Kay, David A. Smith. David P. Reed, Andreas Raab, Julian Lombardi, and Mark McCahill. The present identity of the project has its origins in a conversation between Smith and Kay in 1990, where both expressed their frustration with the state of operating systems at the time.

In 1994 Smith built ICE, a working prototype of a two user collaborative system that was a predecessor of the core of what Croquet is today. Also in 1994 Mark McCahill's team at the University of Minnesota developed GopherVR, a 3D user interface to Internet Gopher to explore how spatial metaphors could be used to organize information and create social spaces. In 1996 Julian Lombardi approached Smith to explore the development of highly extensible collaborative interfaces to the WWW. Later, in 1999, Smith built a system called OpenSpace, which was an early-bound variant of Croquet. Also in 1999, Lombardi began working with Smith on prototype implementations of highly extensible collaborative online environments based on OpenSpace. One of these implementations was a prototype implementation of ViOS, a way of spatially organizing all Internet-deliverable resources (including web pages) into a massively-scaled multiuser 3D environment.

Smith and Kay officially started the Croquet Project in late 2001 and were immediately joined by David Reed and Andreas Raab. Reed brought to the project his longstanding work on massively scalable peer-to-peer messaging architectures in a form deriving from his doctoral dissertation that was published in 1978. The first working Croquet code was developed in January 2002. Simultaneously and independently, Lombardi and McCahill began collaborating on defining and implementing highly scalable and enterprise-integrated architectures for multi-user collaboration and were invited by Kay to join the core architectural group in 2003.

From 2003 to 2006, the technology was developed under the leadership of its six principal architects with financial support from Hewlett-Packard, Viewpoints Research Institute Inc., the University of Wisconsin-Madison, University of Minnesota, Japanese National Institute of Communication Technology (NICT), and private individuals. On Apr. 18, 2006 the project released a beta version of the Croquet SDK 1.0 in the open source. Since then, the Croquet technology infrastructure has been successfully used by private industry to build and to deploy commercial-grade closed source collaborative applications. Open source production-grade software implementations for delivering secure, interactive, persistent, virtual workspaces for education and training have at the same time been developed and deployed at the University of Minnesota, University of Wisconsin-Madison, University of British Columbia, and Duke University.

As of 2009, continued development of the original Croquet technology is taking place through the Open Cobalt project.

Croquet open source software development kit was readily known and used by programmers at the time of this patent filing, to create Virtual Worlds and has the following capabilities:

It is platform and device independent;

Users and developers may freely share, modify and view the source code of the whole system, due to a liberal license;

The technology is not hosted on one organization's server, and hence not governed by any such organization;

It provides a complete professional programmer's language (Squeak Smalltalk), integrated development environment (IDE), and class library in every distributed, running participant's copy; the programming development environment itself is simultaneously shareable and extensible; and

Croquet based worlds can also be updated while the system is live and running.

A person having ordinary skill in the art would clearly understand the recitation of Virtual World or Virtual World Network in the claims.

All of the modules work within a computer server, computer processor, or System on Chip integrated circuit.

1. A Wall Paneling Construction Smart Apparatus and System comprising;
a stationary electrical access wall outlet panel apparatus;
a plurality of low energy multiple color lasers;
a plurality of solar photo voltaic cells;
a plurality of solar concentrator apparatus;
a plurality of graphene super capacitor apparatus;
a plurality of organic battery storage units;
a single or plurality of data storage devices;
a plurality of USB, and USB Power Delivery energy connector apparatus;
a plurality of USB communication ports;
a plurality of electricity generator apparatus;
a plurality of thermal electricity generating layers apparatus;
a plurality of aqueous delivery apparatus;
a plurality of cameras;
a plurality of microphones;
a plurality of speakers;
a spatial point sound and light measurement controller apparatus;
a wireless controller board;
an LCD touch screen display;
a plurality of electricity converted to light transmitting apparatus;
a plurality of light converted to electricity receiving apparatus;
a plurality of graphene layered EMP protection apparatus;
a Human Key USB processor port for identification of authorized users;
a Human Key controller board;
a main CPU controller board;
an energy and battery controller board;
a plurality of computer processors;
a plurality of 3D Solar panel with light intensity tracking apparatus;
a plurality of multi layered graphene solar cell apparatus;

2. The apparatus and system of claim 1 and further comprising;
a mobile non stationary wall panel construction apparatus and system;
a low voltage local DC energy network adapter;
a spatial point measurement apparatus controller;
a mobile battery pack storage apparatus;
a KWH Banking controller apparatus;
a Human Key authorization controller board;
a computer tablet controller;
a mobile phone controller;
a Human Key measurement apparatus.

3. The apparatus and system of claim 2 and further comprising;
a low voltage DC LED lighting apparatus that can plug into stationary or mobile non stationary wall panel construction apparatus;
a USB Power delivery energy connector for light, and charging;
a rechargeable graphene battery;
an energy and communications controller board;
a wireless communication transmitter and receiver;

4. The apparatus and system of claim 2 and further comprising;
a low voltage DC heating apparatus that can plug into stationary or mobile non stationary wall panel construction apparatus;
a USB Power delivery energy connector for material and air heating applications, and charging;
a rechargeable graphene battery;
an energy and communications controller board;
a wireless communication transmitter and receiver;

5. The apparatus and system of claim 2 and further comprising;
a low voltage DC water purifying apparatus that can plug into stationary or mobile non stationary wall panel construction apparatus;
a USB Power delivery energy connector for palatable water purification applications, and charging;
a rechargeable graphene battery;
an energy and communications controller board;
a wireless communication transmitter and receiver;

6. The apparatus and system of claim 2 and further comprising;
a low voltage DC food dehydrator apparatus that can plug into stationary or mobile non stationary wall panel construction apparatus;
a USB Power delivery energy connector for food preservation and storage applications, and charging;
a rechargeable graphene battery;
an energy and communications controller board;
a wireless communication transmitter and receiver;

7. The apparatus and system of claim 2 and further comprising;
a low voltage DC water heating and cooling apparatus that can plug into stationary or mobile non stationary wall panel construction apparatus;
a USB Power delivery energy connector for water heating and cooling applications, and charging;
a rechargeable graphene battery;
an energy and communications controller board;
a wireless communication transmitter and receiver;

8. The apparatus and system of claim 2 and further comprising;
a low voltage DC water de-salinization apparatus that can plug into stationary or mobile non stationary wall panel construction apparatus;
a graphene filtration filter apparatus;
a USB Power delivery energy connector for water salt removal applications, and charging;
a rechargeable graphene battery;
an energy and communications controller board;
a wireless communication transmitter and receiver;

9. The apparatus and system of claim 2 and further comprising;
a low voltage DC Mobile ATM Battery Pack apparatus that can plug into stationary or mobile non stationary wall panel construction apparatus;
a USB Power delivery energy connector for KWH
energy banking applications, and charging;
a rechargeable graphene battery;
an energy and communications controller board;
a wireless communication transmitter and receiver;

10. The apparatus and system of claim 2 and further comprising;
a low voltage DC to AC inverter apparatus that can plug into stationary or mobile non stationary wall panel construction apparatus;
a USB Power delivery energy connector for conversion of low voltage DC to AC power applications, and charging;
a rechargeable graphene battery;
an energy and communications controller board;
a wireless communication transmitter and receiver;

11. The apparatus and system of claim 1 and further comprising;
a graphene laser energy creation apparatus;
a cooling fan apparatus;
a heat transfer apparatus;
a Peltier thermo generator apparatus;
a plurality of electricity generating layers apparatus.

12. The apparatus and system of claim 2 and further comprising;
a plurality of laser measurement system apparatus for determining measurements in a free space;
a plurality of sonic measurement sensors for remote object measurement;
a remote wire frame creation system processor for determining multiple edge measurements;
a spatial point identification component;
a human key data access manager component;
a human key administrative access manager component;
a mobile, hand held manager component;
a 3D 2 lens camera with wifi radio transmitter;
a 3D 2 lens camera with wifi radio receiver;
an infrared and color bands laser light receiver;
an infrared and color bands laser light transmitter;
a plurality of infrared or visible light laser diode distance evaluator component;
a data storage component;
a human key security and identification component;
a request anything transmitter and receiver component;
a sensor apparatus for the measurement of distances;
a digital semantic agent apparatus for making decisions and measurements;
a mini sonic distance measurement component;

13. The apparatus and system of claim 11 and further comprising;
an apparatus for measurement aggregation utilizing visual, sonic, thermal, chemical, gaseous and radio frequency electrical measurements data;
a processor in the apparatus converting measurements that can be made related to size of objects, volumes, areas, magnitude, and cryptography methods of materials, and objects including liquids, solid materials, and spatial point aggregation for placement of objects in a virtual world, and real world.

14. The apparatus and system of claim 11 and further comprising;
a controller apparatus providing measurements related for producing a digital sample where a user can calculate how much of a product, or materials, and quantity are needed for projects;
an apparatus that can solicit and send a request for an estimate, wholesale price, or participation in services related to projects.

15. The apparatus and system of claim 11 and further comprising a controller apparatus system providing;
an apparatus for a user to try products on;
an apparatus for collaboration for measured custom manufacture;
an apparatus to create and print measurement 3D mesh files on 3D Printers;
an apparatus to remotely measure real or intangible property, such as objects, humans, inorganic, or organic matter, spaces, areas, and air, in a stationary position, or in motion, at point of purchase, sale, discovery, manufacturing, design or 3D printing;
an apparatus for Humans, Avatars, and Robots to be able to sample real or intangible property for the best fit, custom fit, style and or 3D Printing or manufacturing;
an apparatus where an Avatar Digital Semantic Agent is used for the purpose of enabling users to sample things, and records a users preferences;
an apparatus where an Avatar Digital Semantic Agent is used for aggregating a users preferences, which includes personality characteristics such as measuring likes, dislikes, voting, favorite colors, foods or preferences in products.

16. The apparatus and system of claim 11 and further comprising controller apparatus providing;
an apparatus that calculates what material, and what size of material, and how much material will be needed for manufacturing;
an apparatus that sets up a request anything function for finding manufacturers that would be interested in bidding, selling, discounting or participating in material manufacturing, and or purchasing, including buying selling trading and bartering;
an apparatus for measurements related to diet tracking, medical diagnostics, medical device manufacturing, fittings and prosthetics measurements for perfect fits.

17. The apparatus and system of claim 11 and further comprising controller apparatus providing;
an apparatus for functions in the medical space, utilizing measurements of internal organs, specifically designed for each human, animal, plant;
an apparatus for body scans with measurement for clinical trial before and after affects;
an apparatus related to diagnostic procedures involving measurements for patients test results.

18. The apparatus and system of claim 11 and further comprising controller apparatus providing;
an apparatus utilization of visible light and infrared lasers, along with sonic methods from the GSense and ITAVMIST apparatus;
an apparatus embedded process and transformation where after the measurement is aggregated within the apparatus, the data can be converted into a bar code, or encrypted code for identification, and attached to a real or intangible property;
an apparatus for entering data into a Virtual World and Real World registry of objects measurements;
a Human Key apparatus and system to create a wire-frame of spatial point targets from the object being measured;
an apparatus for the processing of virtual measurements being transformed that are able to be traded, sold, bought, bid, lent, shipped, and connected to security devices and used in development systems, for placing objects in rooms, places, and spatial point targets, for the purpose of trying objects out before developing, decorating, buying homes, purchasing products or making transactions;
an apparatus with the ability for products and objects to be taken digitally home to sample them, such as virtual wearables, or real or intangible properties;
an apparatus that further enhances data aggregation for an object registry.

19. The apparatus and system of claim 11 and further comprising controller apparatus providing;
a camera system apparatus that can take rapid video and image frames, combined with spatial point target wire frame measurements;
an apparatus where user can take an instant measurement, with their mobile phone, hand held device, or camera, which is then converted into a wire frame of spatial point targets instantly, by just aiming the device to the object and spinning the object around in a circle;
an apparatus embedded process that captures a plurality of images or video in a collection of images, all with measurement data of the spinning object aggregated at the moment of movement;
an apparatus that takes data and sends it to a processor on a computer, and the processor transforms the data into a measurement code. This machine transformed code stays with the image or video recorded at the time of the measurement processing;
a Human Key apparatus is used for initiating the measurement code process, and the code that is created, is used as a 19th redundancy in the Human Key processor apparatus.

20. The apparatus and system of claim 11 and further comprising controller apparatus providing;
an apparatus with embedded processes for “search engine of measurements” for public or private networks, which can be used by users who want to have the exact measurement of things for projects or ideas;
an apparatus where Avatars created by the digital measurement system, can place sensors at spatial point targets in a virtual world, or real world;
an apparatus with processes for creation of a special Avatar with the function of making a virtual clone of a person, that can have not only measurements of a person, and objects related to that person, but also their biological data embedded into the Avatar;
a computer processor where the Avatar can be made into an apparatus sensor in a virtual world or real world;
a computer processor where the Avatar can sense the emotions of other Avatars, Digital Semantic Agents, and Real People;
a computer processor that provides an Avatar sensing system that can measure chemicals and additives to objects such as food, and liquids, and test what is in them, or what materials are used to make them;
a computer processor that provides a measurement system used with GEO targeting systems to be able to see places you are going before you get to them on a trip. It utilizes a smart GPS and GEO imaging aggregation and delivery system. With this component the apparatus allows people to virtually visit places;
an apparatus that adds known aggregated measurements data of objects and indexes those measurements into a search engine, for comparisons, and measurement decision making;
an apparatus for creating spatial point targeted sensors that aggregate sensations related to their individual specifications;
an apparatus and processor where, a Human Cloud connected to an Avatar Cloud is managed by a computer to implement and apply measurements to duly authorized owners or assigned owner of rights to the digital or analog measurement data aggregated, and further is attached to its own Human Key for identification in the system.
